(19) United States
(12) Patent Application Publication
(10) Pub. No.: US 2010/0021022 A1
(43) Pub. Date: Jan. 28, 2010

(54) Electronic Handwriting

(76) Inventors: Arkady Pittel, Brookline, MA (US); Stanislav V. Elektrov, Needham, MA (US); Anatoli Soltan, Woburn, MA (US); Ilya Pittel, Brookline, MA (US); Eugene Goldenberg, Pawtucket, RI (US); Gerhard Andrew Foelsche, Rehoboth, MA (US); Benoit Devinat, Providence, RI (US); Paul Tomashevskyi, Wayland, MA (US)

Correspondence Address: FISH & RICHARDSON PC, P.O. BOX 1022, MINNEAPOLIS, MN, 55440-1022, US

(21) Appl. No.: 12/392,797

(22) Filed: Feb. 25, 2009

Related U.S. Application Data
(60) Provisional application No. 61/031,304, filed on Feb. 25, 2008.
(60) Provisional application No. 61/054,056, filed on May 16, 2008.

(51) Int. Cl. G06K 9/00; G06F 3/033; B65D 85/00

(52) U.S. Cl. 382/123; 345/179; 206/320

(57) ABSTRACT

Among other things, a holder for an electronic stylus includes a cavity in which the stylus can be placed when not in use. The cavity includes a receptacle at one end for a writing end of the stylus and a stop at the other end. The stop has an opening into which an opposite end of the stylus can be placed. The receptacle has a resilient element to urge the stylus against the stop.

This application has the benefit of the filing dates of U.S. provisional applications 61/031,304 and 61/054,056, filed Feb. 25, 2008 and May 16, 2008, respectively, the entire contents of which are incorporated by reference.

This application also incorporates by reference the following U.S. patent applications: U.S. Ser. No. 09/376,837 (now U.S. Pat. No. 6,577,299), entitled “Electronic Portable Pen Apparatus and Method,” and filed Aug. 18, 1999; U.S. Ser. No. 09/698,471, entitled “Tracking Motion of a Writing Instrument,” and filed Oct. 27, 2000; U.S. Ser. No. 09/832,340, entitled “Using Handwritten Information,” and filed August Apr. 10, 2001; U.S. Ser. No. 09/991,539 (now U.S. Pat. No. 7,257,255), entitled “Capturing Hand Motion,” and filed Nov. 21, 2001; U.S. Ser. No. 10/623,284 (now U.S. Pat. No. 7,268,774), entitled “Tracking Motion of a Writing Instrument,” and filed Jul. 17, 2003; U.S. Ser. No. 11/327,292, entitled “Tracking Motion of a Writing Instrument,” and filed Jan. 6, 2006; U.S. Ser. No. 11/327,302, entitled “Tracking Motion of a Writing Instrument,” and filed Jan. 6, 2006; U.S. Ser. No. 11/327,303, entitled “Tracking Motion of a Writing Instrument,” and filed Jan. 6, 2006; U.S. Ser. No. 11/418,987, entitled “Efficiently Focusing Light,” and filed May 4, 2006; U.S. Ser. No. 11/490,736, entitled “User Interfacing,” and filed Jul. 20, 2006; U.S. Ser. No. 11/620,201, entitled “Holding and Using an Electronic Pen and Paper,” filed Jan. 5, 2007; U.S. Ser. No. 11/733,411, entitled “Capturing Hand Motion,” and filed Apr. 10, 2007; U.S. Ser. No. 11/853,330, entitled “Tracking Motion of a Writing Instrument,” and filed Sep. 11, 2007; U.S. Ser. No. 60/096,988, entitled “Electronic Portable Pen with Inertial Navigation and External Beacon that Captures Handwriting for Input to Computers and Personal Digital Assistants (PDA),” and filed Aug. 18, 1998; U.S. Ser. No. 60/142,200, entitled “Electronic Portable Pen that Captures Handwriting and Drawing that is Downloaded to a Cellular Phone for Faxing,” and filed Jul. 1, 1999; U.S. Ser. No. 60/142,201, entitled “Electronic Portable Pen and Wristwatch,” and filed Jul. 1, 1999; U.S. Ser. No. 60/161,752, entitled “Tracking Motion of a Writing Instrument,” and filed Oct. 27, 1999; U.S. Ser. No. 60/195,491, entitled “Using Handwritten Information,” and filed Apr. 10, 2000; U.S. Ser. No. 60/230,912, entitled “Using Handwritten Information,” and filed Sep. 13, 2000, three U.S. Design patent applications Ser. Nos. 29/304,093, 29/304,096, and 29/304,108 (now U.S. Pat. No. D584,313), each filed Feb. 25, 2008; U.S. Ser. No. 61/031,034, entitled “Electronic Handwriting” and filed Feb. 25, 2008.

### BACKGROUND

This description relates to capturing and to using handwriting information.

Wireless electronic pens sometimes work with external sensors. Such sensors are sometimes mounted on a writing surface, for example, at the head of a clipboard or at the corners of a marker board.

### SUMMARY

In general, in an aspect, electronics, including a sensor, wirelessly track motion of a stylus. A receptacle, coupled to the electronics, holds the stylus when not in use. One or more mating elements coupled to the receptacle mate with one or more corresponding elements on an outer surface of the stylus when not in use. At least one retainer pushes the stylus against the mating elements.

Implementations may include one or more of the following. The electronics use infra-red light to track the motion. The electronics include software to determine an out of sight condition of the stylus. The receptacle includes a chamber in a housing. The one or more mating elements include one or more ribs that project in a direction normal to a longitudinal axis of the stylus when the stylus is held in the receptacle. The one or more ribs each have a receiving corner and the retainer applies a force in the direction of the receiving corners. The one or more corresponding elements on the outer surface of the stylus include grooves. The retainer includes a resilient arm. The retainer is configured to snap the stylus into the receptacle. The retainer includes a conductive element connected to pass a charge to a conductor on the stylus to charge a battery in the stylus. The retainer includes a coined surface and the retainer and a corresponding element of the stylus are configured so that the stylus can be inserted in either direction into the receptacle. The retainer is part of a circuit that determines whether the stylus is in the receptacle. The stylus includes at least one of a pen, pencil, marker, or other writing instrument. The stylus includes a writing instrument end and a cursor control end and the stylus can be held in the receptacle in either direction.

In general, in an aspect, a stylus—motion of which is to be tracked wirelessly by electronics, including at least one sensor, coupled to a receptacle that is to hold the stylus when not in use—has an outer surface bearing one or more stylus elements to seat on one or more receptacle elements of the receptacle and conductive elements to make electrical contact with a retainer of the receptacle to receive a charge for recharging an energy storage device in the stylus.

Implementations may include one or more of the following. The energy storage device includes a batter. The stylus includes a pen end and a mouse end. The one or more stylus elements borne on the outer surface of the stylus include grooves to receive the ribs. The conductive elements of the stylus include conductive rings around the stylus.

In general, in an aspect, a stylus has a stylus end and a cursor control end. A device wirelessly tracks motion of the stylus end or the cursor control end on any arbitrary surface.

Implementations may include one or more of the following. The stylus end leaves a visible trace on a writing surface. The cursor control end includes a pressure sensor, and interpretation of traced motion of the cursor control end is based on a sensed pressure level. A threshold of the sensed pressure level is configured by a user. Interpretation of tracked motion of the cursor control end is based on a state of a user-operable switch. The tracking of motion can be absolute based on a reference location or relative to a location at which a recent touching of a surface occurred.

In general, in an aspect, a wireless stylus has its motion tracked wirelessly by electronics. An end of the stylus has flared gripping elements arranged around its circumference.

Implementations may include one or more of the following. The flared gripping elements are arranged approximately 120 degrees apart from each other. The flared gripping elements have a substantially flat outwardly facing surface. The flared gripping elements include the largest circumference of the stylus. A tip of the stylus may comprise a writing element, a non-writing element, or both. The tip of the stylus is operable to select between the writing element and the non-writing element.

These and other aspects and features, and combinations of them, may be expressed as methods, apparatus, systems, means for performing functions, program products, and in other ways.

In general, in another aspect, a stylus contains a light source and a light conductor to conduct the light along the stylus. The light source is controlled to provide to the tracking electronics an indication of a state of operation of the stylus. Implementations may include one or more of the following features. The state includes at least one of a loss of wireless connection, a loss of power in the stylus, a blocking of a line of sight from the light source to a sensor and the sensor being out of range.

In general, in an aspect, a holder for an electronic stylus includes a cavity in which the stylus can be placed when not in use. The cavity includes a receptacle at one end for a writing end of the stylus and a stop at the other end. The stop has an opening into which an opposite end of the stylus can be placed. The receptacle has a resilient element to urge the stylus against the stop.

Implementations may include one or more of the following features. The stop includes an element for electrically detecting a presence of the stylus. There are electrical contacts for connecting the stylus electrically to a source of charging for a battery in the stylus. The resilient element comprises a spring.

In general, in an aspect, an angle at which an electronic stylus is oriented to a non-electronic writing surface is detected, and the detected angle is used in processing handwriting information derived from the stylus.

Implementations may include one or more of the following features. The electronic stylus comprises a writing element that leaves a mark on the writing surface. The writing element leaves marks on the writing surface having a range of color and other parameters that depend on the angle, and the detected angle is used with information about the trajectory of the writing element to capture the parameters. The writing element comprises a pencil, a brush, or a marker. The detected angle is used to cancel an effect caused by the tilt angle. The detected angle is used to infer the parameters from the trajectory. The captured parameters faithfully represent the marks on the writing surface.

In general, in an aspect, information received from an electronic stylus is representative of a force being applied by the stylus against a writing surface. The stylus has two functional ends. The force information is received with respect to a use of either end of the stylus.

Implementations may include one or more of the following features. The information is received from the stylus indicating which of the ends is being used. The information is encoded in light that is also used by a separate device to track motion of the stylus. The light modulation is used to separate the tracking information from the end-in-use information. The one end serves as a mouse and the other end as a stylus.

In general, in an aspect, a motion of an electronic stylus is expressed in a data file that represents a page of writing. The file data includes a page size, a date and time of creation, and a set of data points representing a trajectory of the pen, each of the data points comprising two spatial coordinates and a value of pressure.

In general, in an aspect, a user can navigate temporally through a display of handwriting data that is stored in a data file and that was derived from an electronic stylus. The user can identify a beginning or an end of a segment of handwriting that is to be kept in the file.

Implementations may include one or more of the following features. The segment comprises a page. The user can identify more than one of the segments, each segment to be stored in a separate data file.

In general, in an aspect, users can be enabled to collaborate by accepting information entered by the users' writing with electronic styli on writing surfaces and displaying the handwriting of more than one of the users simultaneously in a manner that is visible to the users.

Implementations may include one or more of the following features. The handwriting is displayed through an online collaboration facility. The handwriting is displayed on an electronic white board. The handwriting is overlaid on a non-handwritten image. The handwriting of the different users is displayed in a common area. The handwriting of different users is displayed in separate areas.

In general, in an aspect, a document to be signed is displayed to a user on a device. While the user is signing his name on a surface using an electronic stylus, the signature is captured electronically and displayed on the document to be signed. The user can move the signature relative to the displayed document until the signature is in a proper location of the document. The user can send the document with the properly located signature to a remote location.

Implementations may include one or more of the following features. The characteristics of the signature including at least one of the pressures applied to the stylus, the angles at which the electronic stylus is oriented to the surface, and the velocity of the stylus are stored with the document as a profile of the signature. The profile of the signature is compared with a previously stored profile of the user's signature to determine authenticity. In some examples, the profile of the signature is compared with a previously stored profile or statistically averaged for variations to determine authenticity.

In general, in an aspect, a signature that a user has written using an electronic stylus is captured electronically. Metadata is also captured representing characteristics of the signature including pressures applied to the stylus during the writing of the signature. The metadata is used to authenticate a signature that purports to be a signature of the user, based on metadata representing characteristics of the purported signature.

Implementations may include one or more of the following features. The metadata also includes angles of orientation of the stylus to a writing surface. The metadata includes information about the pressures over time while the signature is written.

In general, in an aspect, an electronic stylus enables electronic capture of data representing a trajectory of the stylus as it is moved across a writing surface. The stylus includes a device to detect a level of a force between the stylus and the writing surface as the stylus is moved across the writing surface.

Implementations may include one or more of the following features. The device detects the level of force at successive locations of the stylus on the writing surface.

In general, in an aspect, an untethered electronic stylus enables electronic capture of data representing a trajectory of the stylus as the stylus is moved across a writing surface. The data capture is enabled by providing information about the trajectory from the stylus to an external device. A communication channel to the electronic stylus is used to control an aspect of the operation of the stylus.

Implementations may include one or more of the following features. The external device receives the information about the trajectory using light from the stylus. The communication channel from the external device to the stylus is carried on light. The external device comprises a holder for the electronic stylus. The communication channel to the stylus is from the external device. The communication channel to the stylus is from another device.

In general, in an aspect, data representing a trajectory of an electronic stylus is electronically captured as the electronic stylus is moved across a writing surface. Data representing a force of the electronic stylus against the writing surface is also captured as the electronic stylus is moved across the writing surface. An interpretation of the captured data is altered depending on the level of the force.

Implementations may include one or more of the following features. The captured data is interpreted as if the stylus were a mouse when the level of force is lower than a threshold. The captured data is interpreted as if the stylus were a pen when the level of the force is higher than a threshold. The captured data is interpreted as if the stylus were a mouse when the force is zero and the stylus is hovering over but not touching the writing surface. The pen may be used as a stylus when connected to a computer. This may be in conjunction with an application on the computer. An infra red (IR) emitter on the pen may be kept on all the time such that the IR emitter emits signals even when the pen is off the surface. The tip of the stylus may be tracked even when it is moving within a certain space off the surface.

These and other features and aspects, and combinations of them, may be expressed as methods, systems, apparatus, program products, means for performing a function, business methods, and in other ways.

Other advantages and features will become apparent from the following description.

### DESCRIPTION

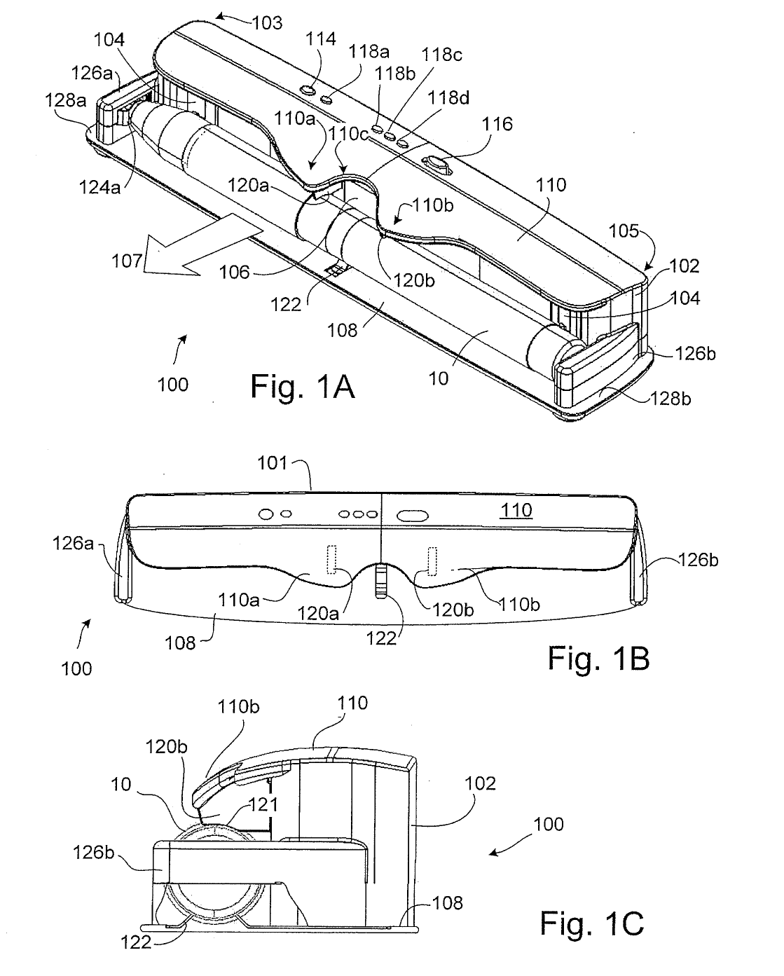

FIGS. 1A and 21 are front isometric views of a pen holder and pen.

FIG. 1B is a top view of a pen holder.

FIG. 1C is a side view of part of a pen holder and pen.

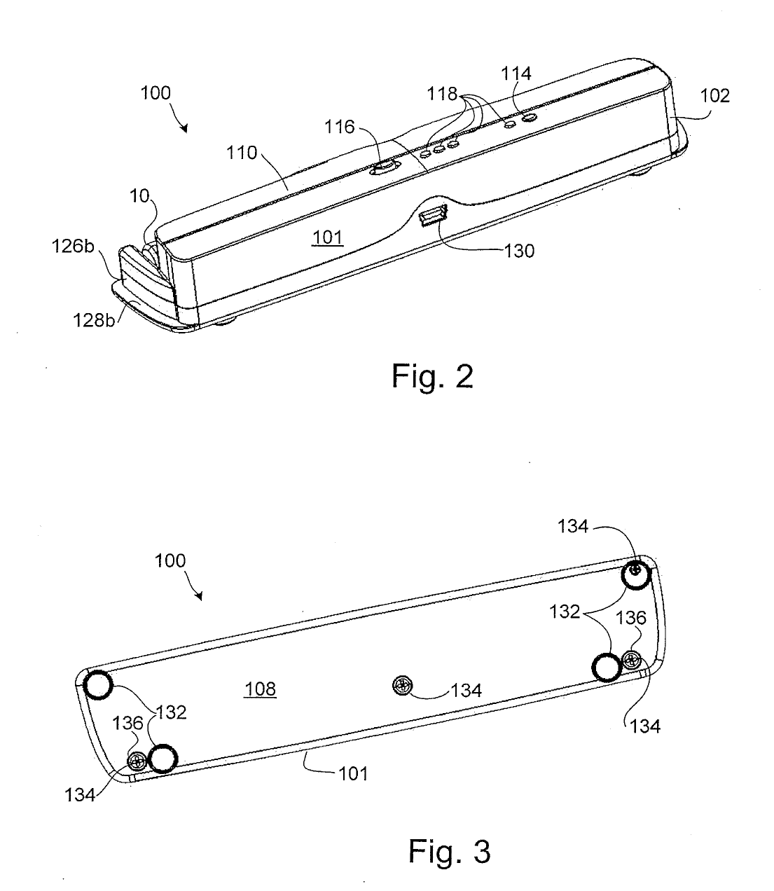

FIG. 2 is a rear isometric view of a pen holder and pen.

FIG. 3 is a bottom view of a pen holder.

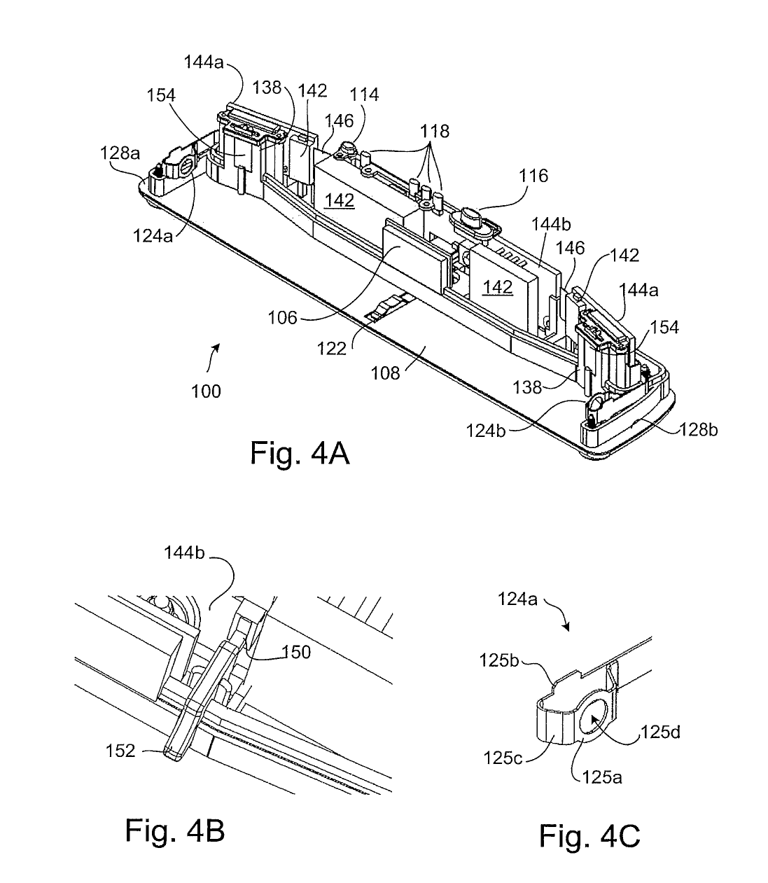

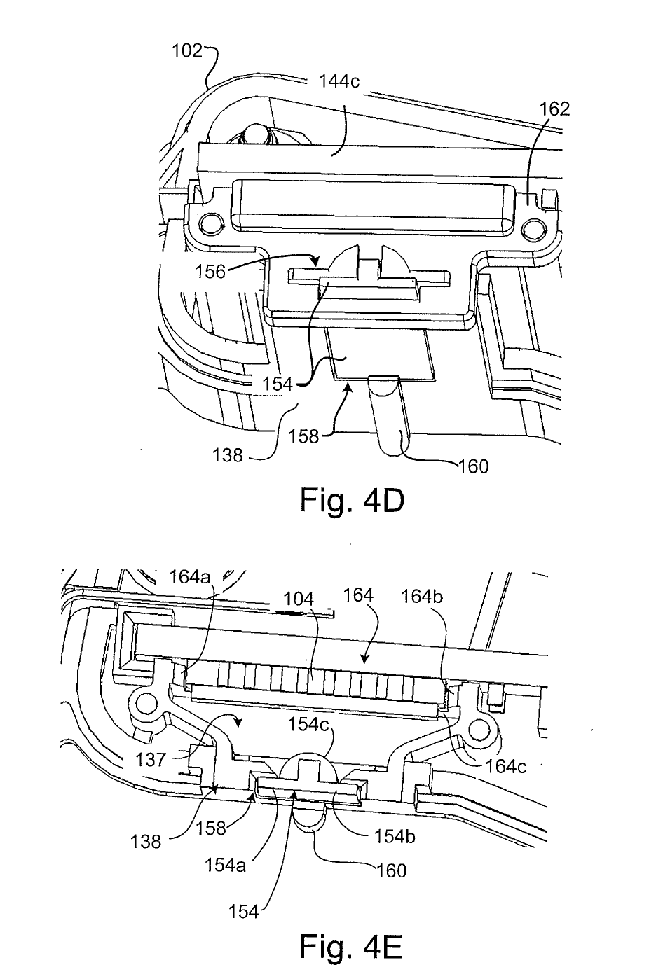

FIG. 4A is a front isometric view of internal components of a pen holder.

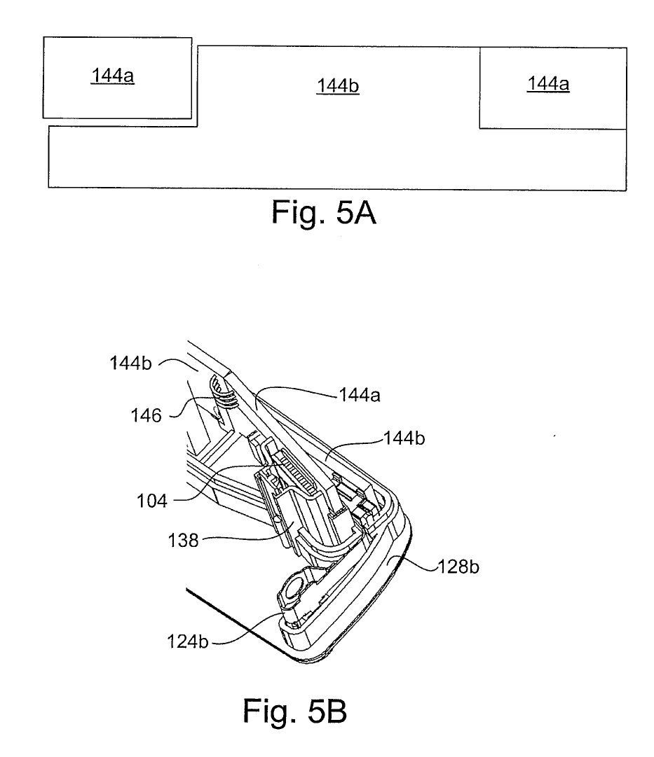

FIGS. 4B-4E and 5B are isometric views of details of internal components of a pen holder.

FIG. 5A is a schematic view of a circuit board.

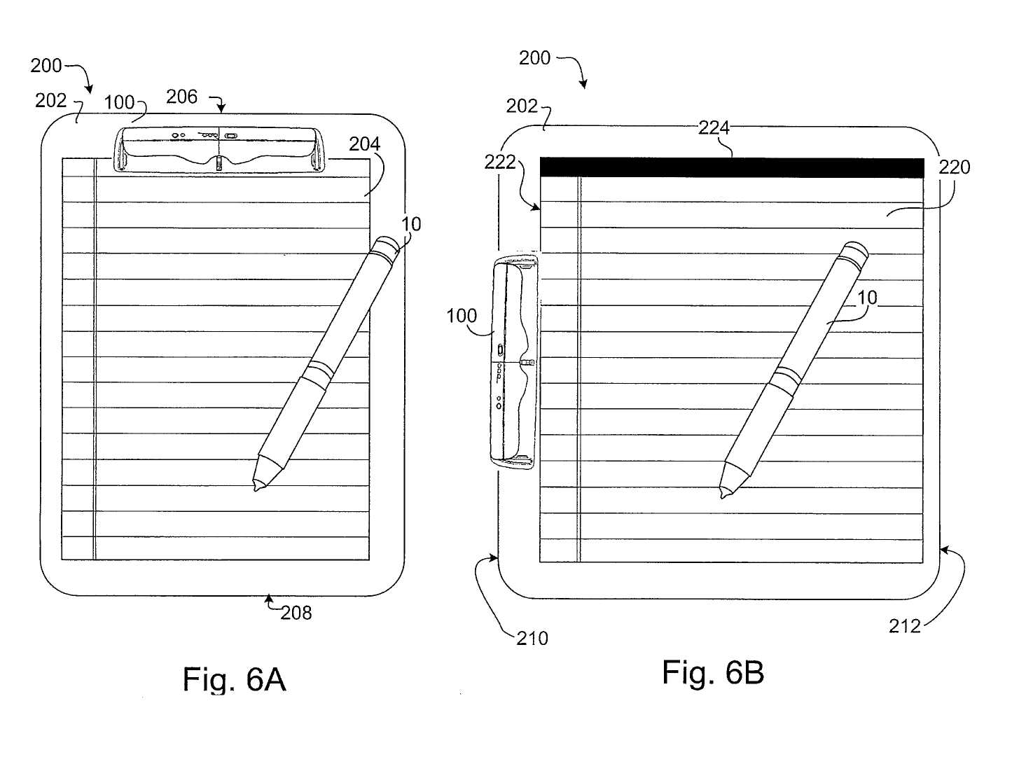

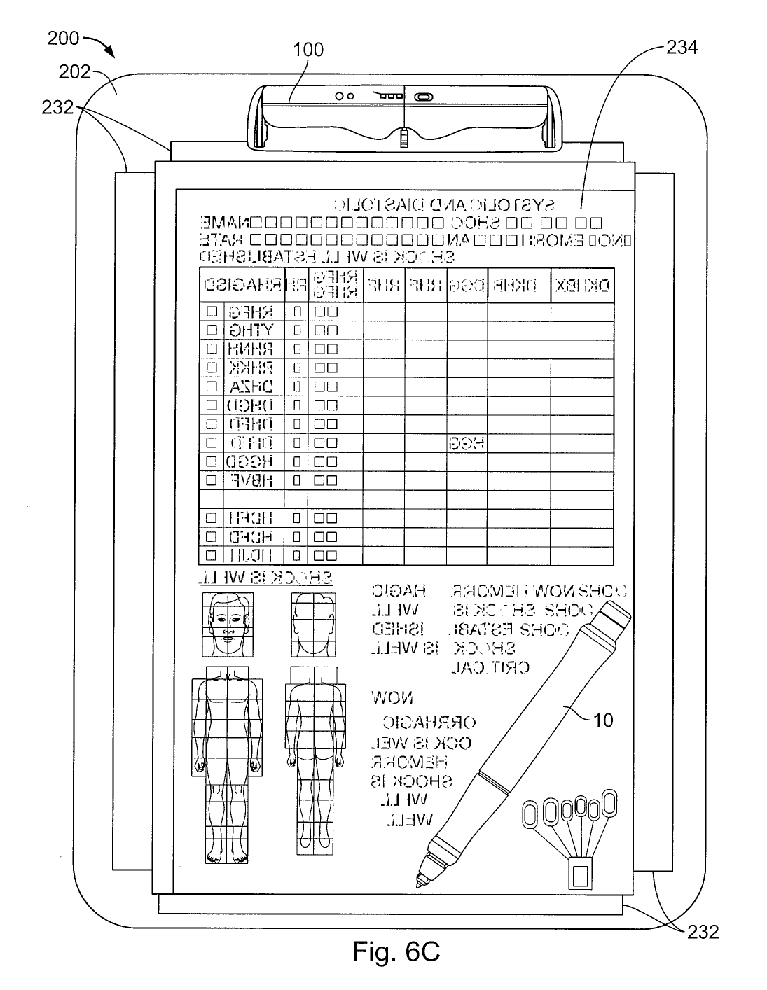

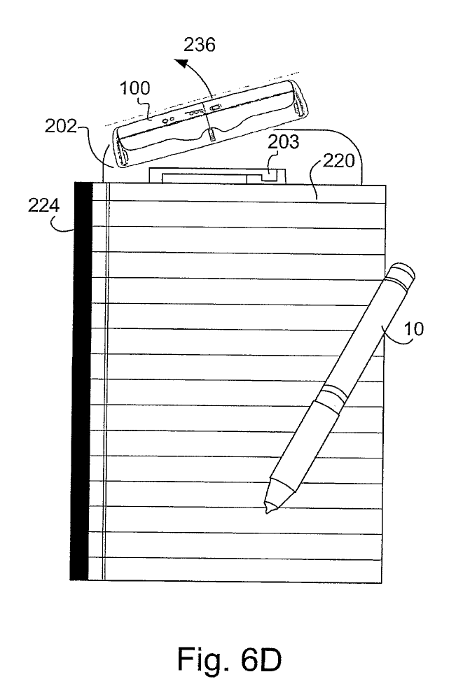

FIGS. 6A-6D are views of clipboards including pen holders and pens.

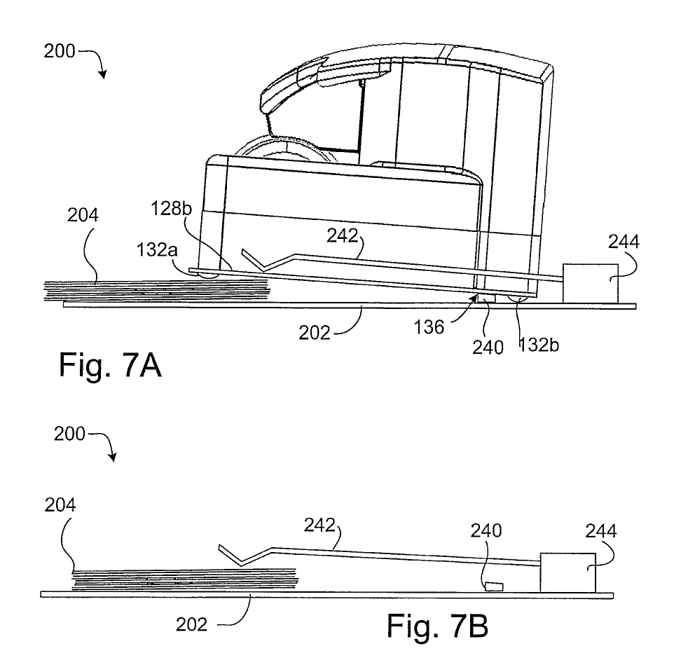

FIG. 7A is a side view of a detail of a clipboard and pen holder.

FIG. 7B is a side view of a detail of a clipboard.

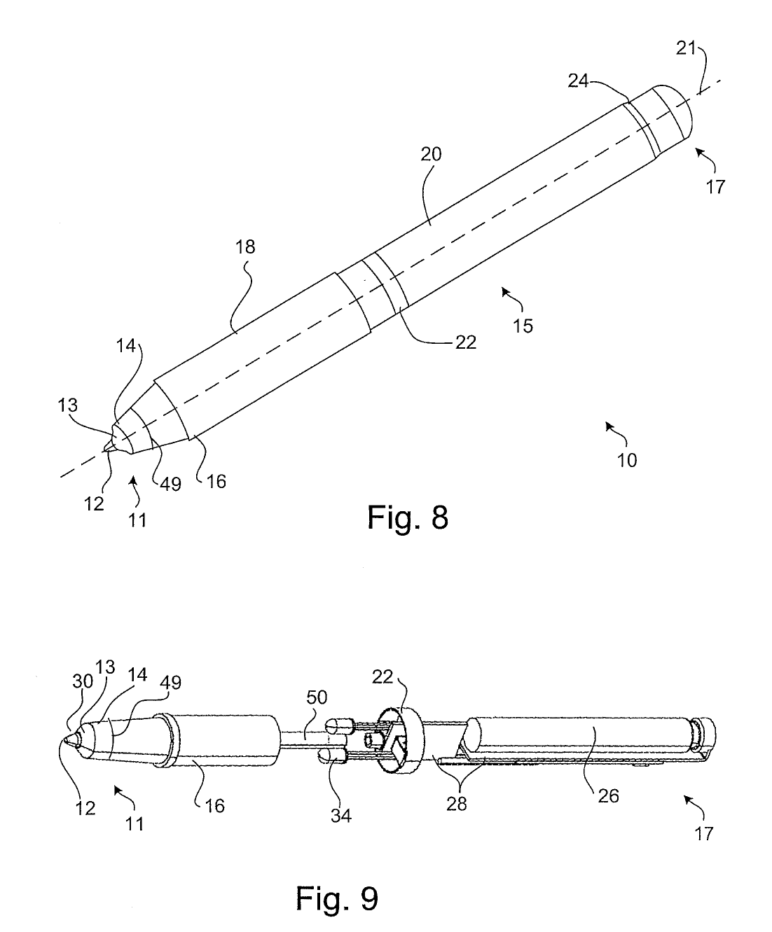

FIGS. 8 and 22 are isometric views of pens.

FIG. 9 shows components of a pen.

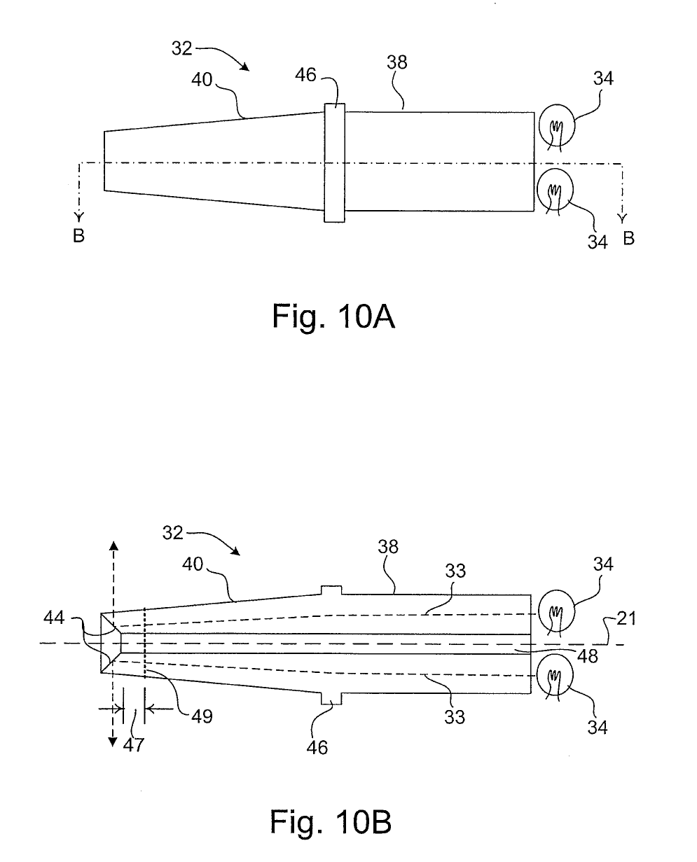

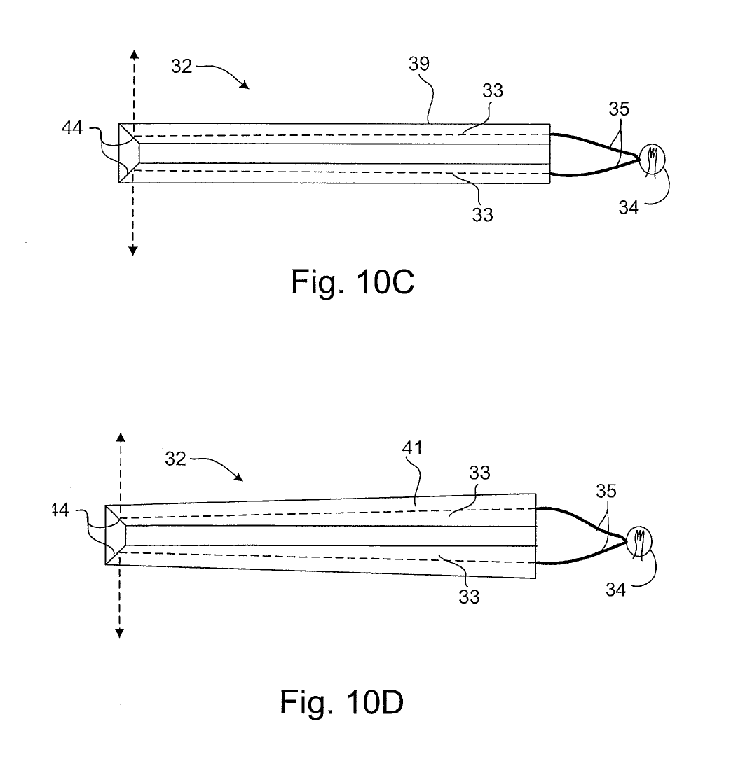

FIG. 10A is a plan view of a light guide.

FIGS. 10B-10D are cross-section views of light guides.

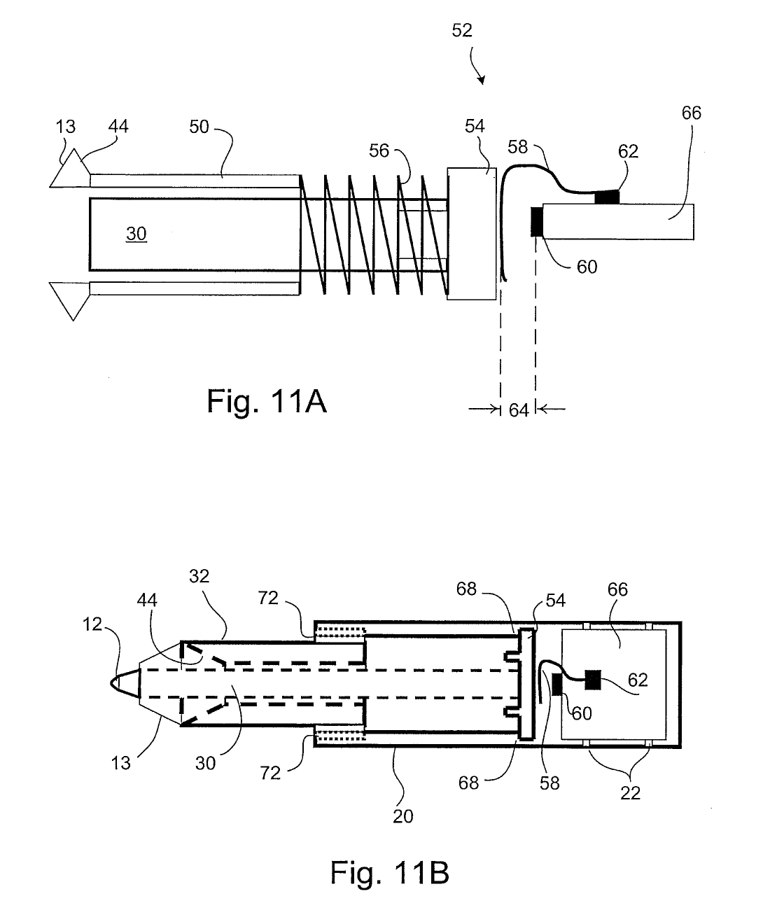

FIGS. 11A and 11B are schematic views of components of a pen.

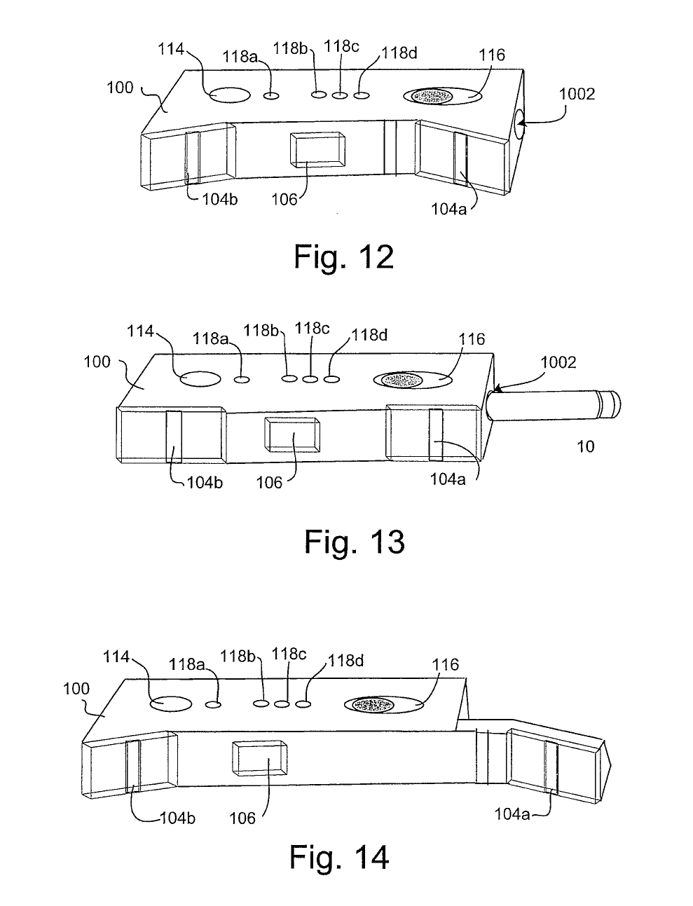

FIGS. 12-14, 20, 23A, and 23B are front isometric views of pen holders.

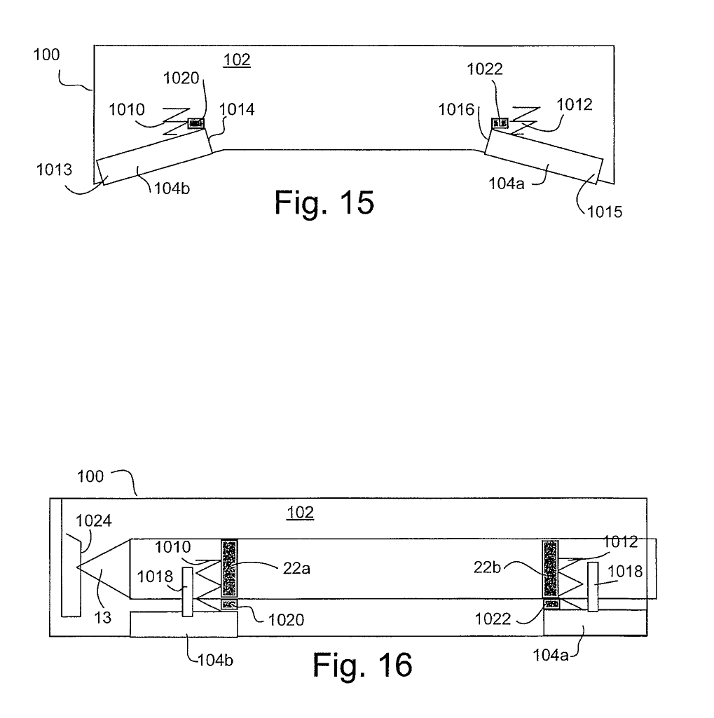

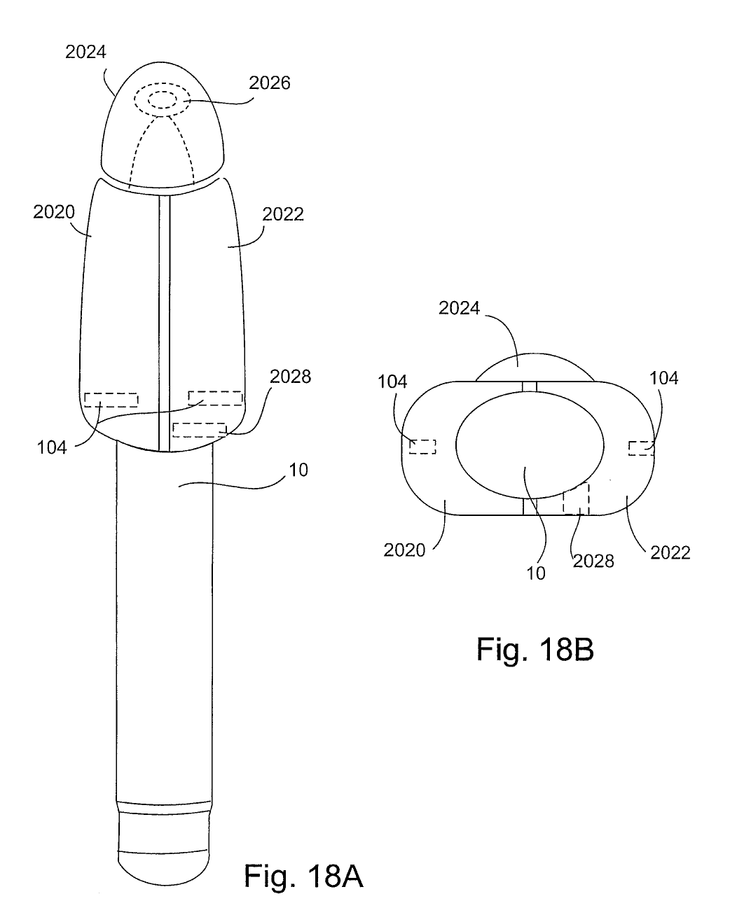

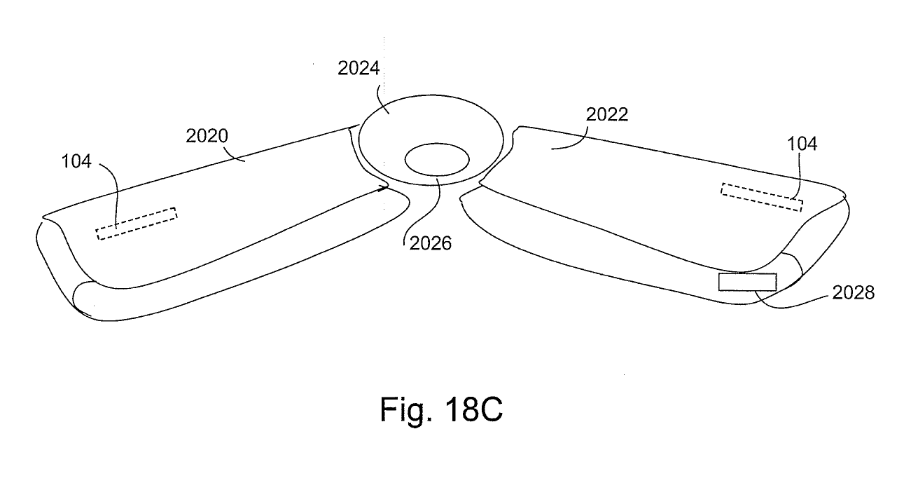

FIGS. 15 and 18C are schematic views of a pen holder.

FIGS. 16, 18A-18B, and 19A-19B are schematic views of a pen holder and pen.

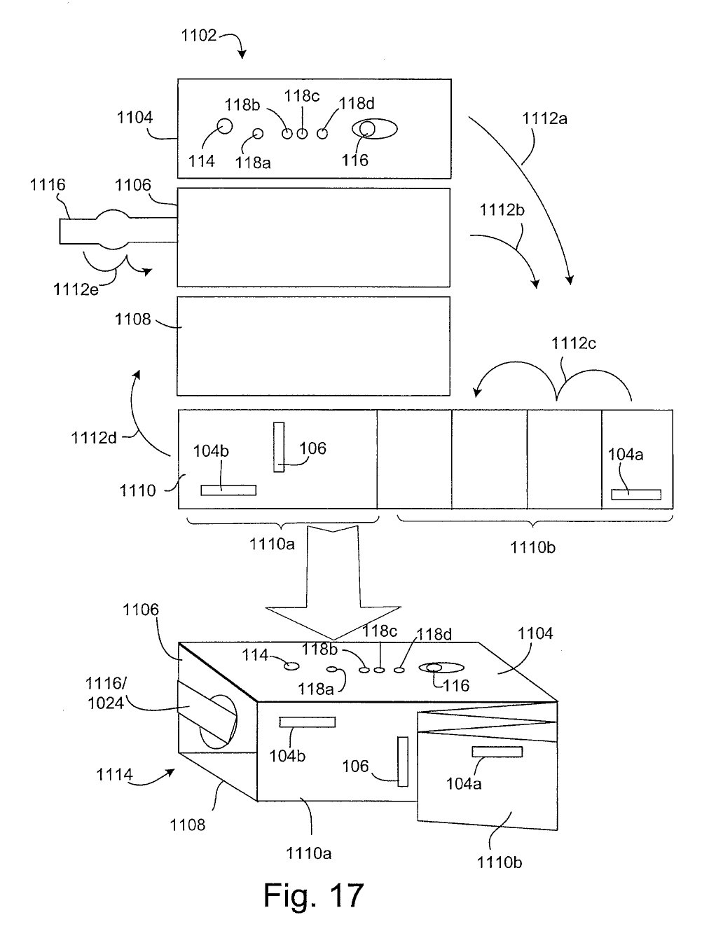

FIG. 17 is a schematic view of a circuit board.

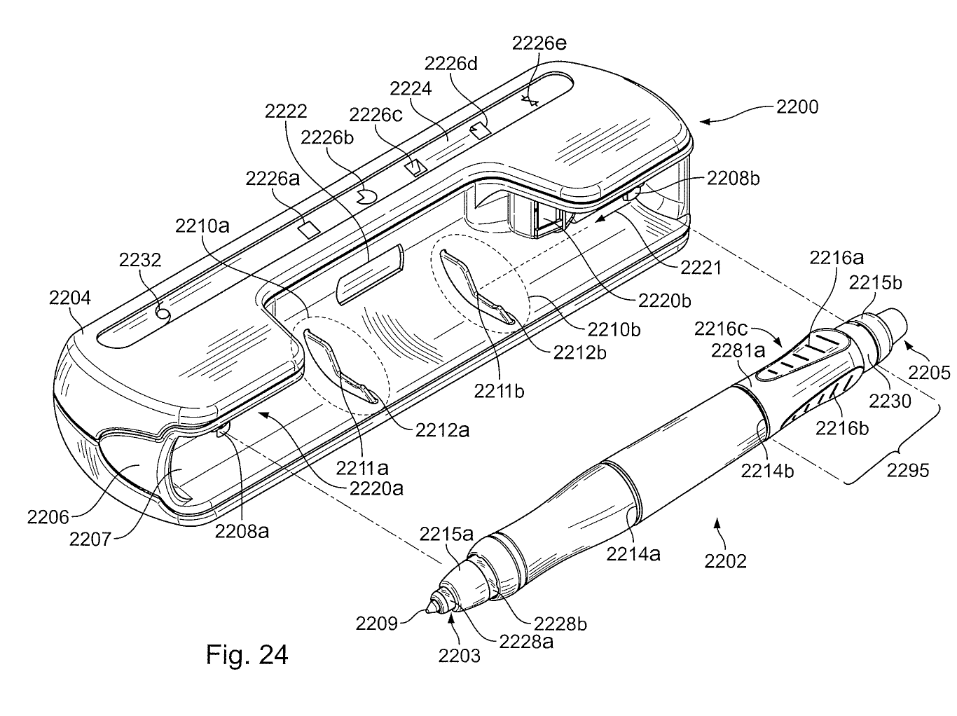

FIG. 24 is a perspective view of a pen and pen holder.

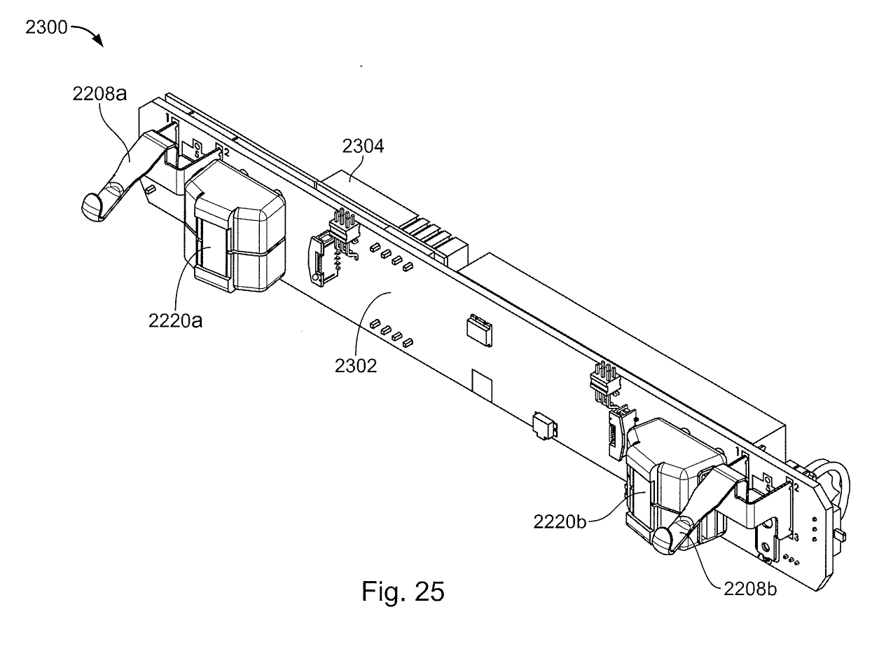

FIG. 25 is a perspective view of a board assembly.

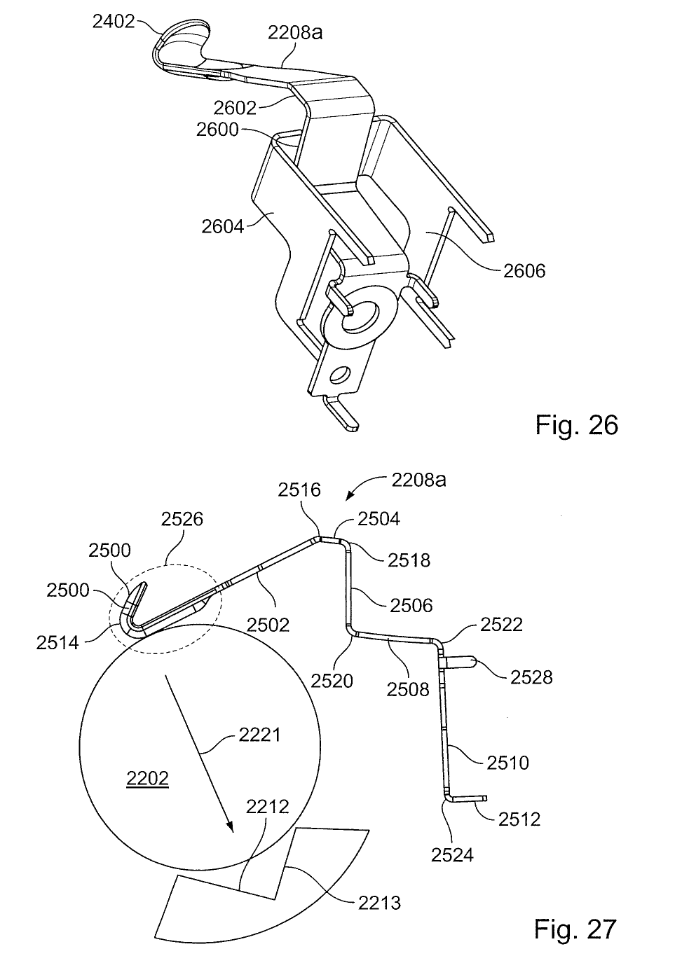

FIG. 26 is a schematic view of a contact assembly.

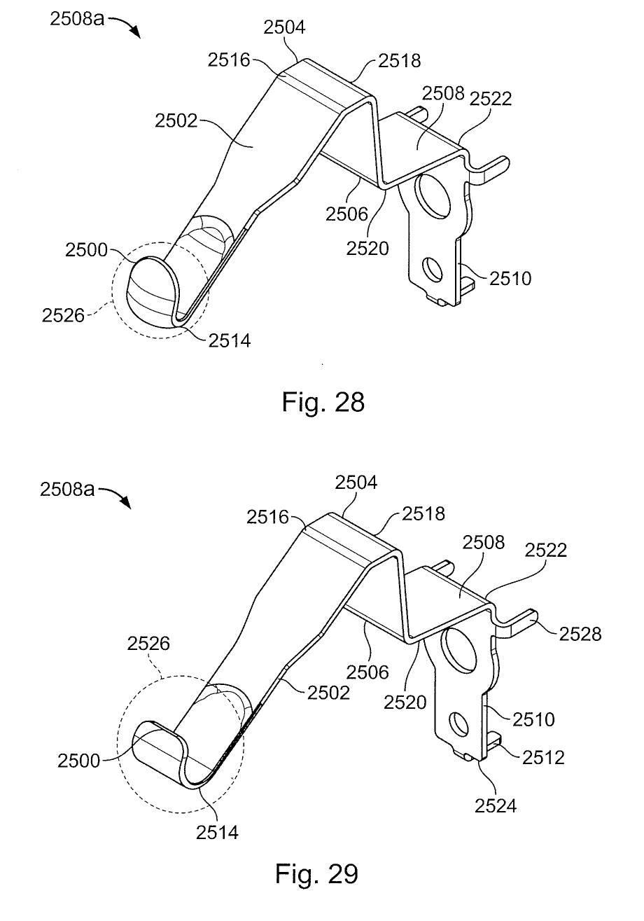

FIGS. 27 and 28 are side and perspective views of a contact arm.

FIG. 29 is a perspective view of a contact arm.

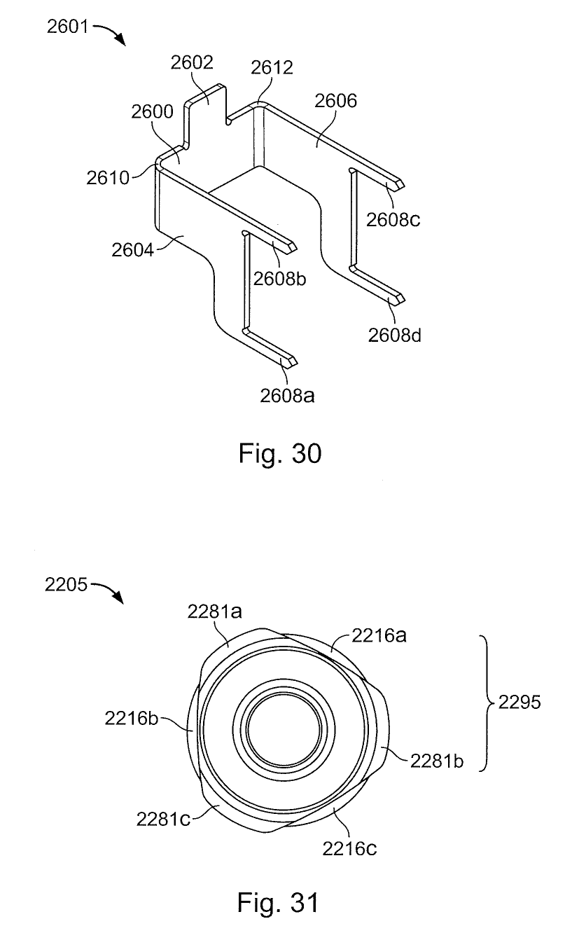

FIG. 30 is a perspective view of a detect contact.

FIG. 31 is a front view of a mouse end of a stylus.

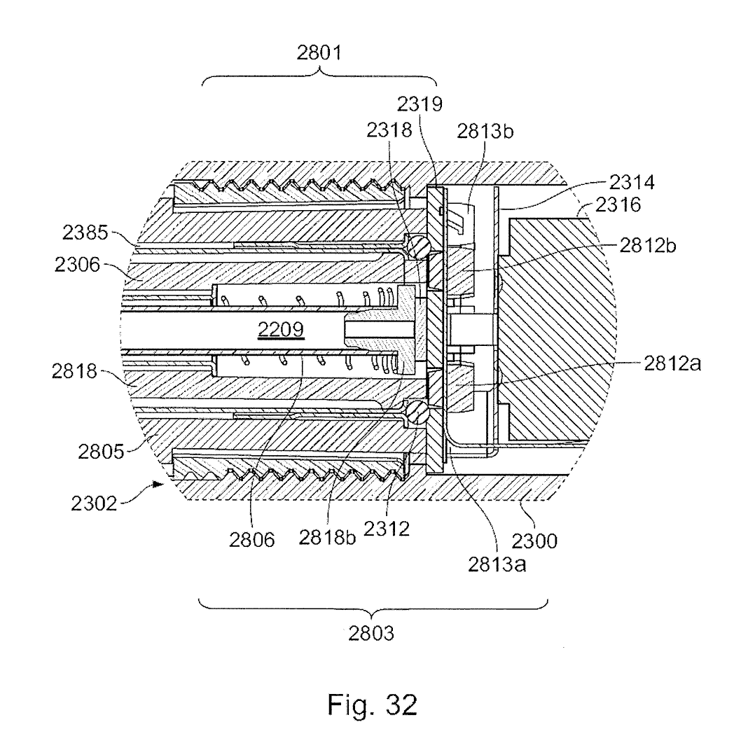

FIG. 32 is a cross sectional view of a portion of a stylus near a stylus end.

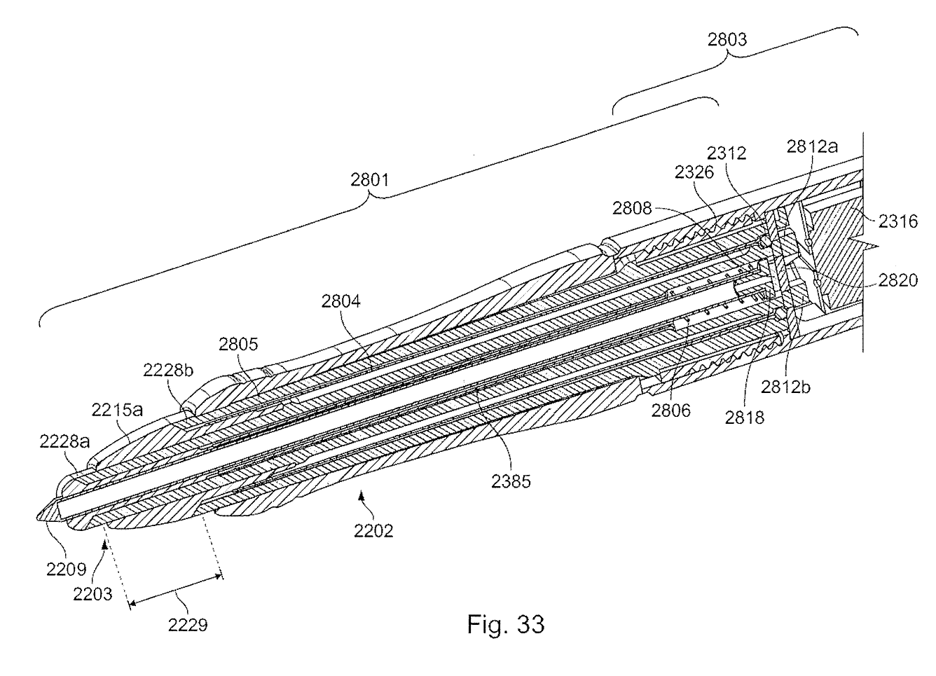

FIG. 33 is a sectional perspective view of a portion of a stylus near a stylus end.

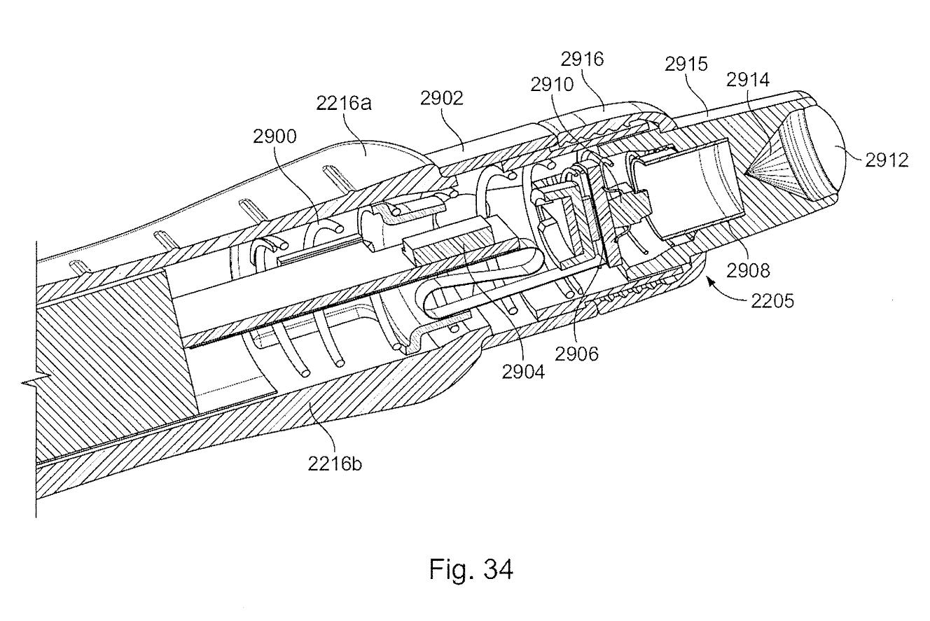

FIG. 34 is a sectional perspective view of a mouse end of a stylus.

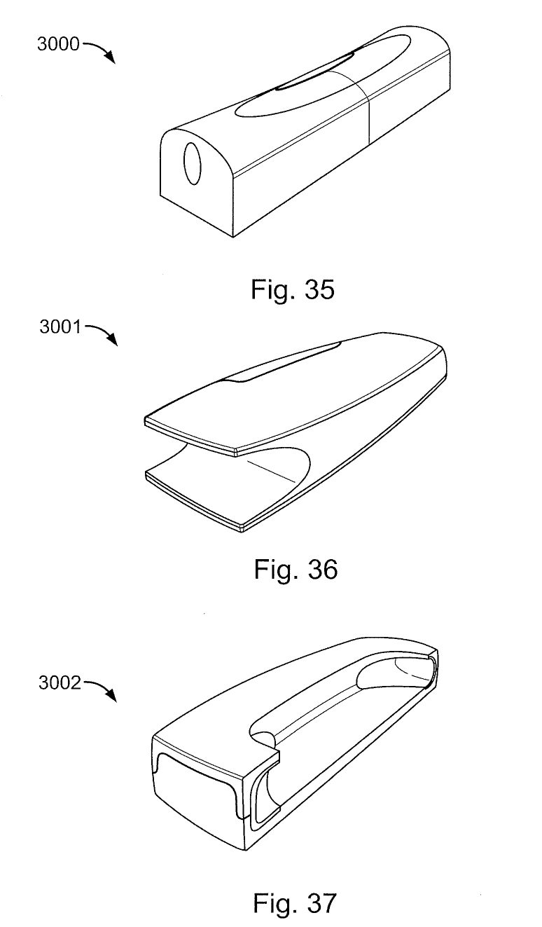

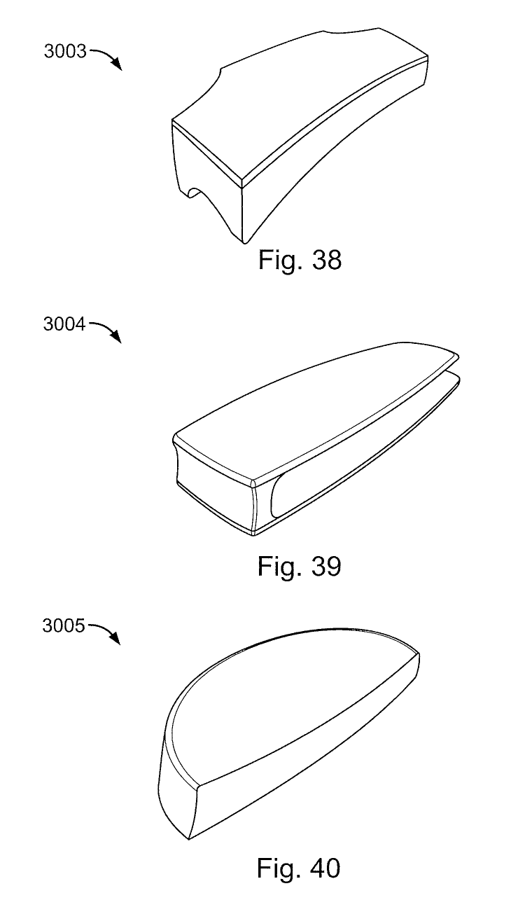

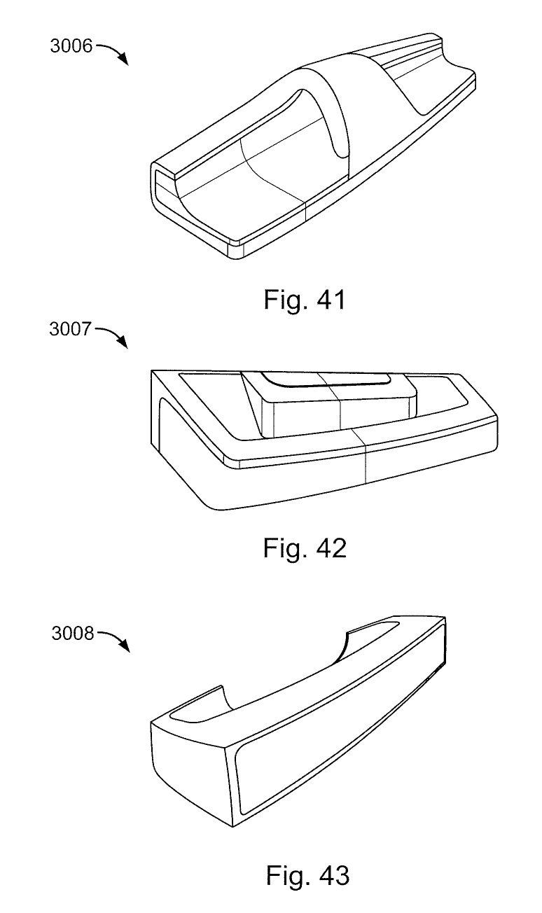

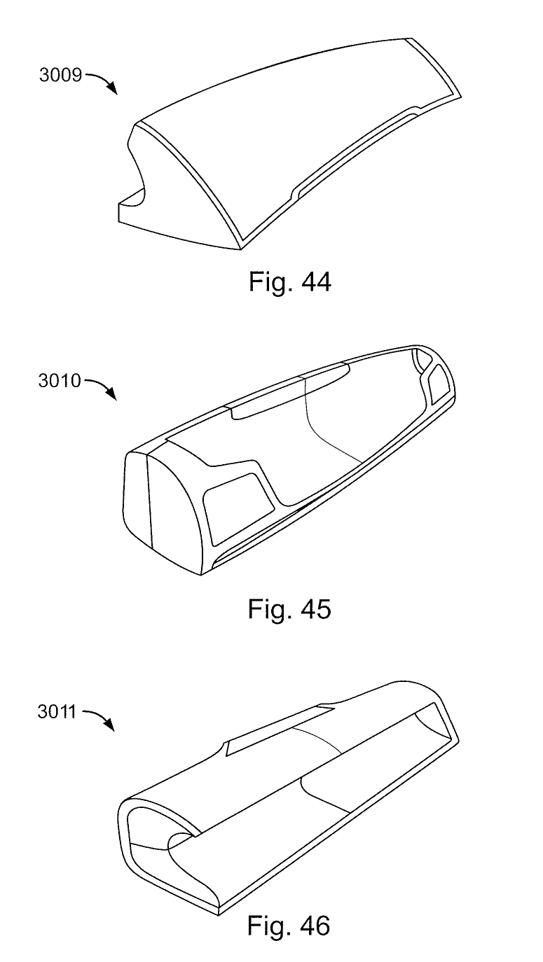

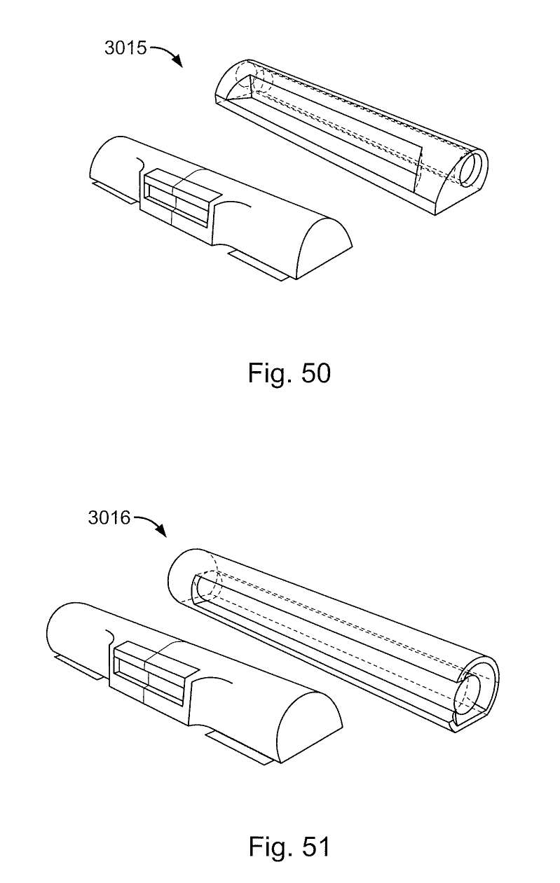

FIGS. 35-54 are perspective views of pen holders.

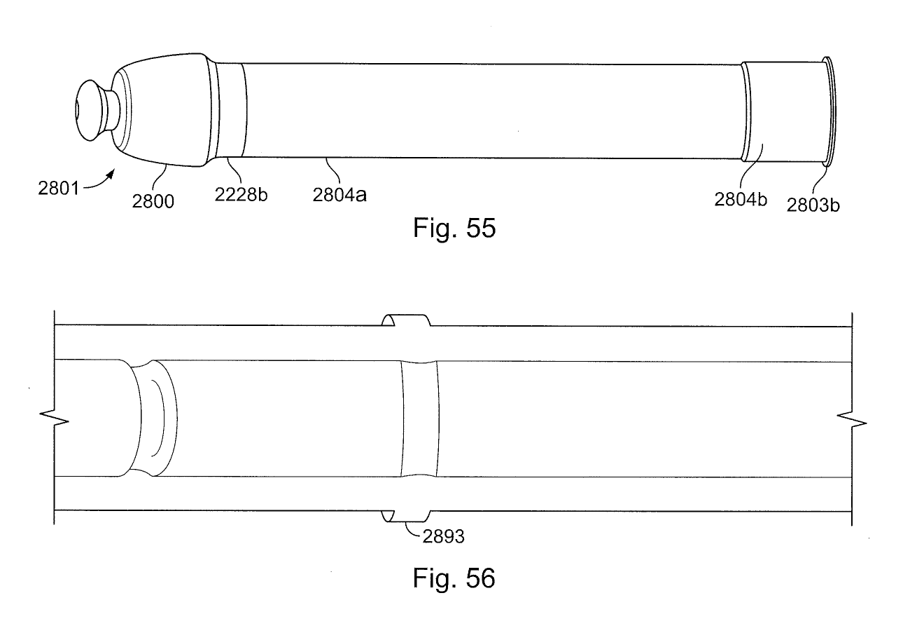

FIGS. 55-57 are perspective views of portions of a pen subassembly.

FIG. 58 is a perspective view of a mouse subassembly.

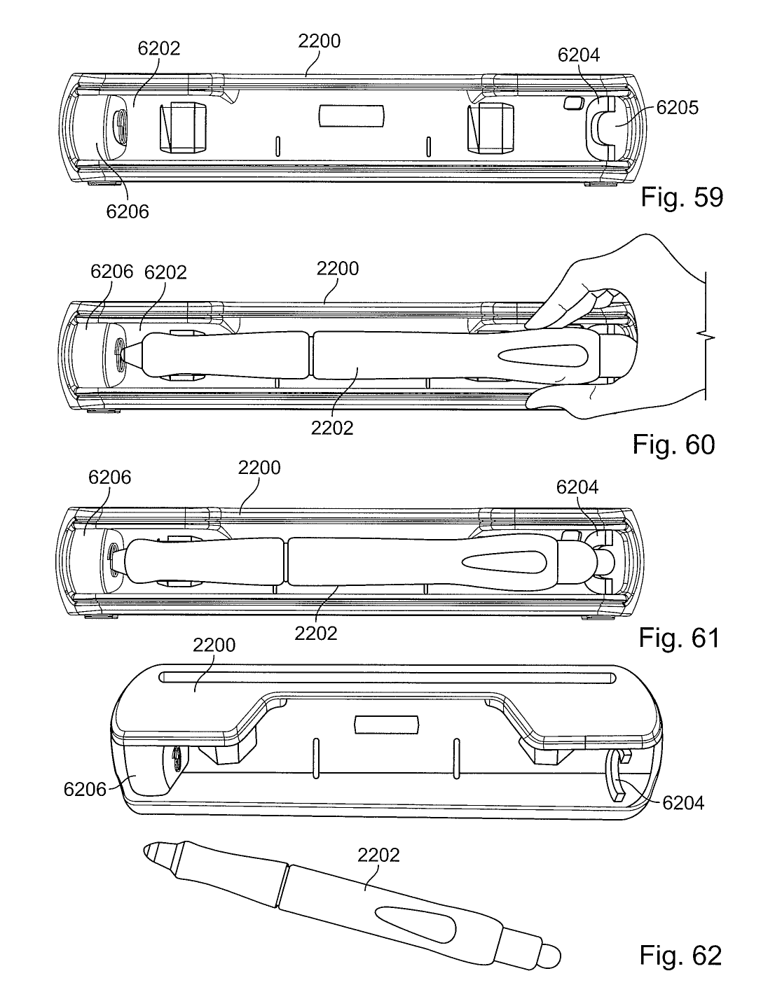

FIG. 59 is a perspective view of a pen holder.

FIGS. 60-62 are perspective views of a pen and a pen holder.

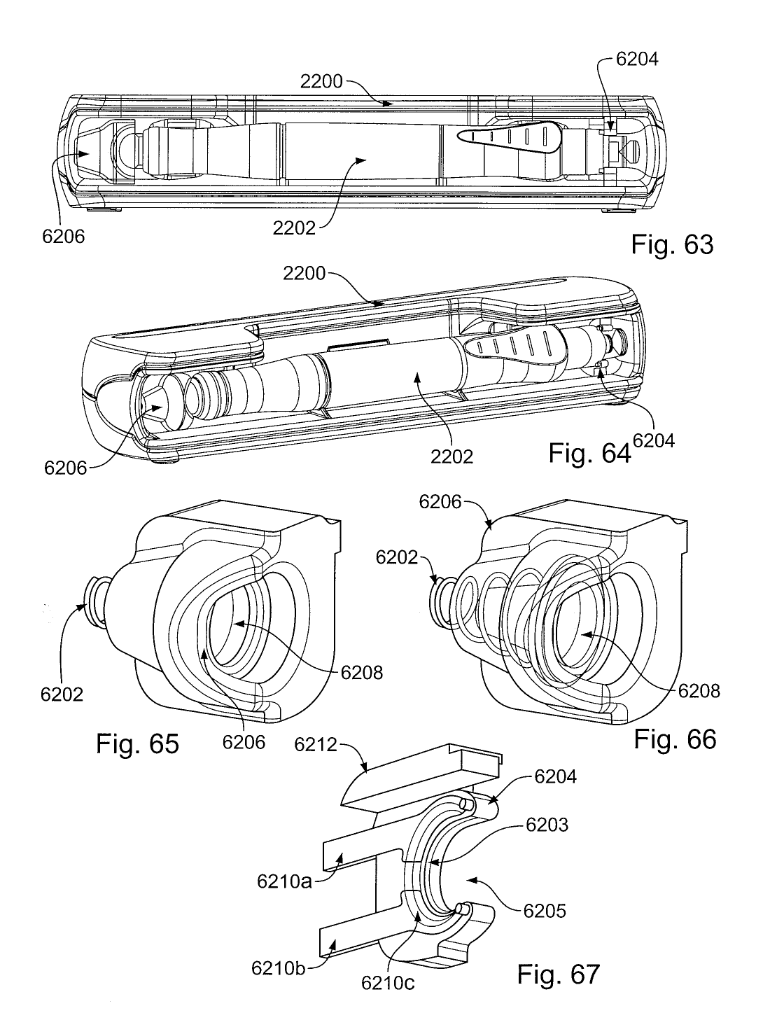

FIGS. 63 and 64 are views of a model pen and a pen holder.

FIGS. 65-66 are schematic views of a front-end contact of a pen holder.

FIG. 67 is a schematic view of a back-end contact of a pen holder.

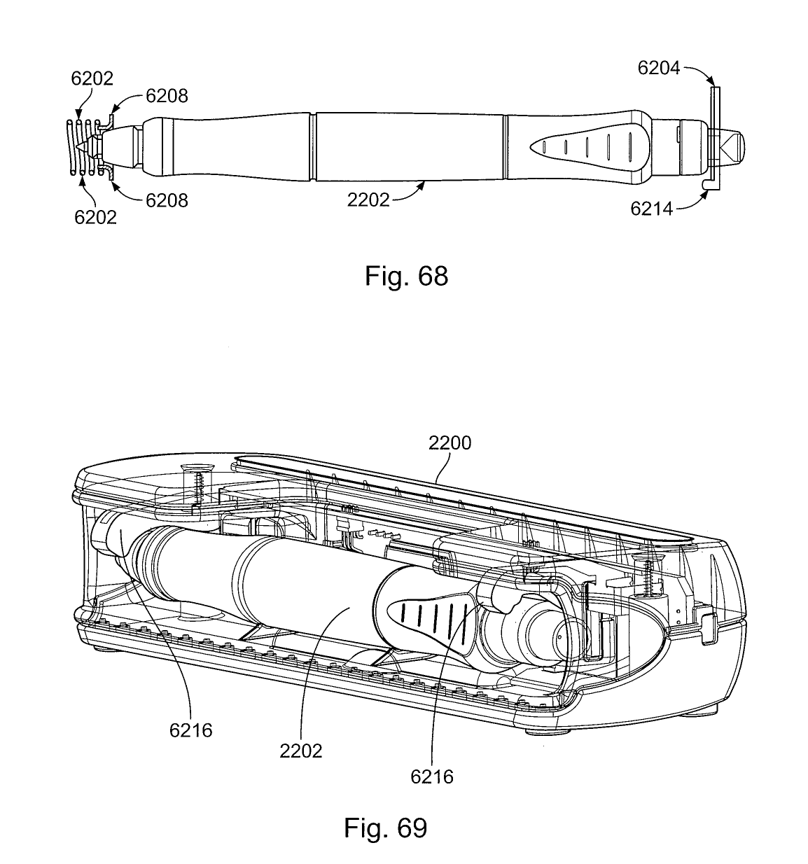

FIG. 68 is a view of a model pen.

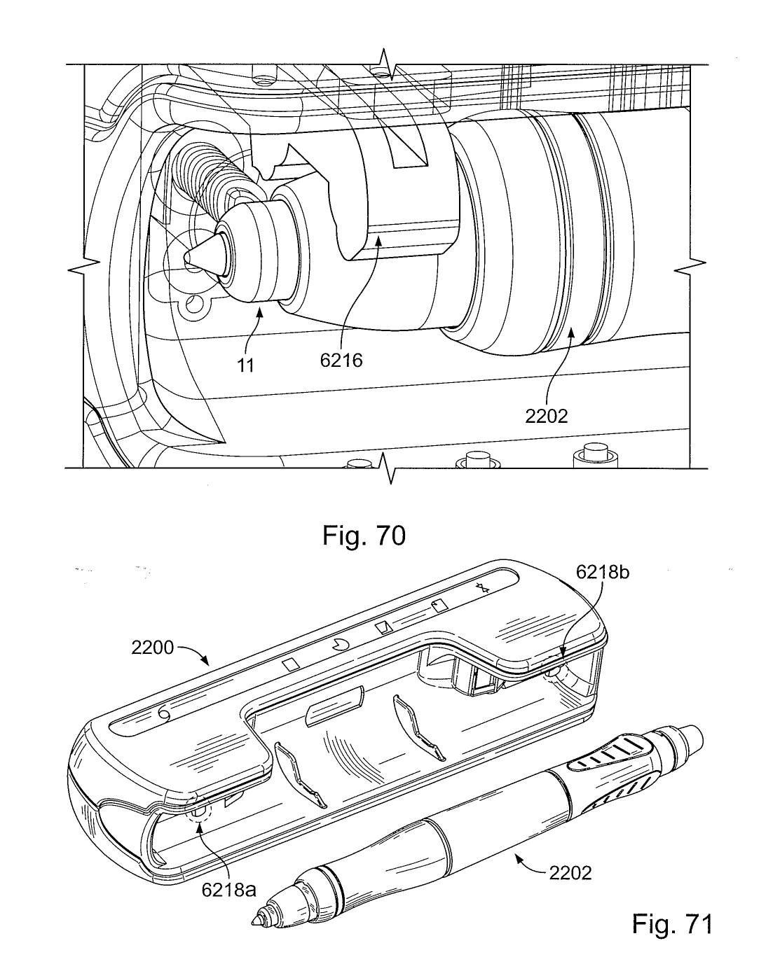

FIGS. 69-70 are schematic views of a pen inside a pen holder.

FIG. 71 is a view of a pen and a pen holder.

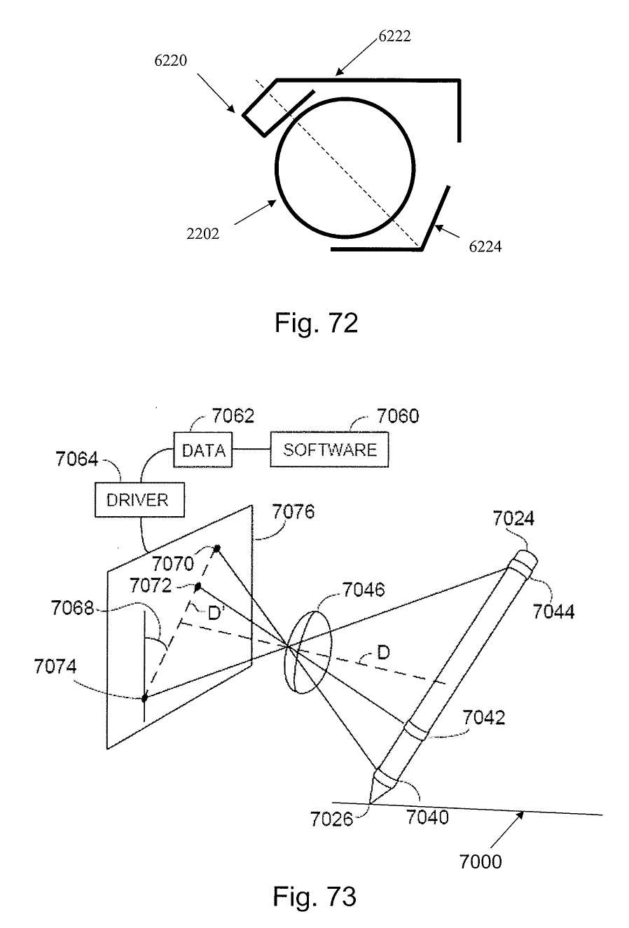

FIG. 72 is a cross-section of a pen, a spring, and a part of a pen holder.

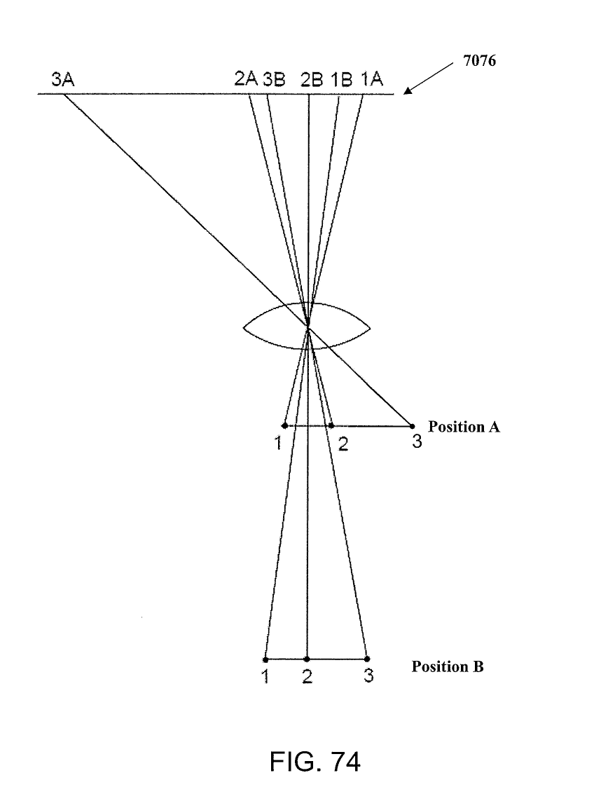

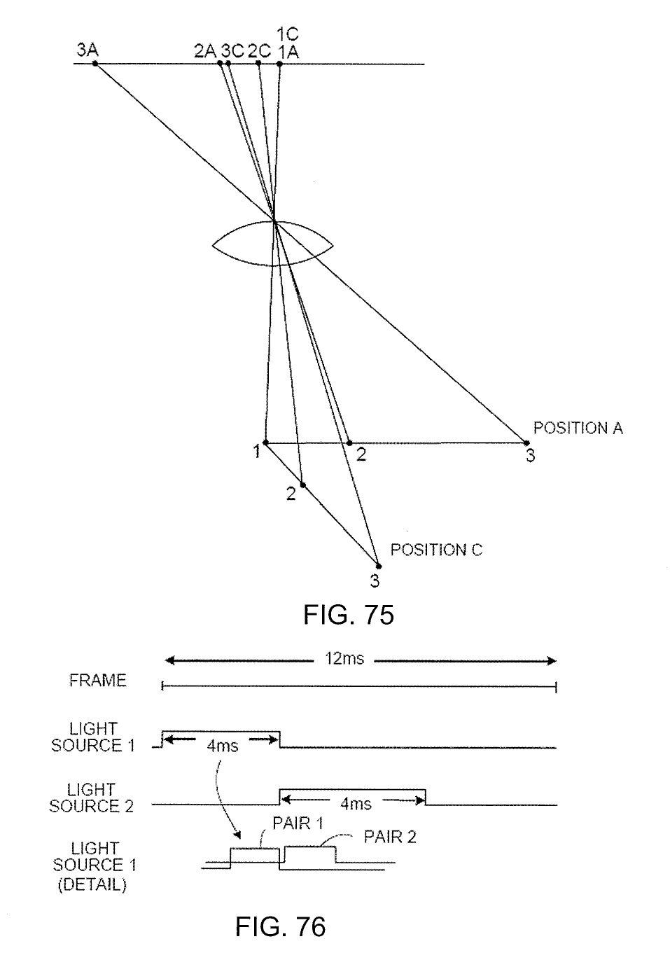

FIGS. 73-75 illustrate tilt and distance computations.

FIG. 76 is a timing diagram.

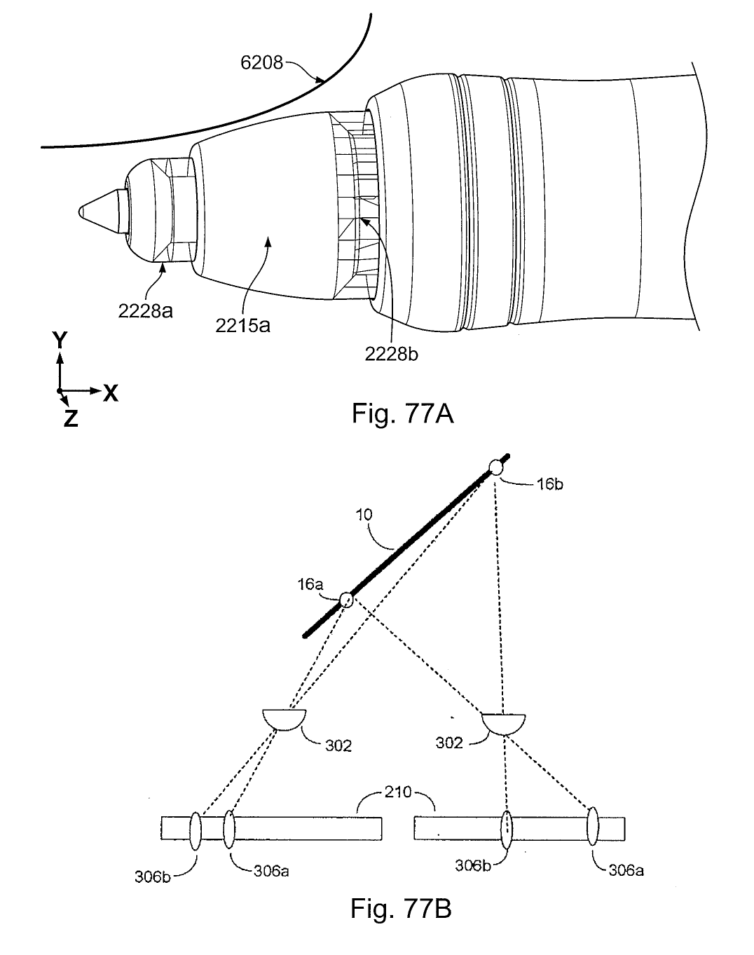

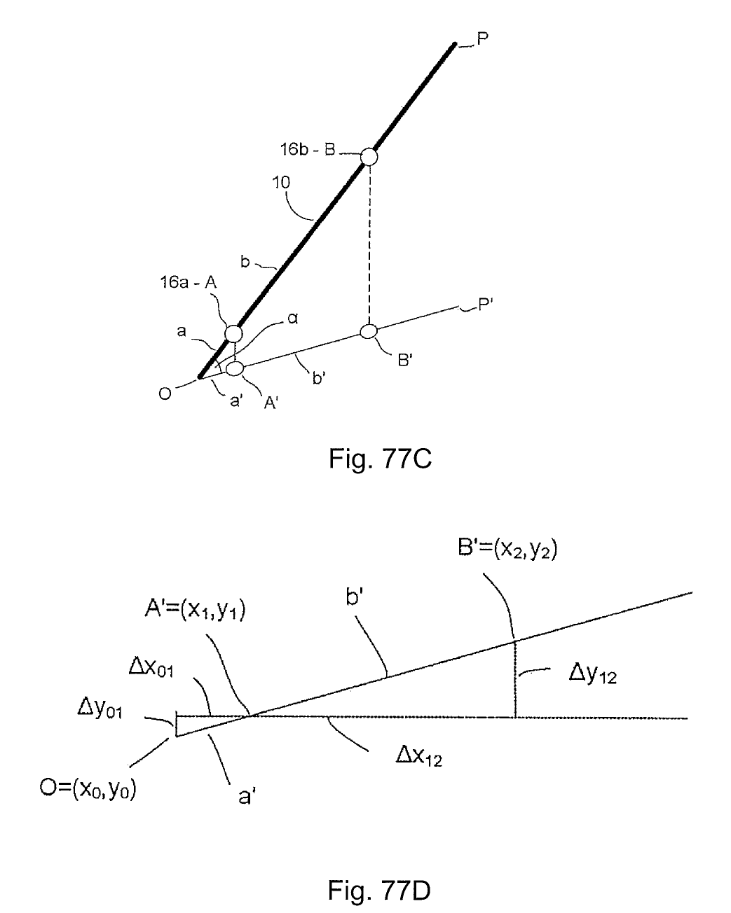

FIG. 77A is a schematic view of a pen and part of a pen holder.

FIGS. 77B-D illustrate tilt and distance computations.

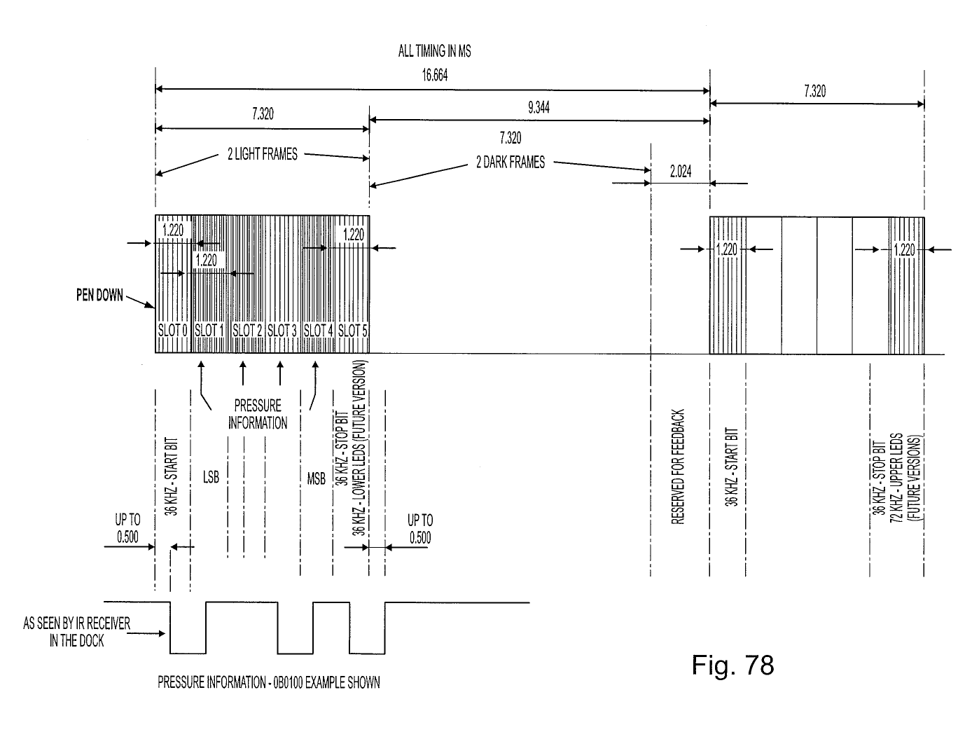

FIG. 78 is a timing diagram.

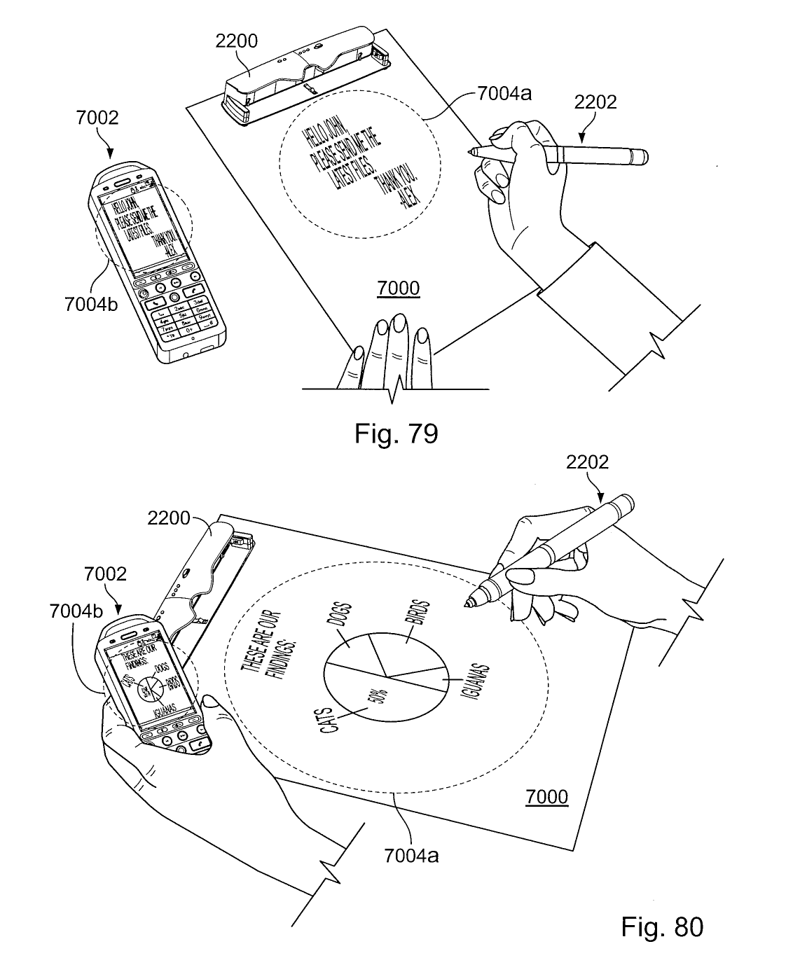

FIGS. 79-80 are views of a pen, a pen holder, a writing surface, and a cell phone.

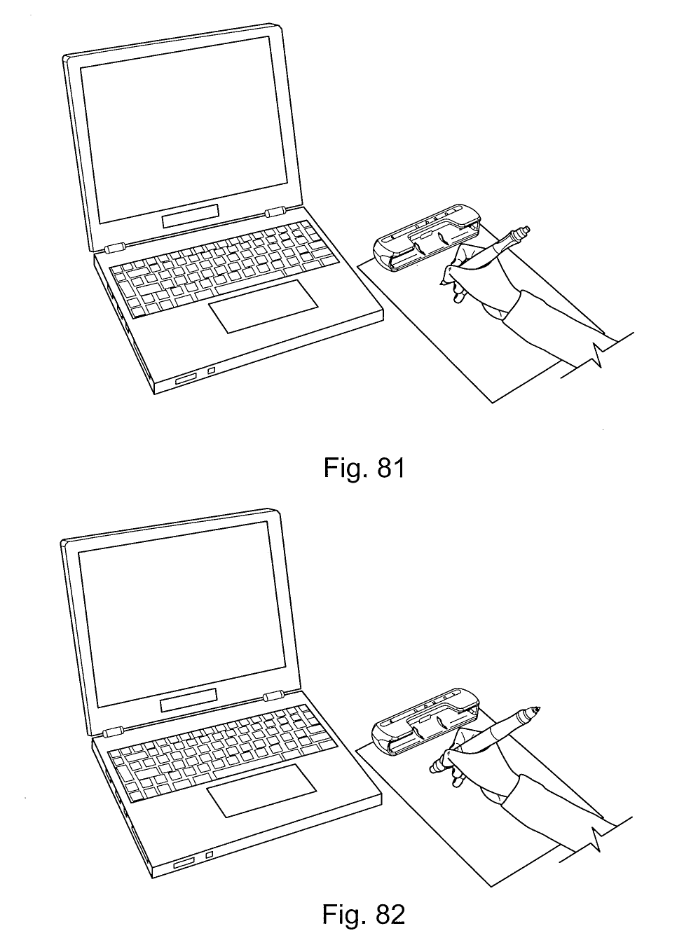

FIGS. 81-82 are views of a pen, a pen holder, a writing surface, and a computer.

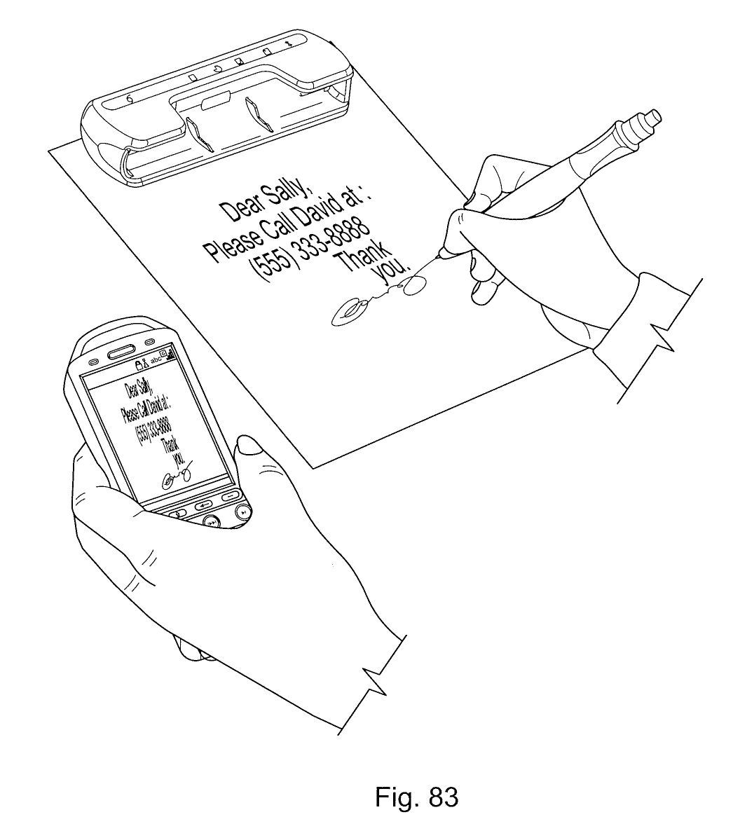

FIG. 83 is a view of a pen, a pen holder, a writing surface, and a cell phone.

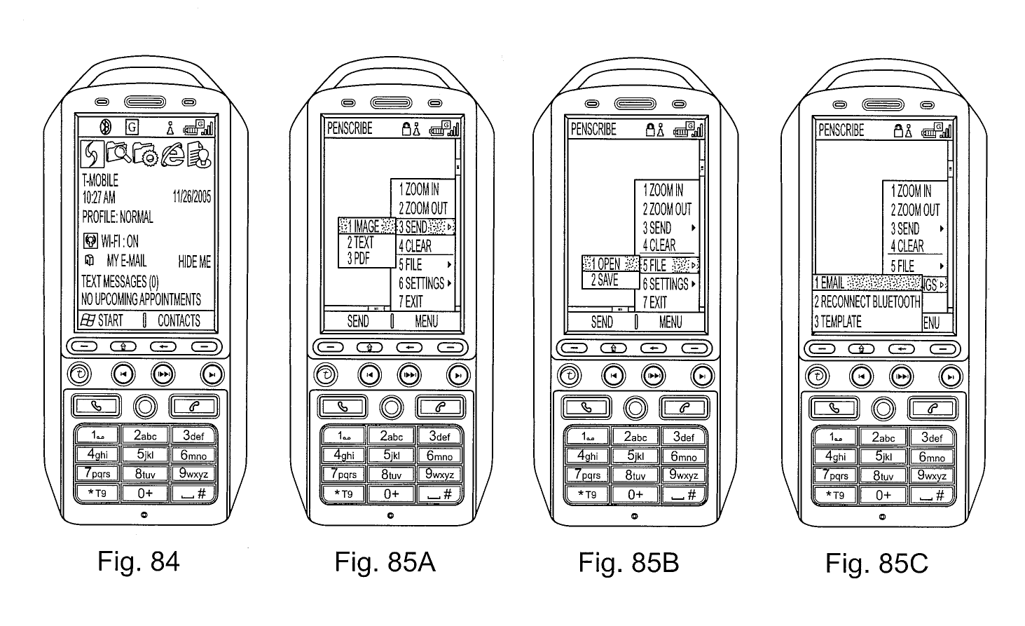

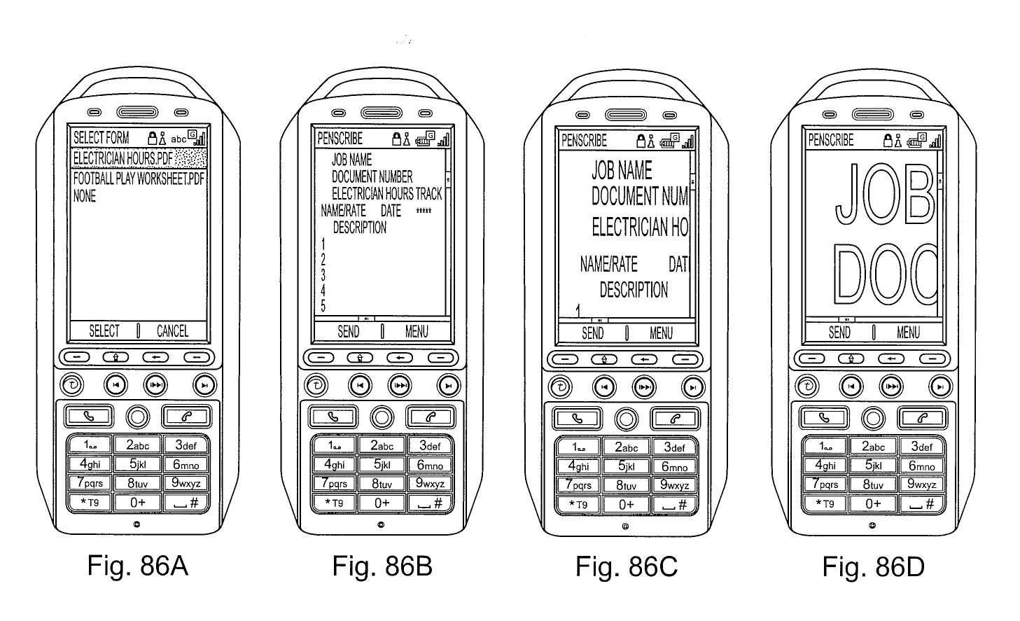

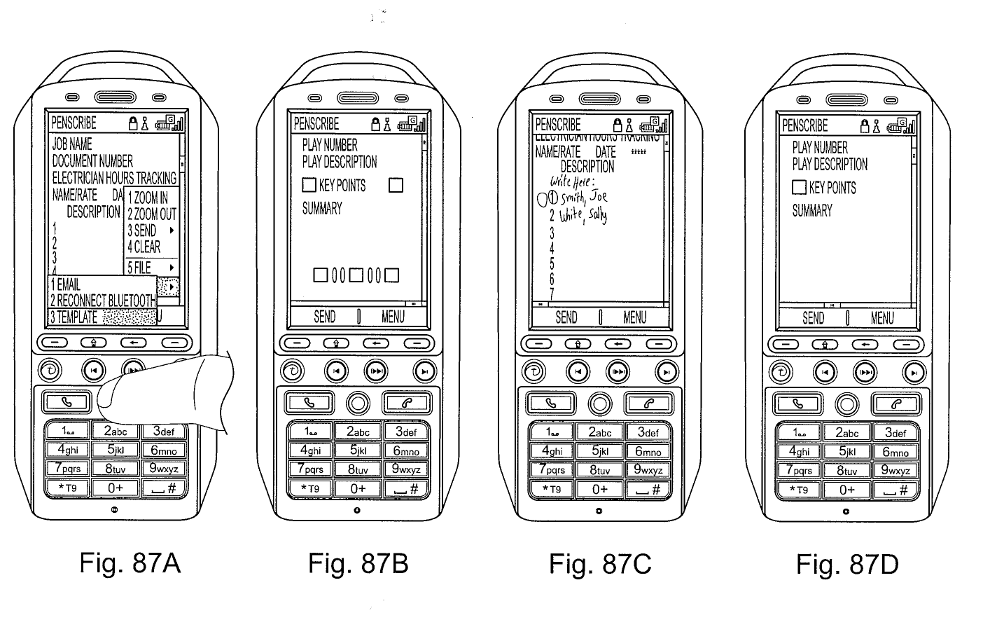

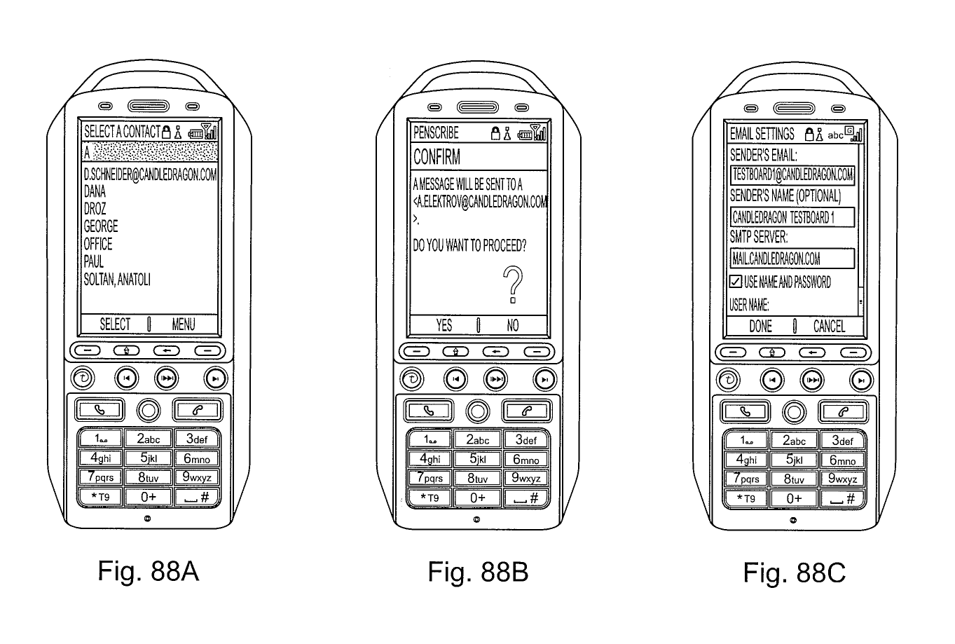

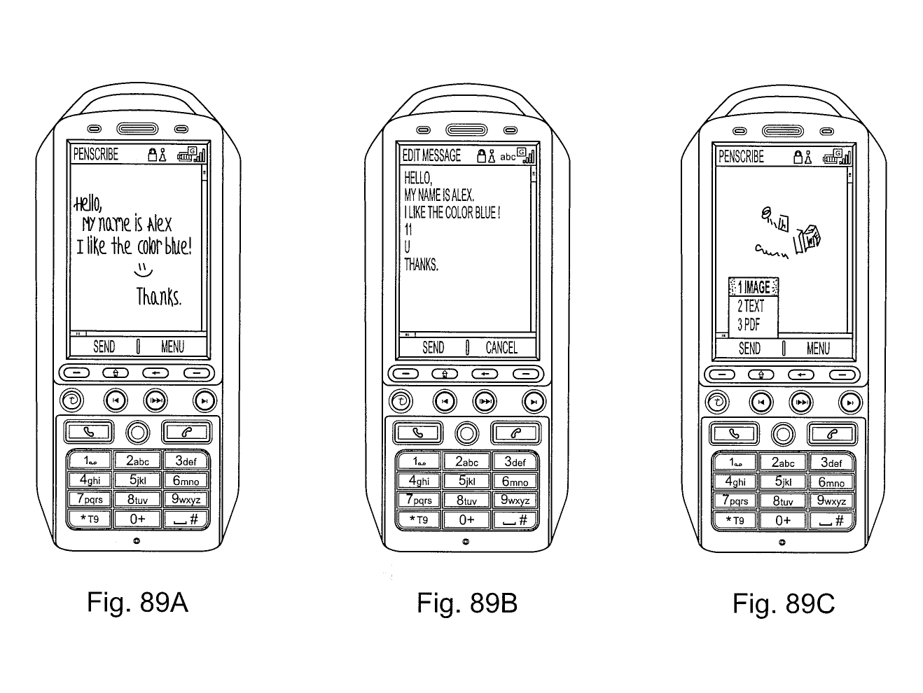

FIGS. 84-89C are views of a cell phone interface.

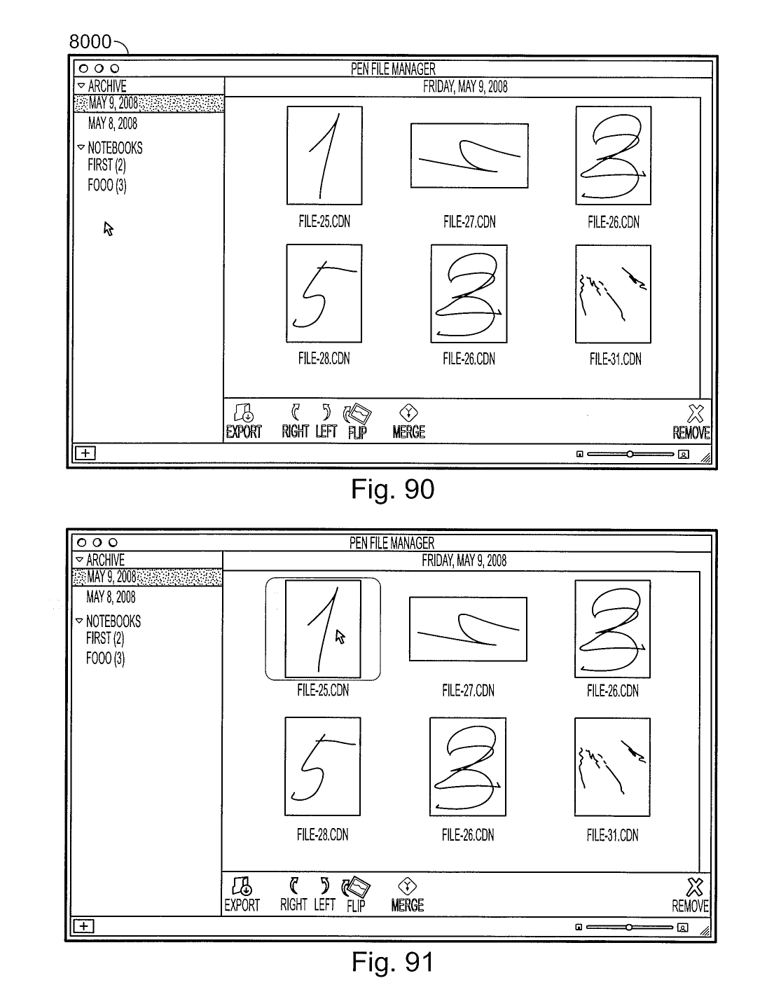

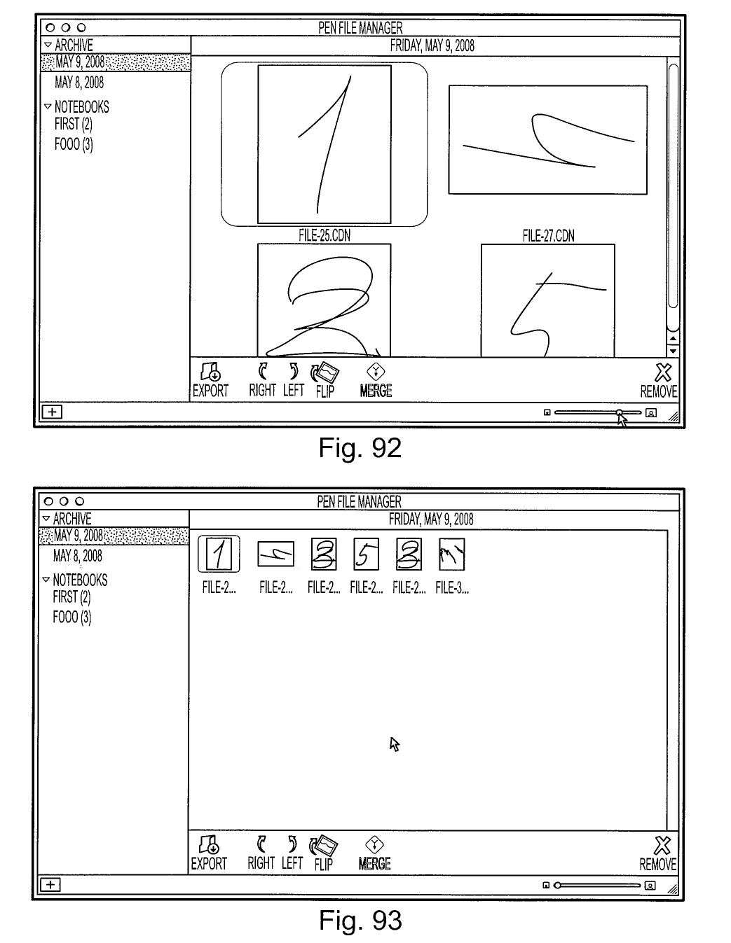

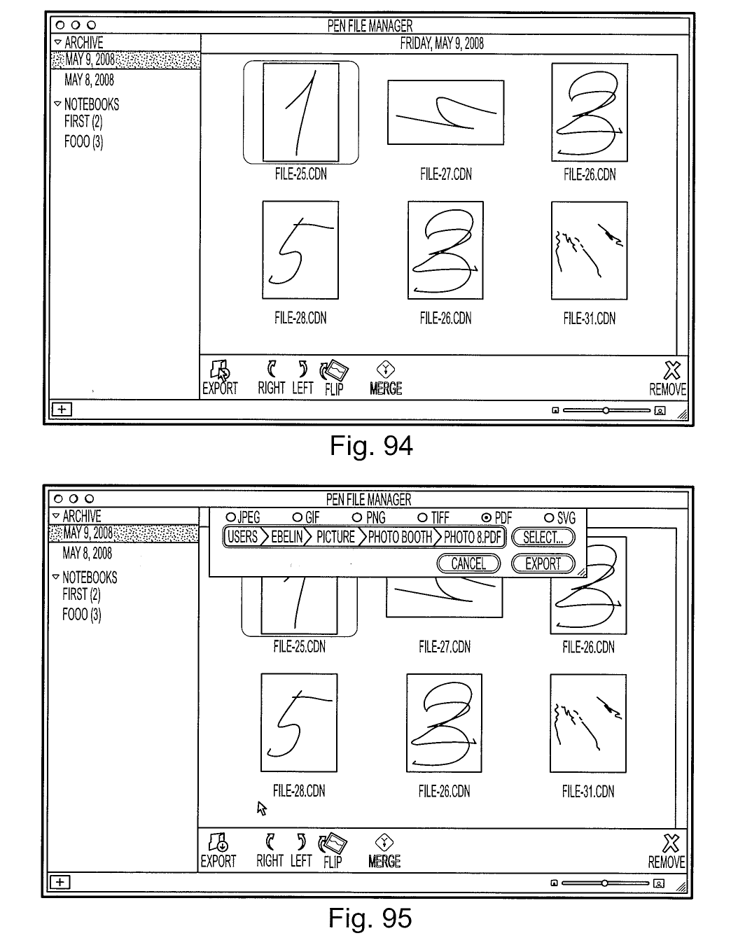

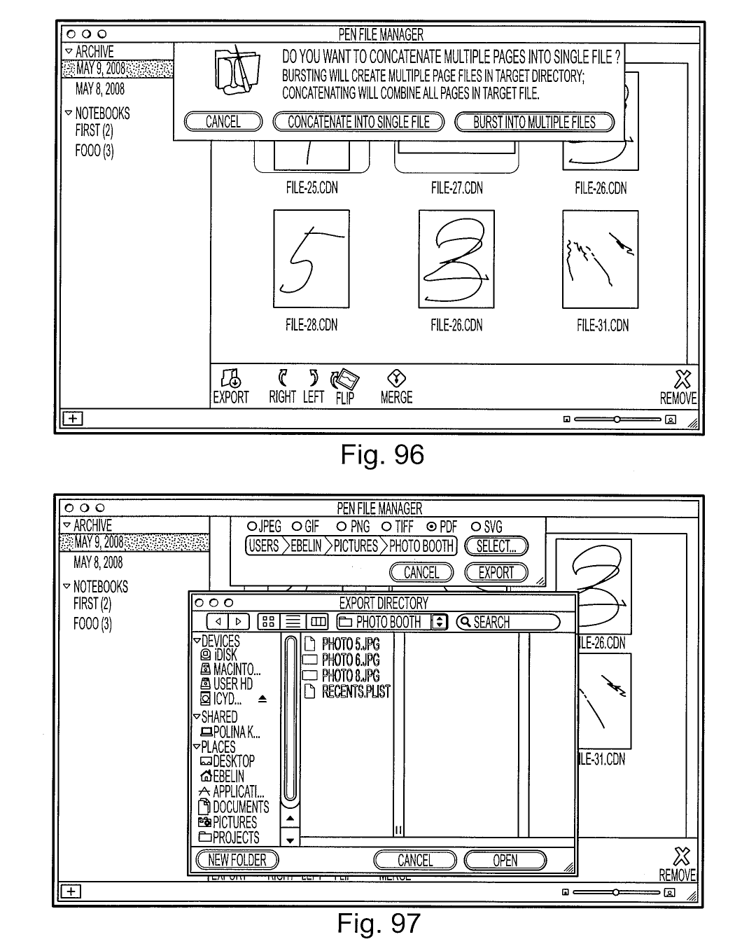

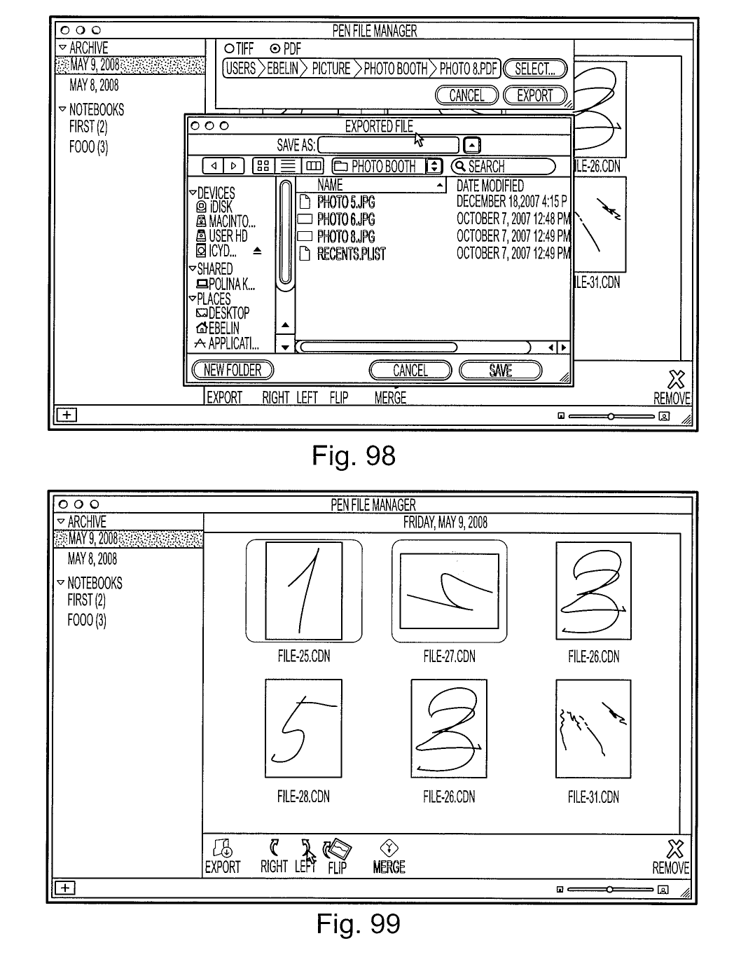

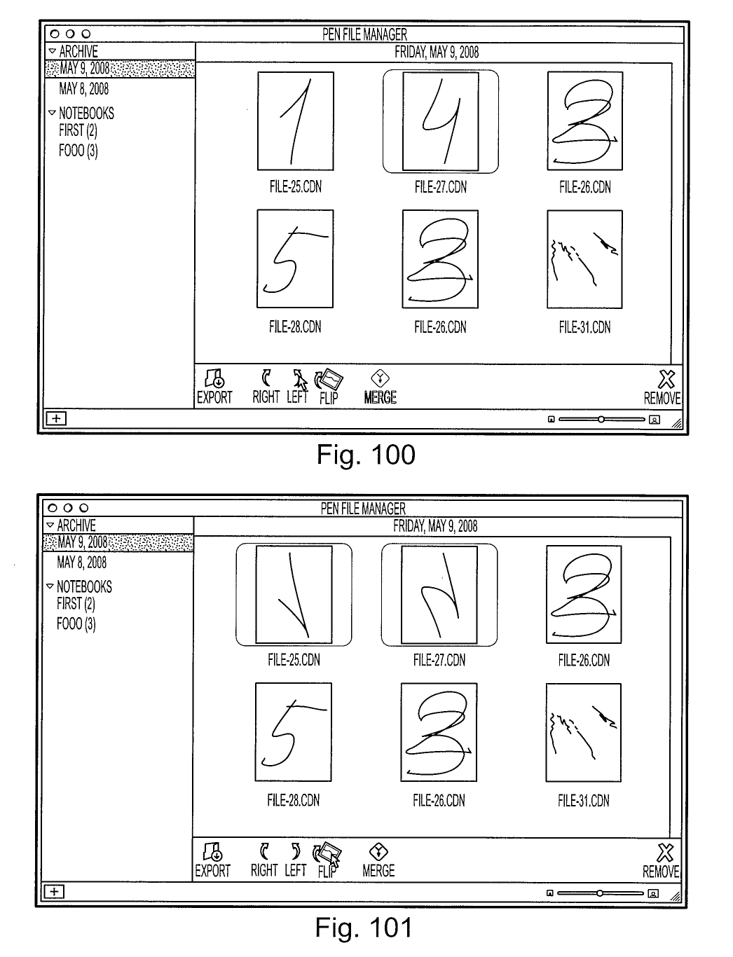

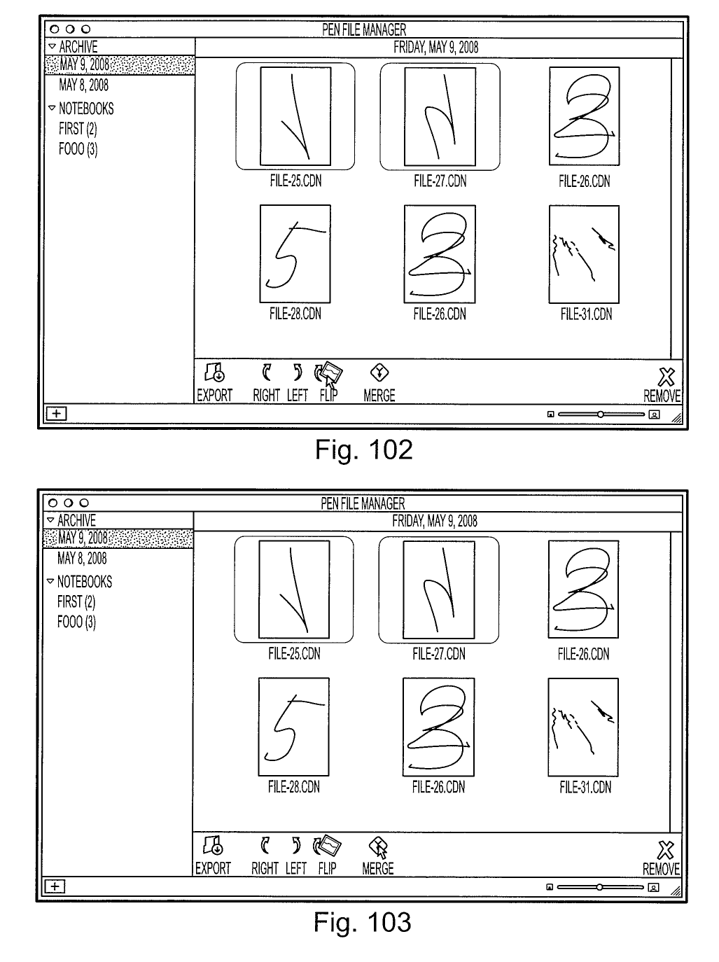

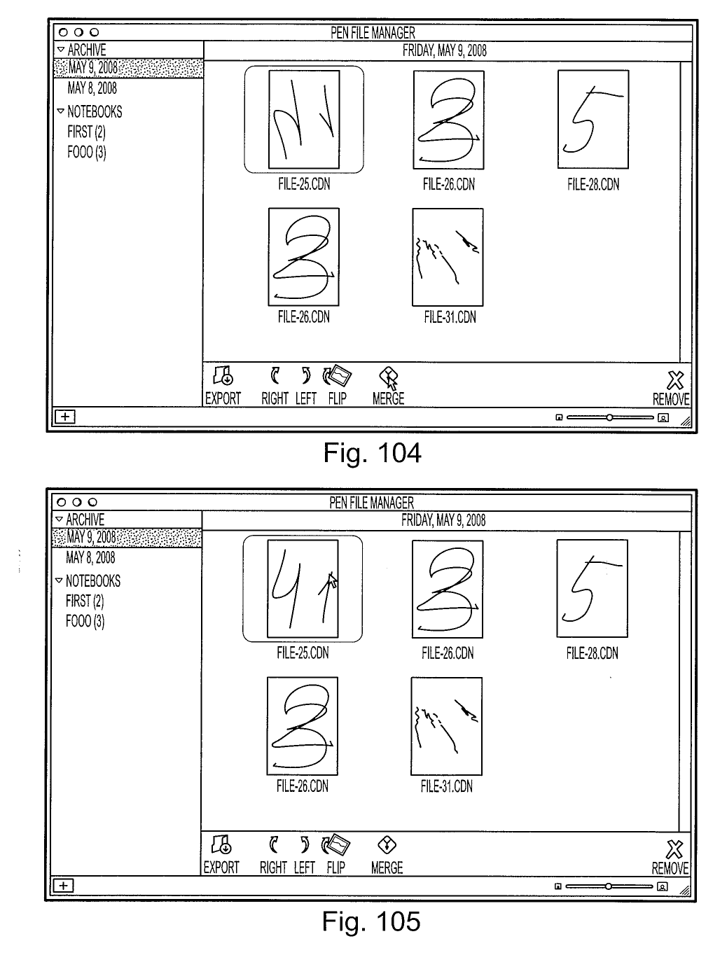

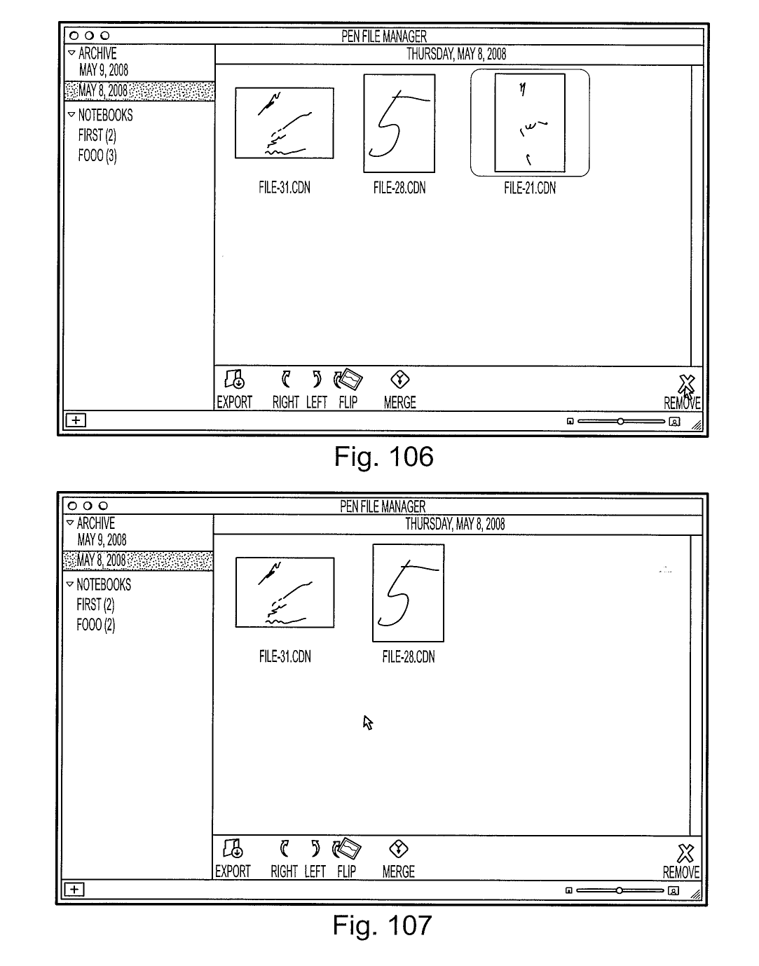

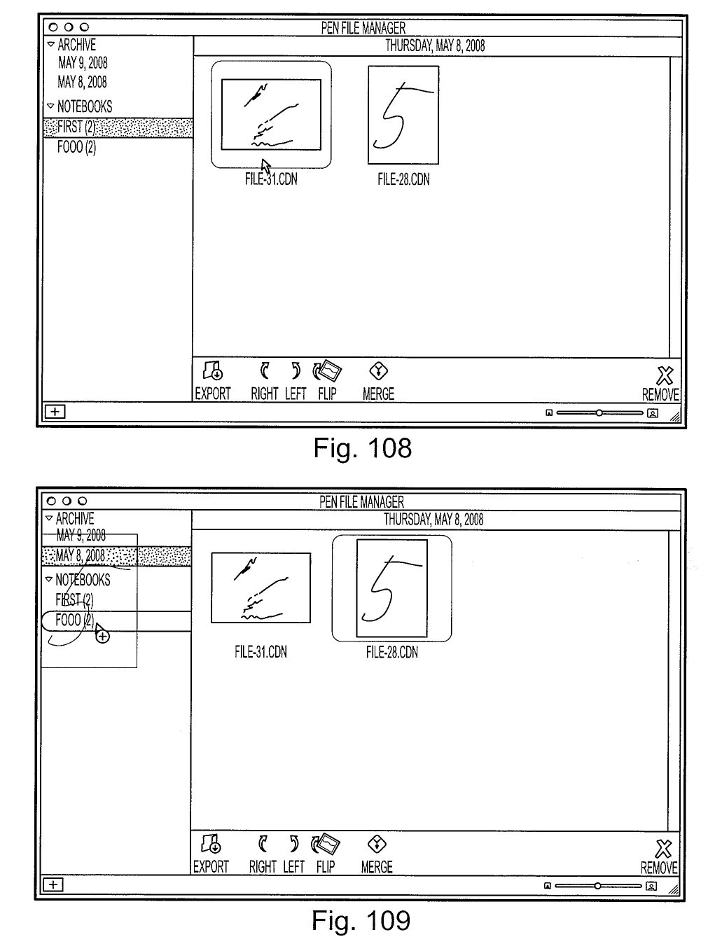

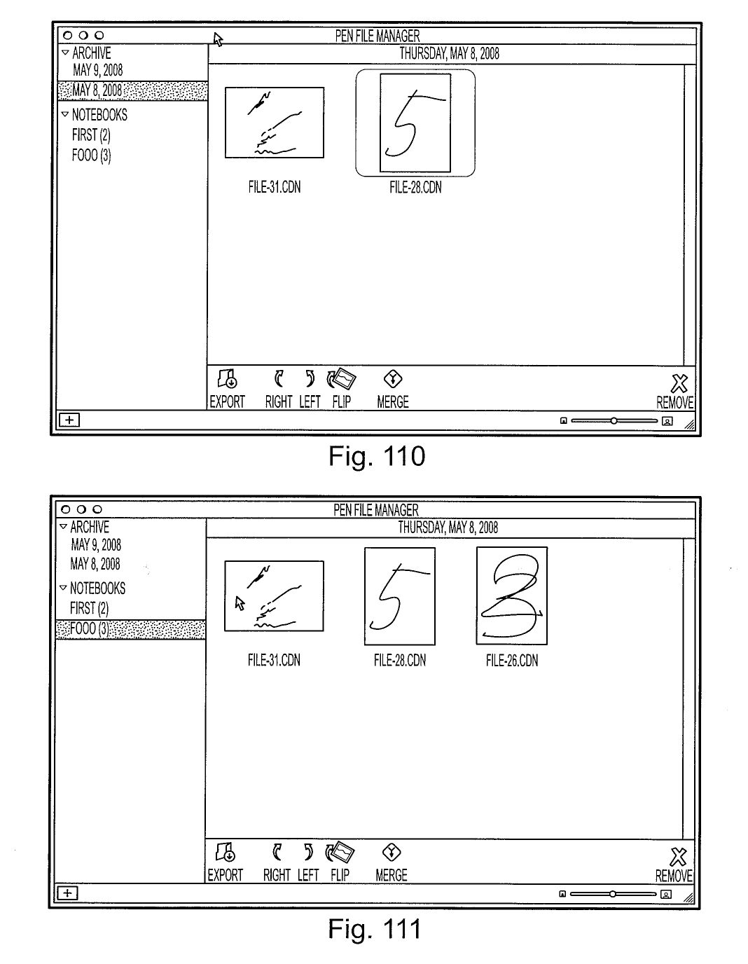

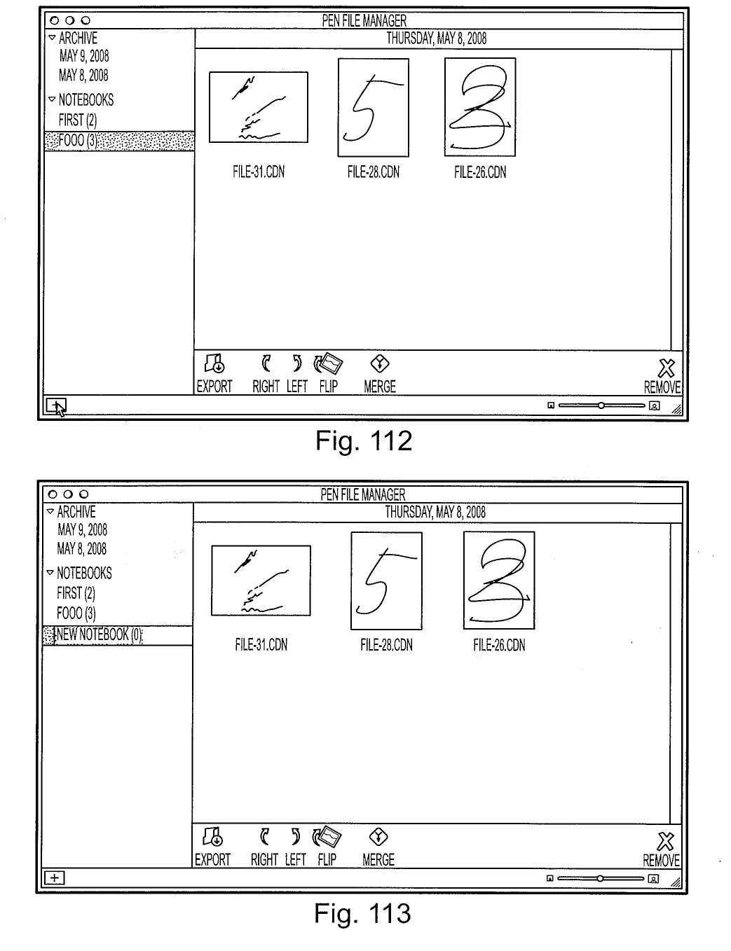

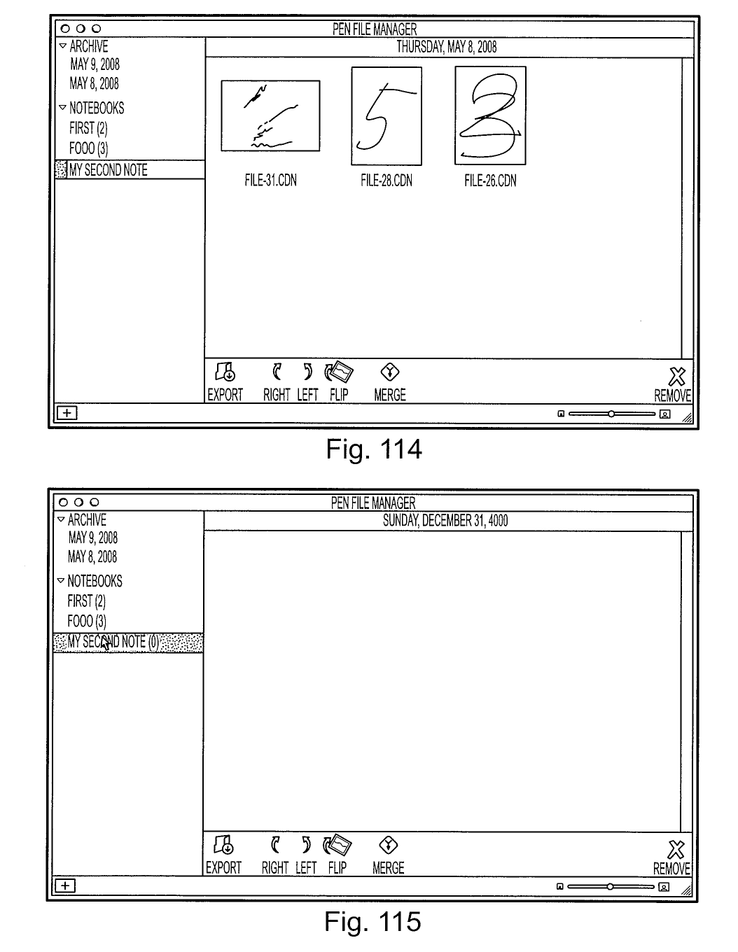

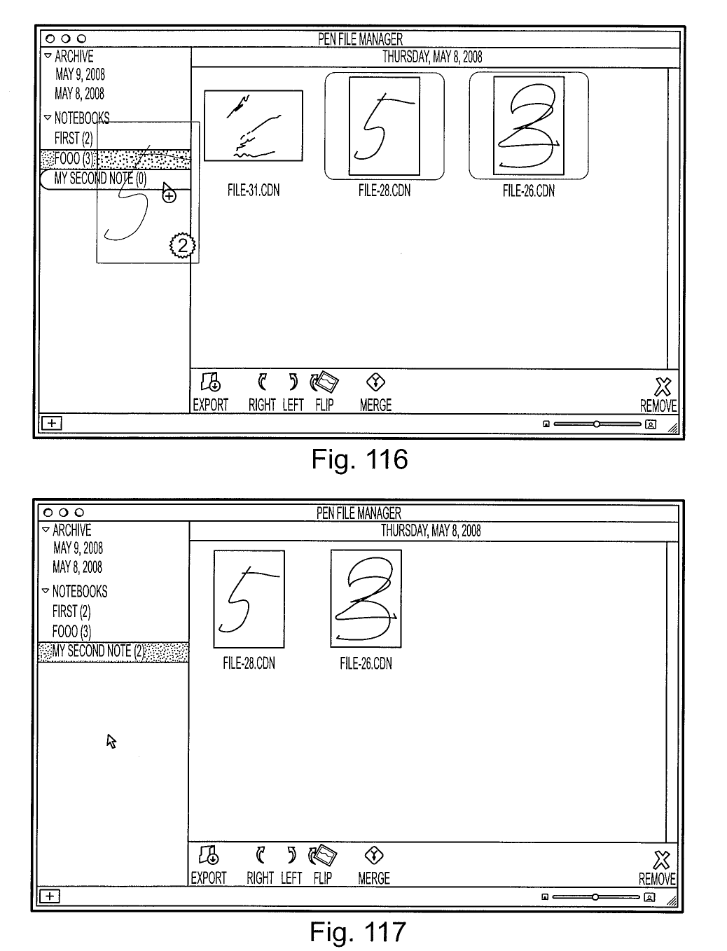

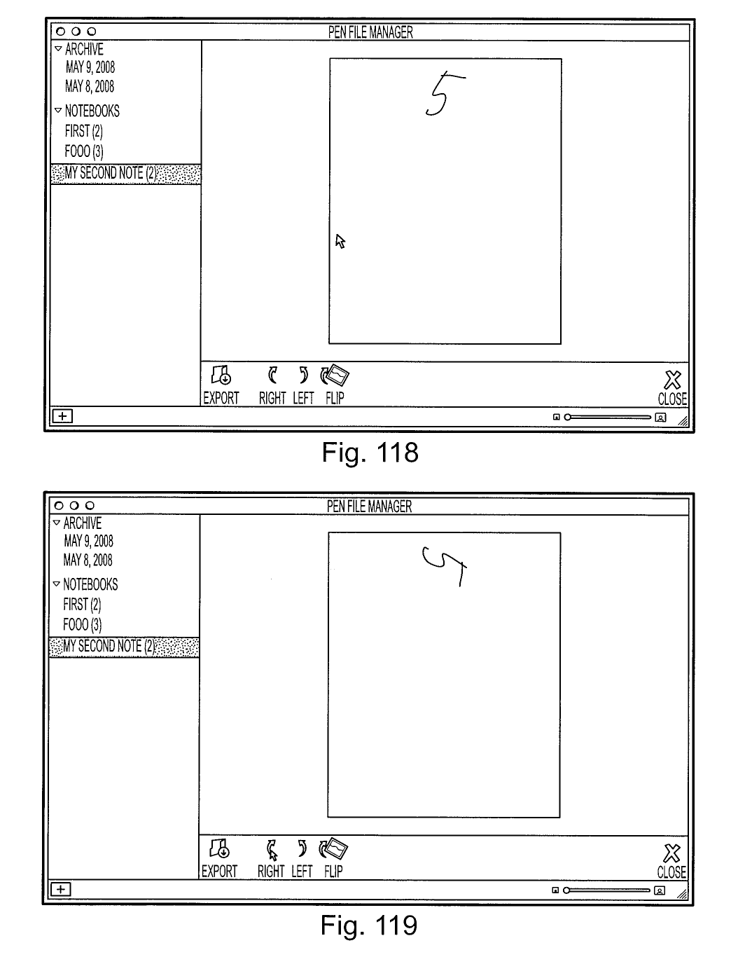

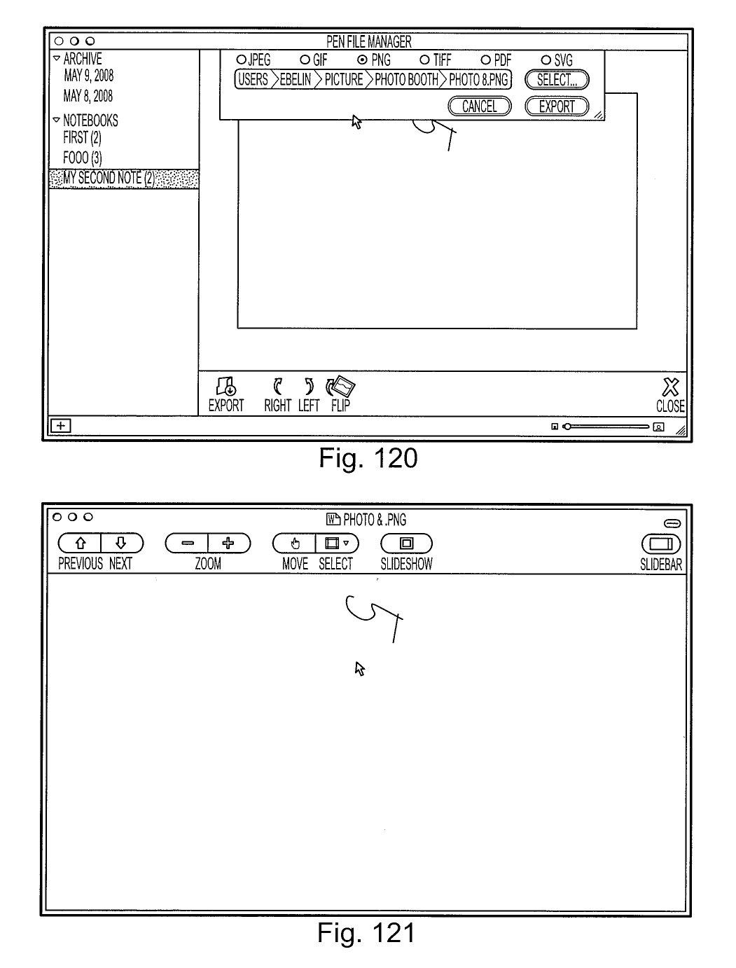

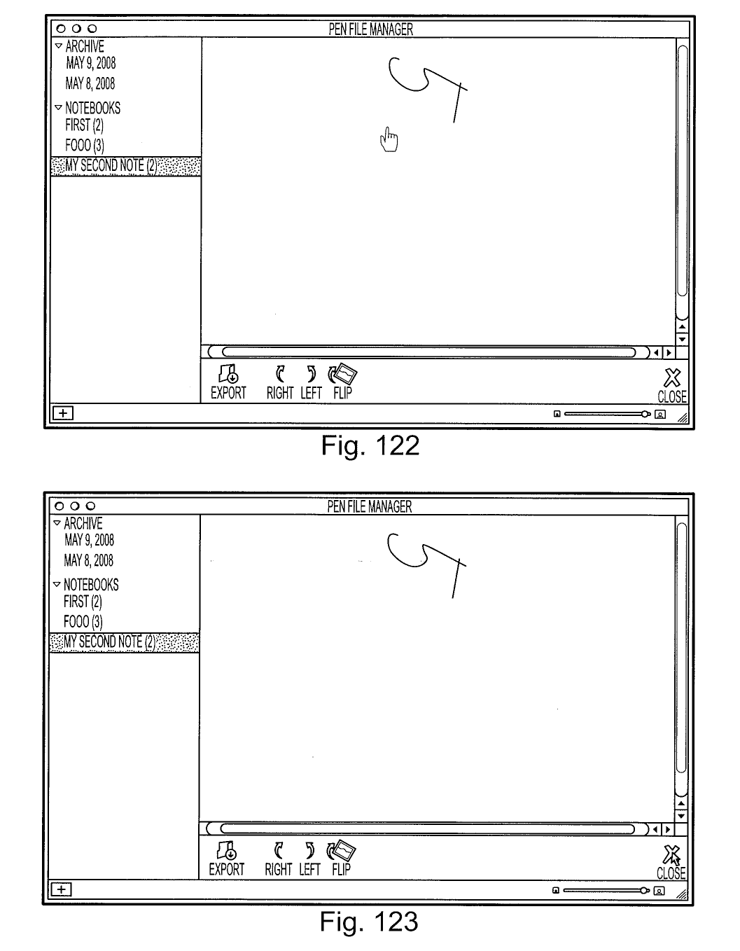

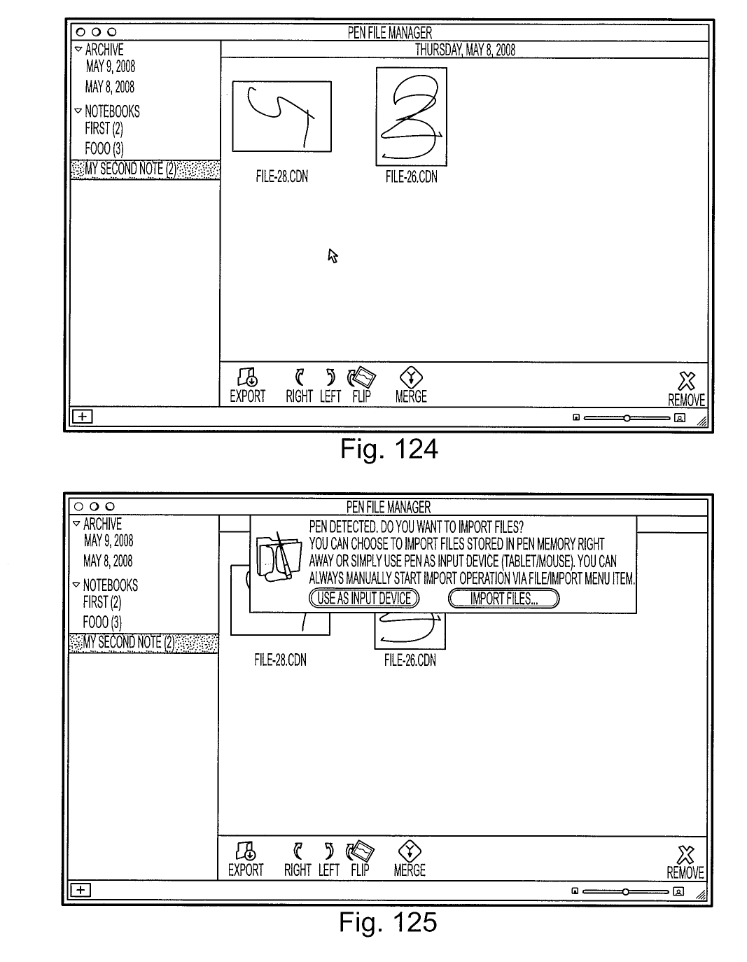

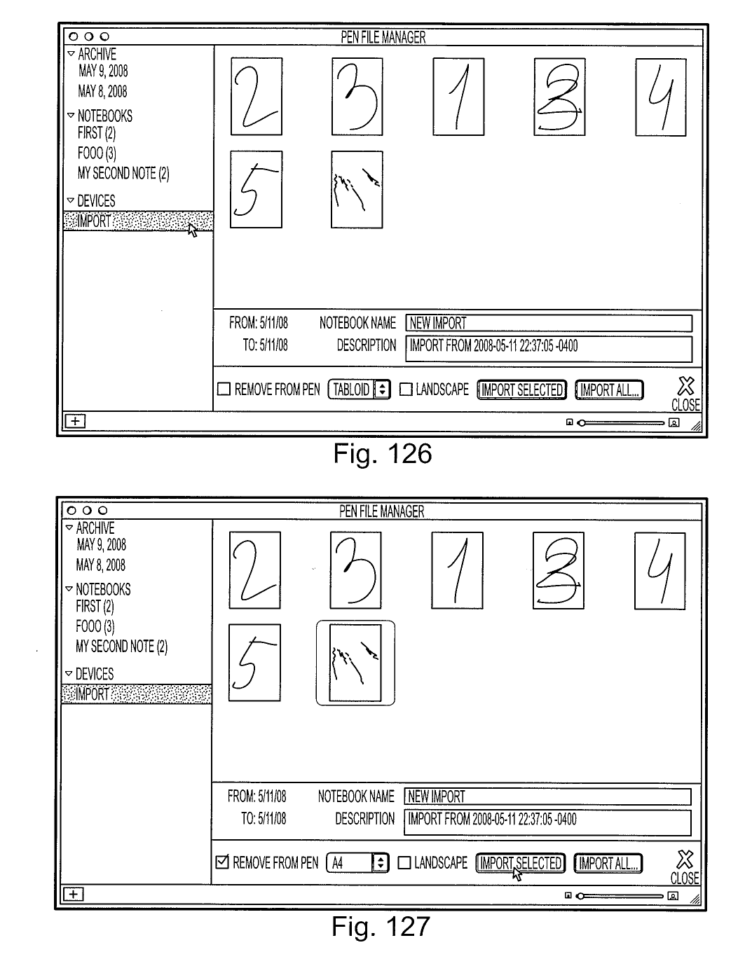

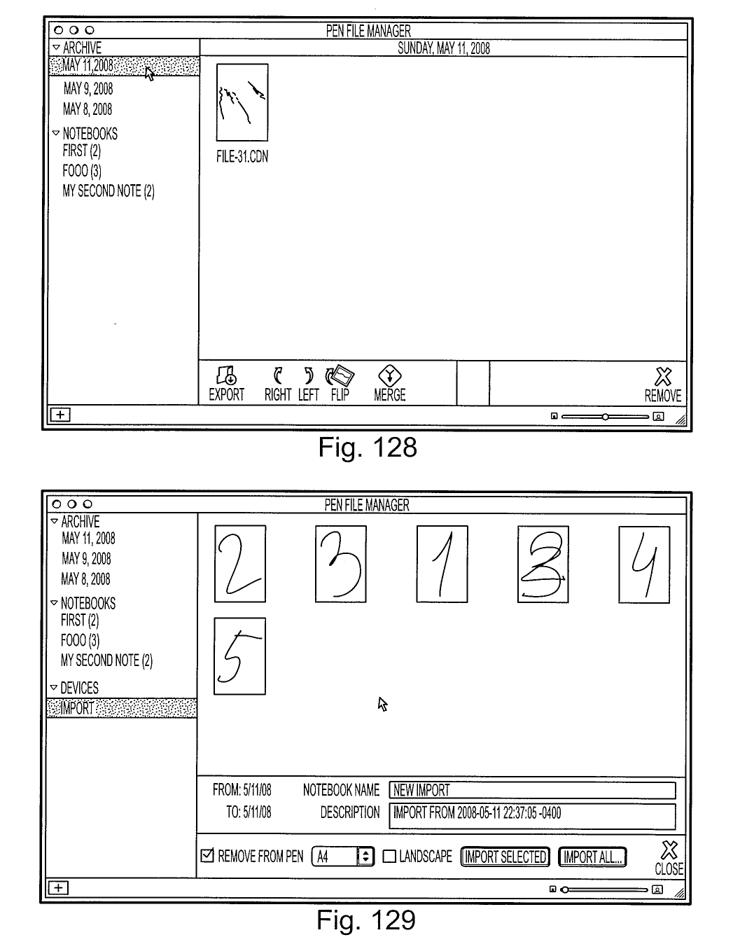

FIGS. 90-129 are views of an application programming interface.

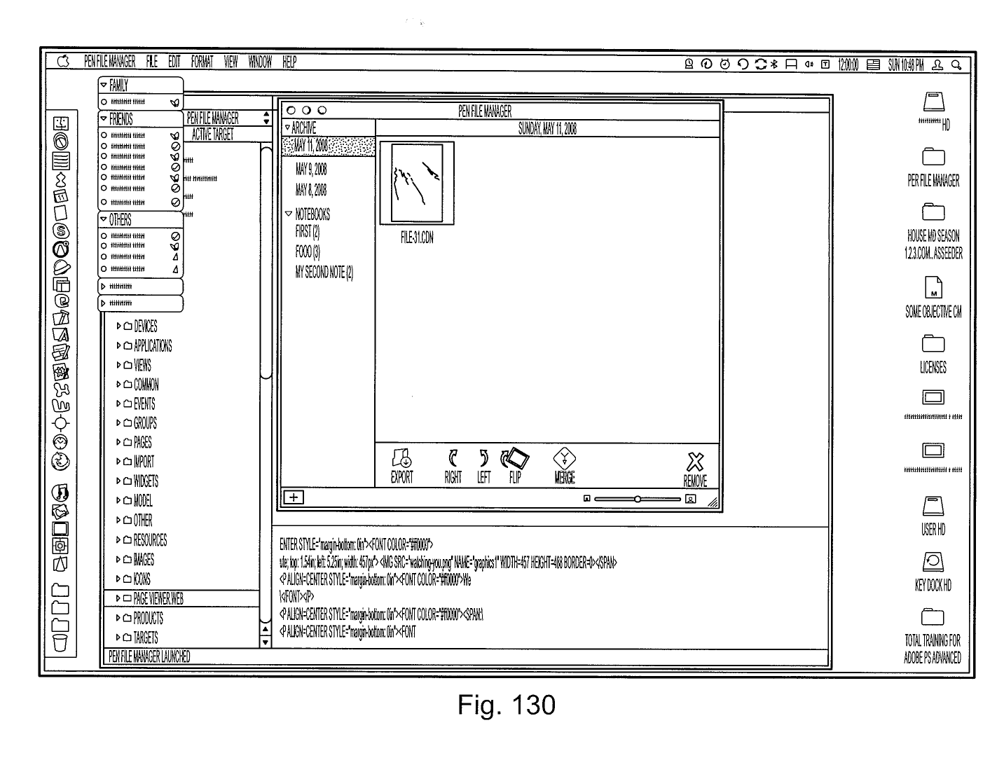

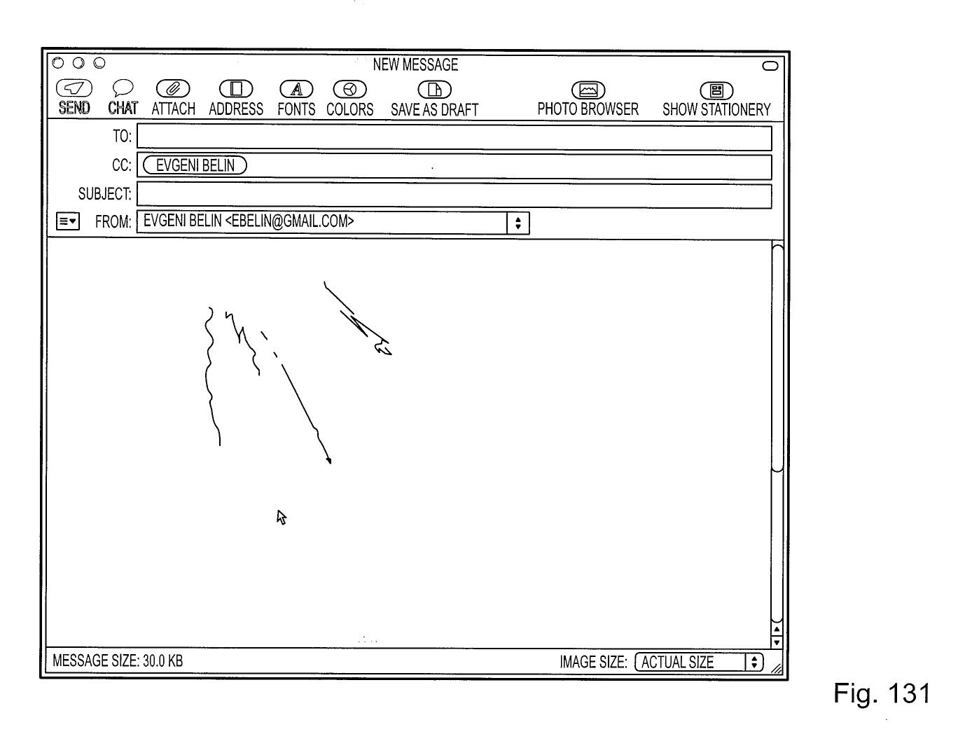

FIGS. 130-131 are screenshots of a computer.

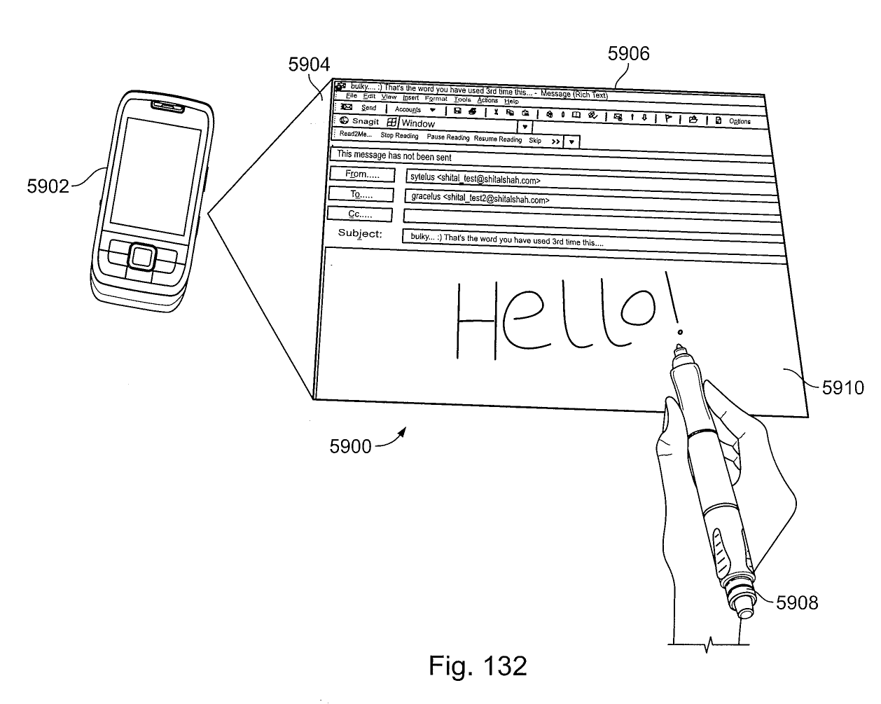

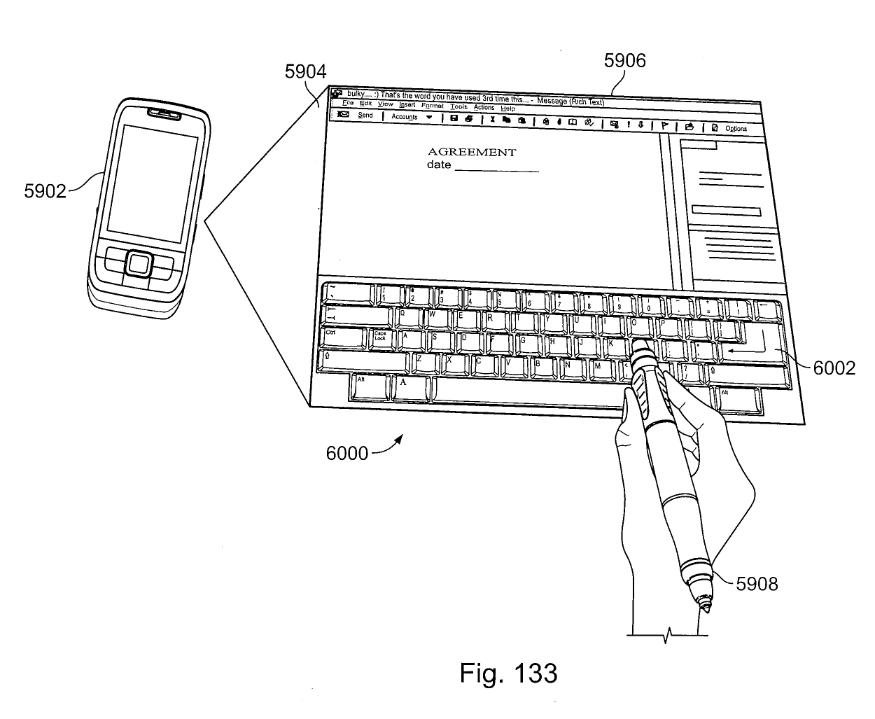

FIGS. 132-133 are sketches of a cell phone, a projected document, and a pen.

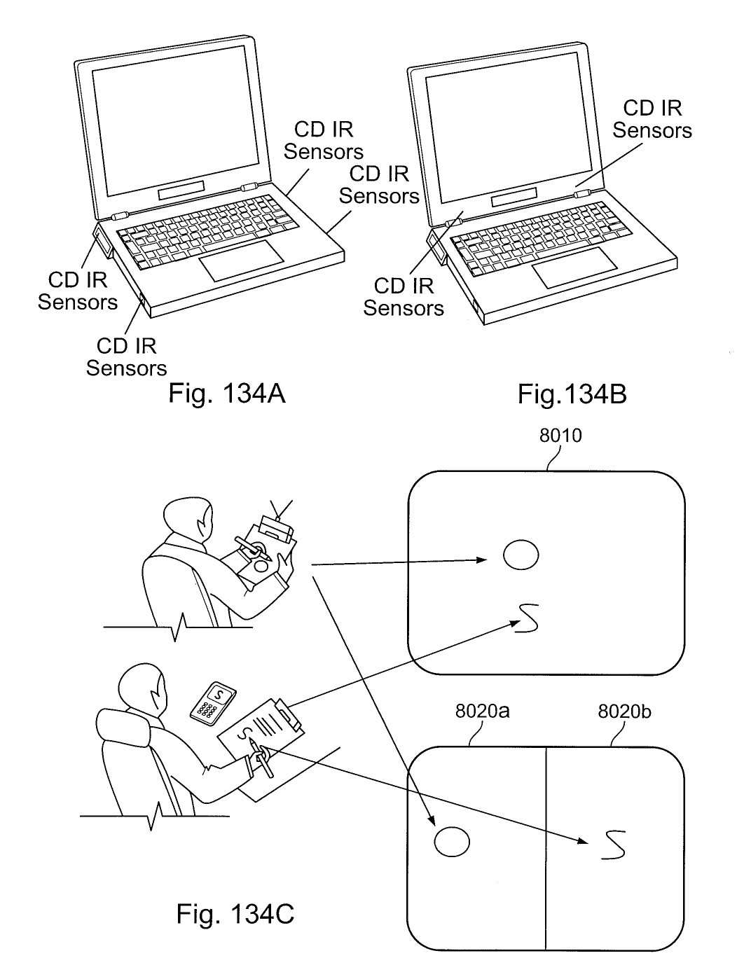

FIGS. 134A-B are views of a laptop; FIG. 134C is a view of two pen users.

A portable electronic device can include a pen and a holder for the pen that houses sensors to receive light emitted or reflected by the pen, for example, to determine the pen's location on a writing surface. In some examples, the device includes a clip that can be used to attach the device to a stack of paper. In some examples, the pen holder is attached to a clipboard, and the entire pen holder may serve as the clipboard's clip. Among other advantages, when the paper is held in the clip, the sensors have known locations relative to the paper.

In some examples, as shown in FIGS. 1A, 1B, 1C, 2, and 3, a pen holder 100 includes a body 102 that houses two light sensors 104 near opposite ends 103, 105 and (in some cases) a central sensor 106 and other electronics (not shown). The body may include or be attached to a lower plate 108 and an upper plate 110. Switches 114, 116 and lights 118a-118d may also be included. A pen 10 (which may be a wireless electronic pen with or without ink, or any similar writing instrument, for example, a stylus, pencil, or marker) is housed between the lower plate 108 and upper plate 110. Flanges 110a, 110b on the upper plate 110 extend partially around the pen to shelter it and help keep it in place. Other features may be used to allow the pen to be inserted and removed along its length, and retain it against falling out in that direction. A scallop 110c between the flanges 110a, 110b allows the user's finger to be inserted beneath the upper plate 110 to grip and remove the pen 10 in direction 107. The pen 10 is also held in place by ribs 120a and 120b that project down from the underside (not shown) of the upper plate, a center spring 122 that projects up from the upper surface of the lower plate 108, and end springs 124a and 124b (see cut-away view in FIGS. 4A, 4C, 5B) in wings 126a and 126b. Details of this structure are shown in FIG. 1B, with the ribs 120a and 120b shown through the flanges 110a and 110b using dashed lines and in which the pen 10 has been removed, and in FIG. 1C, in which part of the end wing 126b has been removed to show the spring 122 from the side. In some examples, springs 124a and 124b are configured so that the pen 10 can be inserted with its tip at either end. As shown in FIG. 1C, each of the ribs 120b includes a profiled segment 121 that matches an outer surface of the pen and holds the pen firmly in place when the pen is held in the pen holder 100. The lower plate 108 extends beyond the wings 126a and 126b to provide shelves 128a and 128b for attaching the pen holder 100 to a clipboard, as described below.

Thus the front of the body 102, the inner sides of the two wings 126a and 126b, the upper side of the lower plate and the lower side of the upper plate define a chamber in which the pen can be stored safely when not in use. The pen can be held in place by the three springs and two ribs to permit the pen to be easily removed and replaced as needed.

A connector 130 (FIG. 2) may be located on the back 101 of the pen holder 100, as shown in FIG. 2, or it may be located at either end on one of the wings 126a or 126b. The connector 130 may be a USB port or some other physical connection for transferring data and or power between the pen holder 100 and an external device (not shown) such as a computer, a telephone or a PDA. Four feet 132 located on the bottom of the pen holder 100 provide traction on whatever surface the pen holder 100 is placed, or they may hold paper in place if the pen holder 100 is used as part of the clip of a clipboard. In some examples the feet 132 are composed of a material having a greater traction than the materials from which the other parts are composed. Screws 134 may hold the lower plate, the upper plate, and the body of the pen holder 100 together. In some examples, holes 136 where the screws 134 were inserted may be used to connect the pen holder 100 to mounting features on a clipboard, as described below. One or more holes 136 may also be used specifically for this purpose, for example, if the plate 108 is integral to the body 102 or attached without fasteners.

In some examples, the feet 132 can be inserted into holes in a plate to create an assembly that can be retained inside a notebook without movement relative to the pages. The pages can be turned back and forth without disturbing the pen holder's ability to detect the use of the pen on each page. The feet 132 can be used together with the holes 136 for screws or other features in the bottom of the pen holder 100.

The positioning and function of the sensors 104 and 106 depends on the hardware and software implementation of the device. In some examples, two sensors 104 positioned respectively near the opposite ends 103, 105 of the pen holder 100 detect light emitted from the pen 10, when the pen is removed from the pen holder and is in use. Electronics in the pen holder use the detected light to triangulate the pen's location. Other sensing technologies, such as ultrasonic emitters and detectors, may also be used. The central sensor 106 may be used, for example, to detect emissions from the pen to synchronize the timing of the operation of the end sensors 104 with a carrier signal in the light from the pen. Other information can be transmitted between pen and pen holder by modulating a carrier signal, including light intensity of the emitter on the pen (which may be reduced, for example, to save battery life), the amount of battery charge left on the pen, the color of the ink cartridge being used, pressure applied to the pen, tilt of the pen, and use of an erase function. The pen holder 100 may also communicate messages to the pen, for example, through an infrared emitter coupled to one of the sensors 104 or 106. This may be used for various purposes, including synchronizing timing between the pen holder and the pen or signaling to the pen that there is a problem with the signals being received at the sensors 104. In some examples, the user may block one or both of the sensors due to the way he is holding the pen or turning pages, while switches in the pen (described below) indicate that the pen is in use. The pen holder may signal to the pen that it is not receiving light, and the pen and/or the electronics may alert the user by, for example, illuminating a visible light to indicate that there is a problem. For example, the pen may send an infrared (IR) signal and if it does not receive a reply signal from the pen holder, the pen can light up its red LED. In some examples, to save power and optimize efficiency of pen battery, the holder signals to the pen electronics to turn the power of emitted energy (i.e. IR for positioning of pen tip) up or down depending on detected signal strength.

In some examples, the sensor 106 is complemented by a light source and the sensors 104 detect reflections from the pen 10. Additional information about the use of the sensors in some implementations may be found in U.S. Pat. No. 6,577,299, Electronic Portable Pen Apparatus and Method, issued Jun. 10, 2003, and application Ser. No. 10/623,284, Tracking Motion of a Writing Instrument, filed Jul. 17, 2003, both incorporated here by reference.

In some examples, the springs 122, 124a, 124b may be used both to hold the pen 10 in place and to provide power to recharge a battery within the pen 10 as described below. With the spring 122 located in the center of the chamber, the pen can be inserted with its tip contacting either spring 124a or 124b, and a charging circuit can be completed in either orientation. In some examples, the electronics may detect which of springs 124a or 124b is in contact with a charging terminal on the pen 10 and provide an appropriate polarity voltage to that spring. In some examples, springs 124a and 124b may be energized with opposite polarity voltage to charge a pen 10 having contacts at both ends. Similarly, two contacts 122 may be provided to contact two electrodes along the length of the pen 10. In some examples, one or more of the springs 122, 124a, 124b may be connected to switches to detect when the pen 10 is held in the pen holder 100. An additional switch may also be used, for example, a switch 150 located on a circuit board 144b and linked to a plunger 152 that protrudes into the space to be occupied by the pen, as shown in FIG. 4B. This detection may be used, for example, to turn the pen holder 100 on when the pen 10 is removed and to turn it off when the pen 10 is replaced into the pen holder 100. The springs 124a, 124b, may also be shaped or include additional material to cover the tip of the pen and prevent it from leaking ink or smudging its surroundings when not in use.

In some examples, the shape of the springs 124a and 124b, as shown in FIG. 4C, includes two pieces 125a and 125b joined by a bent segment 125c. The piece 125a presented to the pen 10 has a hole 125d to receive the tip of the pen and to make contact with a contact near the tip as described below. The connection should be secure but soft to assure a good electrical contact of surfaces.

The switches 114, 116 and lights 118 may have various uses. In some examples, the switch 116 is used to select one of several operating modes of the pen holder 100, such as instructing the pen holder to save the detected handwriting to internal memory, to transmit it over USB or some other physical connection, or to transmit it over a Bluetooth® wireless link or some other wireless system, such as WiMax® or Zigbee® wireless technology. In some examples, the switch 114 is used to turn the pen holder 100 on or to indicate to the pen holder 100 that a user has turned to a new page. The switch 114 may be a rocking switch that allows the user to flip up or down between pages. Pages of writing may be stored in an on-board memory or transmitted to and loaded from a related device (not shown), such as a cell phone or PDA. A screen on the related device or an indicator on the pen itself, such as one of the lights 118 or a small screen (not shown) may show the current page. Using an external display on another device that a user would have anyway can allow the user to view a previously-created page she is now editing without requiring that the pen holder itself have a display, saving both power and package space. The page to be edited may be selected by the other device, based on either user input to that device or the user's current handwriting, as interpreted by that device after being communicated to it by the pen holder 100. In some examples, an additional sensor (not shown) may detect that a page has been flipped, and the pen holder 100 may automatically change which page it is storing input to, or it may use one or more of the lights 118 to indicate to the user that it thinks the page should be changed using the switch 114. To preserve battery life in the pen holder and related devices, the wireless connection may be put in a sleep mode after the data or commands have been sent and while new pen input is being recorded.

The new page switch can also indicate to the onboard processor to process data from the previous page and transform that into various standard formats for immediate or later communication to wirelessly connected devices.

One or more of the lights 118 may illuminate or flash to acknowledge that such a command has been received, that the pen holder is ready to receive pen input, that the memory is full, that a page has been turned, or that the pen holder is transmitting, among other functions. In some examples, the light 118a is amber and blinks once to indicate that the pen holder is ready for the next page and blinks continuously to indicate that the internal memory is full. The light 118b is red and indicates that power is on or that the pen holder is being charged. The light 118c is green and indicates that the pen is in use and writing is being received. The light 118d is blue and indicates that a data connection is in progress. Other colors and other uses for the lights are possible. The lights 118a-118d and the switches 114, 116 may be integrated, and more or fewer lights or switches may be used. Any of the functions of the switches 114, 116 and lights 118 may be performed on a related device connected to the pen holder 100 through a physical or wireless connection. For example, hard or soft buttons on a cell phone may be used to select a page and input mode, and the cell phone's screen may indicate the writing being performed by the pen. Calibration data may be stored in the pen holder 100 or in a device that is to receive information from the pen holder about the movement of the pen. Such data may be used, for example, to correct for manufacturing variations in the sensors or other components.

The pen holder 100 may contain electronics and other structures, as shown in FIGS. 4A-4E. These may include assemblies 138 to hold the sensors 104 or their components in place or to block or control light entering the sensors. The sensors 104, 106 and other circuit components 142 may be connected to circuit boards 144. The circuit boards 144 may be printed circuit boards, flex boards, or other technology. In some examples, the supports may control light in such a way that the sensors 104, 106 remain operational with the body 102 of the pen holder 100 opened to allow testing or calibrating.

FIGS. 4D and 4E show the support assemblies 138. In some examples, the assemblies 138 form a chamber 137 (FIG. 4E) to control the orientation of a lens 154 relative to the sensor 104, to enable easy assembly, to block ambient and other interfering light, including light from the pen itself other then the light being focused by the lens 154, and to allow testing and calibration in a production environment.

The lens 154 is inserted into an opening 158, supported by a front lens support 160. A top cover 162 protects the sensor 104 within the assembly 138. As shown in FIG. 4E, the sensor 104 is positioned in a cradle 164 within the assembly 138 in such a way that the sensor 104 is captured between two plastic features 164a and 164b. This positions the sensor 104 relative to the lens 154 horizontally; vertically it is fixed by the bottom 164c of the cradle 164. The lens 154 is supported vertically within its opening 158. In some examples, flanges 154a and 154b on the side of the lens 154 block ambient and pen light, so that light is only admitted into the chamber 137 through the operational section 154c of the lens 154. In examples where infrared sensors are used, the lens 154 may be composed of IR-filtering material that blocks most of the ambient light. The cover 162 keeps the lens 154 and sensor 104 in place. Glue may be used to keep the lens 154, the cover 162, and other components in place. With the cover and lens blocking stray light from reaching the sensor 104, testing and calibration can be performed without risk that lens and sensor would move or that outside light will compromise readings. This can allow, for example, electronic and other troubleshooting to be performed without recalibrating the pen holder electronics.

In some examples, the sensors 104 are connected to daughter boards 144a that are each positioned at an angle relative to the main circuit board 144b. In some examples, these circuit boards 144a, 144b may be cut from a single circuit board 144 after fabrication, as shown in FIG. 5A. Jumpers or cables 146 may provide electrical communication between the sensors 104 on the daughter boards 144a and the rest of the electronics 106, 142 on the main circuit board 144b, shown in detail in FIG. 5B. Other shapes and configurations are possible, depending on the packaging requirements of the pen holder and the operation of the sensors.

In some examples, as shown in FIGS. 6A-C, 7A, and 7B, a clipboard 200 may be provided in which the pen holder 100 is attached to a board 202. In some examples, the pen may be tethered to the board 202, and the tether may be used to provide power or data to the pen (not shown). The pen holder 100 may also form the clip of the clipboard. Such a clipboard may be configured to hold a stack of paper sheets 204 either in a portrait (FIGS. 6A, 6C) or a landscape (FIG. 6B) orientation. The pen holder can be positioned at either the top 206 or bottom 208 of a portrait orientation and either the left side 210 or right side 212 of a landscape orientation, depending on the preference of the user. If the paper is bound in a pad 220 (FIG. 6B), the clipboard 200 may be oriented so that the pen holder 100 is on an edge 222 other than the spine 224 of the pad 220, permitting the pages to be flipped without interfering with the sensors 104. In some examples, as discussed below, the sensors can be repositioned relative to each other to best accommodate the shape of the paper.

FIG. 6C shows an example of a clipboard being used for pre-printed forms. Guides 232 surround a form 234 and hold it in place, assuring that the markings on the form are in known locations relative to the pen holder, so that the position of the pen 10 detected by the pen holder 100 can be correlated to fields in the form. The layout of the form is also known in advance and may be stored in the memory of the pen holder 100. In some examples, the pen holder 100 converts the pen's positions to input on the form and transmits only the input to another device, e.g., a PC. In some examples, the pen holder 100 transmits the pen's motion in an unprocessed state and the PC itself relates the motion to the contents of the form.

In some examples, as shown in FIG. 6D, the board 202 may be inserted into the pad 220, so that the pen holder 100 can be easily removed (arrow 236) and the board 202 will remain inserted in to the pad 220. This way, the orientation of the sensors 104 to the pad will be the same when the pen holder 100 is returned to the clipboard 200, so the user can continue writing on the same document and the pen holder will know where markings have already been made on the paper from the last time it was used, thus the user may edit a single document in more than one session. This may also be accomplished by consistently placing the board 202 in the pad 220 in a specific location, for example, with the board against the binding and the pen holder 100 against the edge of the pad 220. The user could then put the board 202 between different pages as he moved through the pad. In some examples, the board 202 may be made smaller, to be used more like a bookmark than a clipboard, still holding the pen holder 100 in a consistent position relative to the pad 220. In some examples, the user may write directly on the board, with or without actually leaving marks, depending on the configuration of the pen.

In some examples, the clipboard 202 may include electronic circuitry 203 to complement that in the pen holder 100, such as an antenna for wireless communication or sensors to detect when pages have been turned, as mentioned above, or the number of pages between the pen holder 100 and the board 202. A user may be prompted to change pages when the number of pages changes. The pen holder 100 may communicate to another device to display a new page when the page is changed.

FIG. 7A shows details of how the pen holder 100 may be secured to the clipboard 200. As noted above, the holes 136 on the bottom of the pen holder 100 may receive a mounting feature 240 attached to the board 202. Alternatively, the feet 132 may be inserted into holes in the board 202 (not shown). In some examples, a spring 242 may be attached to the board 202 via a mounting block 244. In some examples, the spring 242 may be an extension of the board 202 or directly fastened to the board, e.g., by a rivet or screw. This spring 242 may press down on the pen holder 100 via the shelves 128a and 128b, also as mentioned above. Such an arrangement may allow the pen holder 100 to pivot upward to accommodate the paper 204. In some examples, the front foot 132a may help hold the paper in place. In some examples, the rear foot 132b may provide a point for the pen holder 100 to rock on, or may limit its range of motion. In some examples, the spring 242 or its mounting block 244 may hold the paper in place independently of the pen holder 100, as shown in FIG. 7B.

In some examples, the pen is constructed as shown in FIGS. 8 and 9. FIG. 8 shows the exterior of the pen and FIG. 9 shows internal components with the pen body 20 absent. The writing end 11 of the pen 10 has a writing tip 12, a front face 13, light source 14, a forward body 16, and a grip 18. The middle 15 of the pen has a main body 20 and a charging contact 22 and houses electronics 28. In some examples, the charging contact is a band around the entire circumference of the body 20 so that it will make contact with the center spring 122 of the pen holder 100 described above regardless of the pen's rotation about its long axis 21. A second contact may be located at the front face 13 at the writing end 11 of the pen. As noted above, there could be two or more charging contacts 22 to contact two or more springs 122 or other electrical contacts. One or more of the charging contacts may be integrated with a retaining feature to hold the pen within the pen holder. An advantage of charging through the front face 13 and a single center contact 22 is that is allows a conventional pen appearance, with only one metal ring contact on the body of the pen where most pens have a band to hide a joint between two parts of the body. Thus the center contact 22 serves the conventional function of joining two parts of the pen, and the front face 13 may be made indistinguishable from other pen's tips. Placing the ring contact into the center of the pen also has the advantage of allowing the pen to be inserted into the pen holder 100 in either direction, convenient for serving both right- and left-handed users.

The tail end 17 of the pen 10 has a rear body 24 that houses a battery 26. The writing tip 12 could be part of a pen cartridge 30, such as a refillable or disposable ink cartridge, or could be a lead tip, a marker, or a piece of chalk. The pen 10 may include a pen guide 50 to provide an electrical pathway from the electronics 28 to the front face 13. The light source 14 may be a lamp 34, such as one or more LEDs, or a reflector. In some examples, the light source 14 is an end of a light guide 32 as shown in FIGS. 10A and 10B that guides light 33 from lamps 34 deeper within the pen body. Additional information about examples of pens may be found in patent application Ser. No. 10/623,284 cited above.

The light guide 32 may include a straight section 38 that receives light 33 (short-dashed line) from the lamps 34, and a tapered section 40, that exits the pen body and emits light. The lamps 34 may be molded into the light guide 32 or may be separate from it. The tapered section 40 may include a reflector, such as reflective surface 44, configured so that light is emitted at an angle selected to increase the amount of light that will reach the sensors 104. The reflector can have various forms, including a distinct component, a polished face of the light guide 32, or a coating on a face of the light guide. In some examples, the surface 44 defines a conical frustum having a smaller diameter matching a channel 48 through the center of the light guide along the axis 21. In some examples, the conical frustum has an angle of 45 degrees from the axis 21 so that light 33 is reflected approximately perpendicular to the axis 21. The reflective surface 44 may begin a distance 47 from the position 49 at which the light guide 32 exits the pen body (see FIG. 8) to assure that light 33 has room to diverge after leaving the light guide 32. In some examples, this distance 47 is about 1.0 mm. A ridge 46 may be included to attach the light guide 32 to the forward body 16. The channel 48 guides the pen cartridge 30 and may include space for a pen guide 50 described below. The outside diameter of the straight section 38 may be close to the inside diameter of the pen body 20 to assure that the pen cartridge 30 can be inserted through the center of the pen body 20 and light guide 32 without hitting the lamps 34 or other electronic components.

The tapered section shown in FIGS. 10A and 10B can reduce the efficiency with which light is conducted from the lamps 34 to the reflector 44. This effect can be reduced by making the straight section 38 close in diameter to the outside diameter of the reflector 44, i.e., making the entire light guide cylindrical or nearly so, as shown in FIG. 10C. In the example of FIG. 10C, the light guide 32 has a single cylindrical section 39. In the example of FIG. 10D, the light guide 32 has a single tapered section 41. To accommodate a smaller diameter at the lamp end of the section 39, smaller LEDs may be used for lamps 34, or the lamps 34 may be connected to the light guide 32 by fiber optic guides 35. The LEDs may be mounted directly on the surface of a circuit board. In some examples, the diameter of the light guide is around 4 mm. In some examples, the light guide has a diameter of around 7 mm at the end coupled to the lights 34 and around 4-5 mm at the end where the light 33 exits.

As the light 33 moves from the fiber 35 to the reflector 44, the light guide mixes it to encourage a uniform distribution of light at the tip. To help maintain high efficiency, the surfaces of the light guide 32 should be protected from scratches and direct contact with foreign materials, especially those with a high coefficient of refraction, which may absorb light and prevent the light guide 32 from channeling it to the reflector 44. The pen body 20 can provide this protection for the outer surface, and the pen guide 50 may be used to protect the inner surface of the channel 48. In some example, surfaces of the light guide may be coated with an aluminum paint or other reflective material, which may also serve to enhance reflection and provide electrical conductivity in addition to protecting the surfaces.

In some examples, the lamps 34 may include LEDs or other light sources that emit light in more than one frequency. Infrared may be used for communicating with the sensors 104 and 106 in the pen holder 100, while visible frequencies are used to communicate with the user, for example, using different colors to indicate the pen's status or battery charge.

FIG. 11A shows a switch mechanism 52 that detects when the pen 10 is in use. The cartridge 30 extends through a guide 50 and ends in an end cap 54. At the end of the guide 50 it expands to form both the reflector 44 for the light guide and the front face 13 of the pen (the length and width are not to scale in FIG. 11A and other figures). In some examples, the guide 50 is integral to the light guide 32 or some other body structure of the pen 10. A coil spring 56 provides pressure between the end cap 54 and the guide 50. This keeps the end cap 54 in contact with a flat spring 58. The flat spring 58, in an equilibrium position, maintains a small gap 64 between itself and a contact pad 60 on a circuit board 66. The flat spring 58 is also in contact with a second contact 62. When the pen is in use, the pressure of writing presses back on the pen cartridge 30, deflecting the flat spring 58 and causing it to contact the pad 60. This completes a circuit between the contact pad 60 and the second contact 62, indicating to the pen's circuitry (not shown) that the pen is in use. To avoid interfering with the writing of the pen, the gap 64 between the flat spring 58 and contact pad 60 may be on the order of 0.2 mm. The springs 56 and 58 together may be configured to allow this small movement with a force sufficiently small that a user will not notice the movement or the force required to achieve it. Other methods of sensing that pressure is being applied to the pen cartridge 30 may also be used. In some examples, the end cap 54, coil spring 56, and guide 50 may all be conductive to provide a current path, including the flat spring 58, from the pad 62 to the front face 13 of the pen to route power from one of the springs 124a or 124b to charge the battery 26 in combination with the charging contact 22 at the center of the pen.

In some examples, the pen 10 is structured as shown in FIG. 11B. The end cap 54 is sized to occupy the entire diameter of the pen body 20. A lip 68 retains the end cap within the pen body 20. The pen cartridge 30 directly plugs into the end cap 54, avoiding the need to attach an end cap to the cartridge before installing it in the pen. The spring 58 maintains tension against the end cap, so that the spring 58 can work in the same manner as in FIG. 11A. In this example, no circuit is made through the front face 13, which may be made of plastic. The pen may be charged using two contacts 22 or a second contact may be located at the tail end of the pen (not shown). The pen body 20 may be connected directly to the light guide 32 using threads 72, with surfaces of the light guide coated with a suitable material, such as aluminum paint or other protective materials. Aluminum paint may serve to enhance internal reflection by the faces of the light guide and to lessen the effects of scratches on the reflection. This construction may more readily work with off-the-shelf pen cartridges.

In some examples, as shown in FIGS. 12-16, the pen holder 100 is configured to be used as a cap for the pen 10, thus the pen is inserted into a channel 1002 in the body of the pen holder 100. In some examples, the sensors 104 and the circuit boards that support them are mounted so that they can pivot between positions, as described below.

As shown in FIG. 12, when the pen 10 is removed, the sensors 104 pivot into the body 102 so that they are positioned at an angle that improves the accuracy of their measurements. As shown in FIG. 13, when the pen is inserted into the channel 1002, the sensors 104 are pushed out into a flat position. In some examples, the sensors move in the opposite direction, such that when the pen 10 is removed, the sensors 104 extend out from the body 102, and when the pen is inserted into the channel 1002, the sensors 104 are pulled back into their unextended position.

As shown in FIG. 14, one of the sensors 104a and surrounding packaging may also extend along the length of the pen holder 100 in order to give the two sensors 104a and 104b greater separation which in turn allow for higher accuracy in the overall reading of the pen's position. In some examples, the entire pen holder body may extend. This may allow the sensors to be placed in different locations or relative angular orientations according to the shape or orientation of the paper being written on.

In some examples, the moving sensors 104 of FIGS. 12 and 13 may be implemented as shown in FIGS. 15 and 16. When the pen is absent (FIG. 15), springs 1010 and 1012 push the outer ends 1013, 1015 of the sensors 104 out from or pull the inner ends 1014, 1016 in to the body 102. When the pen is present (FIG. 16), it pushes a linkage 1018 that pulls or pushes the ends 1014, 1016 back to a flat position. The movable sensors may also be used to position charging contacts 1020 and 1022 in contact with charging contacts 22a and 22b on the pen 10. In some examples, only one charging contact 22 is present along the length of the pen, with the second charging contact of the pen 10 located at the front face 13 of the pen 10 as above and a second charging contact 1024 of the pen holder 100 located deep inside the channel 1002. This contact 1024 could be constructed in the same manner as the springs 124a and 124b, shown in FIG. 4C.

In some examples, circuit elements may be mounted to a flexible board 1102 that is folded into shape as shown in FIG. 17. In some examples, the board 1102 has four portions corresponding to the top 1104, rear face 1106, bottom 1108, and front face 1110 of the pen holder 100. They are folded as shown by arrows 1112a-1112e to form a box 1114. In some examples, the front face portion 1110 may be longer than the others so that the part 1110b holding the sensor 104a may be extended as shown in FIG. 14. When not extended, the longer part 1110b of the face portion 1110 may be folded as shown, partially overlapping the shorter part 1110a. One of the faces may include an extension 1116 that can be folded to form the internal end contact 1024. More or fewer sections could be used, for example, the bottom section 1108 could be eliminated if no circuitry is needed on the bottom of the pen holder, or additional sections may allow more complex shapes.

As shown in FIGS. 18A-18C, the pen holder 100 may be in the form of a pen cap as in FIGS. 12-14, but may be configured to unfold in two sections 2020 and 2022, joined by a center section 2024, when the pen 10 is removed. The two sections 2020 and 2022 would fold back into a pen cap configuration when the pen 10 is reinserted into the center section 2024. The sensors 104 could be located in the sections 2020 and 2022, and the sections configured to place the sensors 104 at the proper positions when unfolded. The pen 10 may be charged through a first charging contact 2026 located in the center section 2024 and a second charging contact 2028 located in one of the side sections, e.g., section 2020.

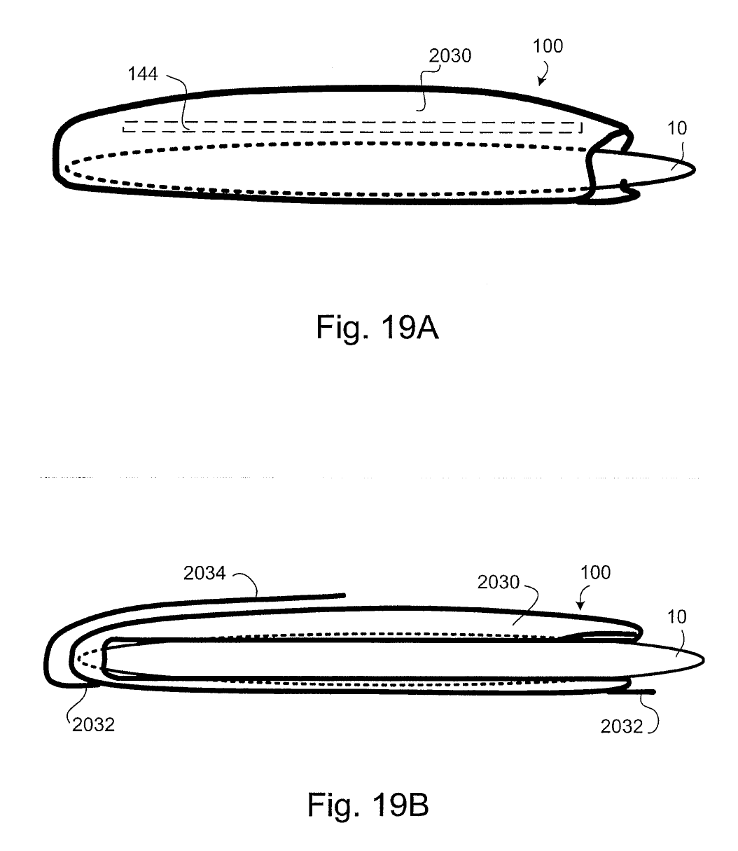

As shown in FIGS. 19A and 19B, a more compact pen holder design may be used, in which the circuit board 144 is moved closer to the pen 10, allowing the outer shell 2030 to be reduced in size relative to the pen holder body 102 described above. This may, for example, allow the pen holder to itself resemble a large pen that can be unobtrusively carried in a user's pocket. Internal components such as the charging contact 1024 may still function as above, modified as needed to accommodate the repositioned circuit board 144. The pen holder 100 in this example may include any of the features described above, for example, structures 2032 for attaching to a pad of paper or to the board of a clipboard or bookmark while a clip 2034 is used in the manner of a pocket clip in a standard pen.

Other embodiments are within the scope of the following claims.

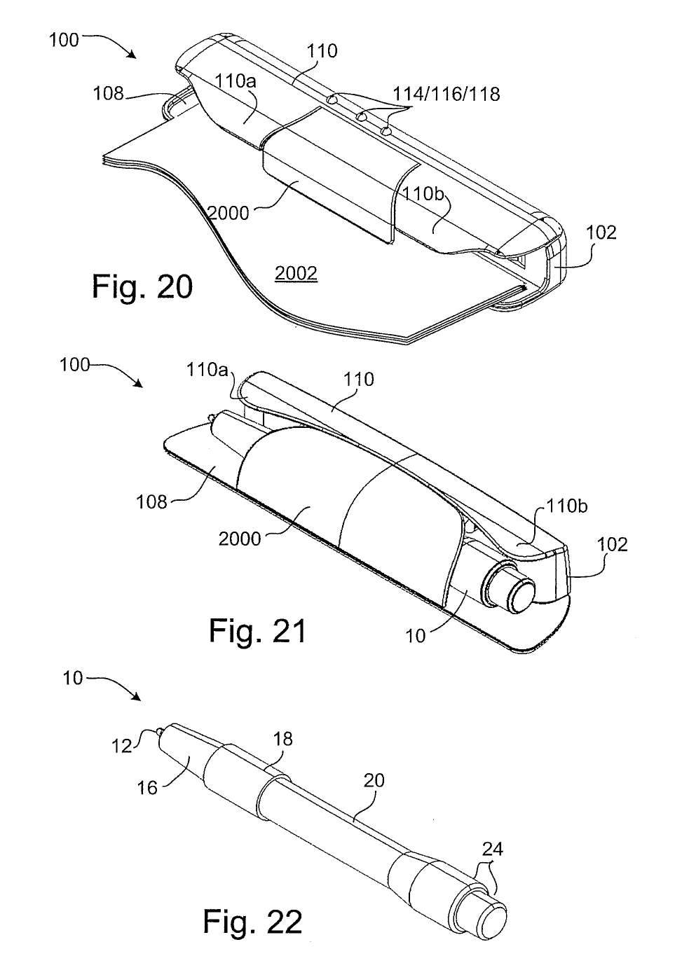

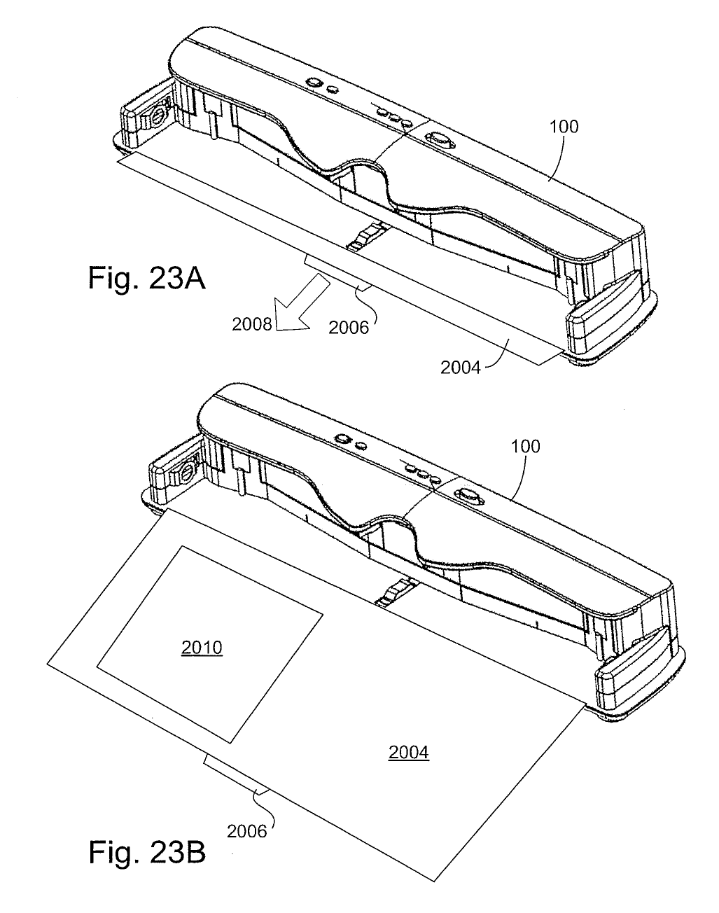

For example, as shown in FIGS. 20 and 21, the pen holder 100 may have a wide variety of other shapes. A clip 2000 can be provided that opens to release the pen and can be used to attach the pen holder 100 to a stack of paper 2002. In some examples, the clip 2000 may be of a material transparent to IR light so that it does not obstruct signals from the pen 10 to the sensors 104, 106. The pen 10 may also have a wide variety of shapes including the one shown in FIG. 22. As shown in FIGS. 23A and 23B, the pen holder 100 may include a retractable writing surface 2004 that is pulled out from the pen holder 100 by a tab 2006 (arrow 2008), which may be a reusable writing surface or may accommodate small pieces of paper 2010. Although the examples discussed earlier include sensors in a pen holder that can also serve as a clip of a clipboard, the sensing device could serve as a clip without also holding the pen. Although we have referred to a pen in much of the earlier discussion, many of the features apply to other kinds of writing instruments and styli.

In an example of a pen holder 2200 and a pen 2202, shown in FIG. 24, pen 2202 has a stylus end 2203 and a mouse end 2205. The stylus end 2203 includes reflectors 2228a and 2228b to reflect light produced by a light source. The stylus end 2203 may be equipped with a writing element 2209 (such as an ink cartridge with a writing point) that is capable of leaving a visible mark on a writing surface. The stylus end 2203 could be a non-marking blank or “dummy” so that the pen could be used as a stylus without leaving a mark on a writing surface. To switch between different types of stylus ends (e.g., the writing element or the dummy), a user may replace the stylus end by hand, or the user may twist, push, slide, snap, or pull the desired writing element into place by some other operation such as pushing a button or twisting a section of the pen 2202. In some examples, the stylus is replaced by unscrewing the lower part of the stylus from the upper part, giving access to the inside of the lower part. The mouse end 2205 of the pen 2202 has a grip area defined by flared sections 2281a, 2281b, and 2281c (2281b and 2281c not visible in FIG. 24), and gripping sections 2216a, 2216b, and 2216c (not visible in FIG. 24).

The pen holder 2200 has an outer shell 2204 that forms a main structure of the pen holder (which we sometimes refer to more broadly as a device). Disposed on the outer shell 2204 is a control panel 2224 including icons 2226a, 2226b, 2226c, 2226d, 2226e, and 2232. These icons can be illuminated and can represent status lights. Capacitive switches can be located below these icons to make the user interface simple and easy to use. Capacitive switches can have metal surfaces to extend their range of activation by connecting metal elements to sensitive elements of capacitive sensors on board and to prevent an accidental activation by shielding unintended parts of the package, leaving only areas for a finger to reach sensitive areas. Also the firmware associated with a capacitive switch can filter out activations from touching a part of a user by, for example, disabling simultaneous activation of two or more buttons. An interior molding 2206 defines an elongated chamber 2207 to accommodate the pen 2202. Contact springs 2208a and 2208b, near the top of chamber 2207, are positioned not to obstruct the sensors 2220a, 2220b, and 2222. Alignment ribs 2212a and 2212b project orthogonally from the bottom of chamber 2207, between the contact springs. As a user inserts the pen 2202 into the pen holder 2200, at first the user encounters mild resistance from the contact springs 2208a and 2208b. But as the user continues to insert the pen, it reaches a point at which the contact springs, by virtue of their configuration, grab the pen and pull it (e.g., snap it) into rest against alignment ribs 2210a and 2210b. In the rest position, a force 2221 (see also FIG. 27) is applied by the contact springs in a direction that pushes the pen toward the corners defined between two cusps 2211a, and 2211b of each of the respective ribs.

To prevent movement of the pen 2202 along the longitudinal axis of the pen holder, once the pen is inside of the pen holder 2200, the alignment ribs 2210a and 2210b are seated in respective grooves 2214a and 2214b that encircle pen 2202. The seating occurs easily because the positions of the grooves along the pen match the positions of the ribs along the chamber.

On each alignment rib is a tooth 2212a and 2212b that helps to hold the pen 2202 inside of the pen holder 2200.

To remove the pen, the process is reversed by simply pulling on the pen to release it.

When the pen is in the pen holder, the contact springs 2208a and 2208b contact conductive cylindrical charging rings 2215a and 2215b on the pen 2202. The charging rings 2215a and 2215b allow a charge to pass through contact springs 2208a and 2208b to recharge a battery (not shown) inside the pen 2202. The contact springs 2208a and 2208b need to make a reliable electrical contact with the charging rings even though their diameters may be different. If reliable contact is not maintained, the battery inside the pen 2202 may not charge properly, or the pen may slide around in the pen holder 2200, which could damage surfaces of the pen.

Storing the pen 2202 in the pen holder 2200 is useful, for example, because, in some examples, the pen holder charges a battery inside of the pen. Therefore, a user does not need to replace the batteries, as would be the case if disposable batteries were used instead. The pen holder protects the pen from physical damage and allows for easier transport of the pen. Also, because the pen and holder are wireless and portable, it is advantageous to store the pen in the same unit that contains the tracking electronics, as this combination reduces the number of components that a user may lose. By having a rechargeable battery in the pen that is charged from the pen holder, the pen battery does not need to be replaced. The pen holder itself and the pen can be recharged together. When mounted in the pen holder, the pen protects the sensors by blocking them. Mounting the pen in the pen holder reduces the need to have the ink cartridge be retractable, because the tip of the pen is not exposed. The pen holder 2200 may include rubber elements on the bottom of the outer surface to prevent the pen holder from sliding on the surface that it is resting on. The pen holder 2200 may also include features to attach clipping mechanisms which can be used to attach the pen holder to paper or other accessories.

The pen holder 2200 has a power switch (not visible) to turn the pen holder on and off. The icons on the control panel 2224 may serve a number of functions. For instance, an icon (e.g., icon 2226a) could be a battery level indicator that changes color to convey the status of the battery (e.g., the icon could be green when the battery is fully charged, red if the battery is at 5% capacity, and not lighted if battery is dead). A similar colored icon (e.g., indicator 2226b) could represent the amount of available memory. The control panel may also include a “new page” button (e.g., icon 2226d) and indicator. Pressing the icon 2226d starts a new page/file. The indicator blinks when the button is activated. The control panel 2224 may also include a Bluetooth® button and indicator (e.g., icon 2226e); pressing the icon 2226e causes the holder to attempt to connect to the last paired device, and the indicator displays connectivity status. The indicator 2232 may show whether the device is powered on or is off. The indicator 2232 may be brighter when the pen 2202 is in operation and may become dimmer with a visible “breathing effect” when the pen is in sleep mode. The breathing effect refers to the indicator alternating between progressively brighter and progressively dimmer levels.

A board assembly 2300 and its attached components are shown in FIG. 25. The board assembly 2300 is mounted behind chamber 2207 (FIG. 24) to form a subassembly on which electronics may be mounted. After assembly, some elements of the board assembly, including a BlueTooth® module 2304, are hidden behind the interior molding 2206 (FIG. 24), while some elements such as the sensors 2220a and 2220b, and the contact springs 2208a and 2208b, protrude into the chamber 2207 (FIG. 24). The board assembly 2300 serves as a mounting surface for these and other components and also provides power to the components through contacts that connect it to the battery. The contact springs 2208a and 2208b are attached to the board assembly 2300 directly. One of both of the contact springs make an electrical switch by contacting a corresponding detect contact 2601 (FIG. 30) when in a released position, such as in the example shown in FIG. 26.

As shown in FIGS. 27 and 28, each of the contact springs (in this case contact spring 2208a) is stamped from a metallic sheet, such as tempered bronze, and may be nickel or chrome plated. The material is bent to the shape shown in FIG. 27. The metal is bent at locations 2514, 2516, 2518, 2520, 2522, and 2524 to form segments 2500, 2502, 2504, 2506, 2508, 2510, and 2512. The contact spring 2208a is resilient and is meant to be pliable enough to be easily deformed temporarily by a user pushing the pen into the pen holder, yet rigid enough to exert a force on pen 2202 to hold it in place. The tip 2526 of the contact spring 2208a may be coined (as shown in area 2526) to make it more rigid in that region and also to prevent scratching of the pen. The tip may be left un-coined as shown in FIG. 29. The tip of contact spring 2208a is turned upwards to make the tip more rigid and to reduce scratching of the pen 2202 when the pen is being inserted into the pen holder 2200.

FIG. 30 shows the detect contact 2601, which also functions as a support structure to hold an “arm,” or a spring that goes down when the pen is not in the penholder. Formed of a conductive metal, the detect contact 2204 has two parallel plates 2604 and 2606. Plate 2604 terminates in pins 2608a and 2608b, and plate 2606 terminates in pins 2608c and 2608d. Plates 2604 and 2606 are joined to plate 2600 at intersections 2610 and 2612, respectively. These plates are formed from one continuous piece of metal, by bending or stamping. A tab 2602 extends vertically from plate 2600, and serves as a main contact point for contact spring 2208a.

Referring again to FIG. 26, in their normal positions as mounted on the board assembly, the contact spring 2208a touches and is therefore in electrical contact with the tab 2602. When the pen 2202 is placed in the pen holder 2200 under contact spring 2208a, the contact spring is forced away from tab 2602, thereby breaking its electrical contact with tab 2602.

When the pen 2202 is removed from the pen holder, at least one contact spring, such as contact spring 2208b, re-contacts tab 2602, thereby completing a circuit. Through connections with the contact spring and tab, a circuit on the board assembly may determine whether the pen is inside or outside of the holder 2200 and, accordingly, decide whether to activate or deactivate the pen holder 2200.

In FIG. 31 the flared sections 2281a, 2281b, and 2281c form a flared region 2295 (see also FIG. 24) on the mouse end 2205 (which is an example of a cursor control end) of the pen 2202. The flared sections are arranged approximately 120 degrees apart from each other about the longitudinal axis of the pen. The flared region may be the portion of the pen having the largest circumference. The flared sections are separated by three depressed gripping sections 2216a, 2216b, and 2216c, also arranged at equal angles about the axis of the pen. The depressed gripping sections are substantially flat to prevent the pen 2202 from rolling. Each of the gripping sections includes ribs (not visible here, but visible on FIG. 24) to aid gripping. The flared region and the gripping sections help a user to grip the pen comfortably and securely at the mouse end, when the mouse end is being used, and enable the user to manipulate the mouse end more precisely and easily for use as a mouse than would be the case with a simpler cylindrical outer pen surface. The gripping sections 2216a, 2216b, and 2216c and their corresponding ribs reduce the likelihood of a user's fingers slipping down the pen, which would cause them to obstruct the infrared (IR) window 2902 (FIG. 34, the same as element 2230 in FIG. 24), or the reflector 2915 of the mouse end 2205. The flared sections 2281a, 2281b, and 2281c along with gripping sections 2216a, 2216b and 2216c having flat or near flat surface also can prevent the pen from rolling off a table or other surface. The flared sections may be soft sprayed to provide greater comfort to a user, and to improve a user's ability to grip the pen.

As shown in FIG. 33, for example, the front of the stylus is a subassembly 2801 that is held on a mating part (subassembly) 2803 that forms the rest of the body of the stylus by threads 2326 (FIGS. 32, 33). The front of the pen has an ink refill or a dummy refill 2209 depending on the application. The refill is held inside the subassembly 2801. Each of the two subassemblies is made of metal, plastic and other parts and has several functions.

One function of the lower subassembly 2801 is to conduct light from light sources (e.g., four infrared LEDs and one red/amber LED) located at the end of the mating part (the upper subassembly) 2803. The subassembly 2801 also carries charging current from the pen holder through ring 2215a to the pen battery, and holds and guides the refill as it moves back and forth to activate an electrical switch or pressure sensor located adjacent to the LEDs. A holder (e.g., a spring, a metal ring, an internal tubing) can be used as a guide to keep the refill on axis within the pen 2202.

Referring also to FIG. 32, the lower (also sometimes called the front) subassembly 2801 has inner and outer concentric cylindrical optical light pipes 2818 and 2805. The two light pipes have effectively two reflectors respectively 2228a and 2828b. Light from the LEDs is conducted along the light pipes toward the tip of the stylus and reflected away from the stylus at the locations of the two reflectors effectively to provide two light sources at the tip of the pen, separated from each other by a known distance 2229 to permit a determination of the angle of the pen to a surface, such as a sheet of paper, on which it is being used to write.

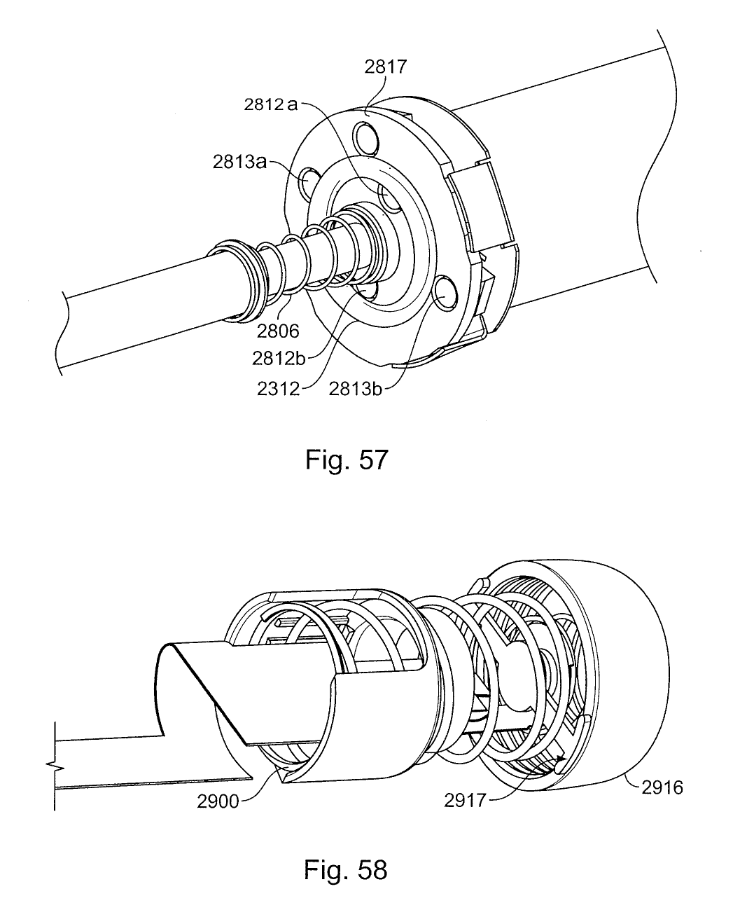

The inner optical pipe 2818 (FIG. 33) collects light from a pair of IR LEDs 2812a and 2812b coupled into that pipe, while the outer optical pipe 2805 collects light from another pair of IR LEDs 2813a and 2813b. The outer optical pipe also collects light from a red indication LED 2817 (FIG. 57) to indicate that communication with the pen has been lost, for example, because it has been moved out of sight or the pen battery is running low.

The two cylindrical light pipes are optically isolated from one another by a combination of brass tubes 2385 held in between them along their lengths. At the location where the optical pipes couple optically with their respective LEDs, an O-ring 2312 isolates the two pipes to prevent cross coupling of light between them.

The metal pipes and the O-ring also conduct electricity for charging the battery from the electrical contact ring 2215a. A plug 2818b is press fit into the hole at the upper end 2818a of the refill. The flared end 2818c of the plug supports an upper end of a spring 2806 (FIGS. 32 and 33) and holds the inner light pipe in position relative to the end 2818a of the refill. This arrangement enables the refill to slide inside the inner light pipe and holds the inner light pipe in place.

As shown in FIG. 55, the set of metal parts provides support and an electrical path for charging current from the battery. This set of metal parts includes the charging ring 2800, an electrical conduit 2804a and a rivet 2804b. The outer optical pipe 2805 is held between the reflective end 2228b of ring 2800 and a flared part 2803b of the rivet 2804b.

A snapping feature 2393 (FIG. 56) of the outside of the inner optical pipe enables a snap fit of the inner optical pipe within the body of the electrical conduit.

As shown in FIG. 32, a cross-sectional view, a main structure of the pen 2202 is formed by the joining of the outer casing 2300 with the inner casing 2302 at thread 2326. The upper assembly of the stylus 2803 holds a battery 2316. An electrical connection is made from the battery to a printed circuit board 2319 by a battery support 2314.

The refill 2810 resides in a chamber 2306 within the inner light pipe As mentioned earlier, at an end of chamber 2306 is a plug 2818 that in combination with the spring 2310 holds and guides the refill 2810 in place and provides a consistent orientation for pressing onto a pressure sensor 2318. When pressure is applied to the tip of the stylus end of pen 2202, the spring 2806 compresses against the spring support 2818c, and force is exerted on the pressure sensor 2318, which is constructed by a pressure-sensitive element that is deposited on the center of the circuit board 2319. A rubber material can interface the pressure sensor 2318 for a more even distribution of pressure.

The pressure sensor 2318 provides information that can be used to control the reproduction of line thickness, color, shade, darkness, or other attribute by monitoring the pressure a user applies when writing with the pen on a writing surface. In operation, the line attributes produced on a display may correspond to the amount of pressure that a user applies to the tip of the pen 2202. The pressure sensor 2318 can be used in conjunction with the stylus end 2203 or the mouse end 2205 of the pen 2202. For example, applying more pressure to the writing tip 12 of pen 2202 can increase the line thickness. The amount of pressure that must be applied to the pressure sensor 2318 to achieve different line thicknesses may be configured by a user. The pressure sensor is mounted on printed circuit board (PCB) 2319.

Pressure sensors would be a way to effectively match a pressure on the pen refill with an activation of an LED, as many off-the-shelf switches have an activation pressure above the desired level of 20 to 30 g. Details of the traces left on paper, whether made by ink refill, pencil, marker or other such tool, can be recorded. For example, a line thickness and a color scale can be represented by recorded pressure information. The line thickness or color can be set at default levels or can be adjusted in software to closely match markings made by a real pen on a paper (or other media). In some examples, the pressure information can be used to make special visual effects. In some examples, pressure sensitivity can be used in applications such as biometrics, security, control of instruments, video games, et al.

As shown in FIG. 34, a smooth convex surface 2912 on the mouse end 2205 may be pressed against and moved across a writing surface by a user. When pressure is exerted on the surface 2912, a reflector 2914 mounted on the back of convex surface 2912 along with an optically transparent cylindrical element 2915 travels slightly downward toward the pen end.

In some examples, a calibration of the pressure sensor 2318 can be performed when the pen 2202 is in a in a resting position during pen battery charging. When a processor on the pen 2202 detects that the battery is being charged, it assumes the pen is in a resting position. Frequent calibrations of pressure allow for the pressure sensor 2318 to change its characteristics somewhat over time but maintain the lowest pressure level when the pen 2202 is resting in the pen holder 2200 as a reference level that exerts no force on the pen tip.

At the same time, a light pipe 2908 also travels downward toward the pen end because it is part of the same subassembly. The light pipe 2908 may be made of brass, or another suitable material.

When the surface 2912 is pressed against a writing surface, pressure is exerted on a pressure sensor 2906. Infrared light is generated by an IR LED 2910, and the reflector 2914 reflects that light. The LED 2910 is powered by a battery (not shown), and receives power from flex circuitry.

A second path for battery charging is provided on the back of the pen through a charging ring 2916 that presses on a “spider” 2917 (FIG. 58) that connects to the spring 2900 that pushes on the metallic edges of the electronic board.

The mouse end 2205 also includes an infrared receiver 2904 for receiving communications from the pen holder 2200 (FIG. 24). A window 2902 around the stylus' circumference allows infrared light to reach the infrared receiver 2904.

The light reflected from the reflector 2914 is tracked by the sensors 2220a and 2220b (FIG. 1), and a processor within pen holder 2200 (FIG. 1) translates the received signal data into positional data related to the movement of the mouse end 2205 of pen 2202. The tracking of the location of the mouse end 2205 of the pen 2202 is similar to the way in which the stylus end 2203 is tracked, but there is a key difference. In the case of the mouse, it is the relative movement of the cursor relative to a point at which the mouse was most recently touched to a surface that is tracked. In the case of the stylus, it is the absolute coordinates of the stylus that are tracked relative to a reference location on or near the surface and mapped into the area on the screen defined by user. That is, the cursor is moved on the screen according to the relative motion of the mouse end 2205 from its last point of touching, and not to the absolute location of the mouse end 2205 on a surface.

This mouse end design allows a user to lightly drag the mouse end 2205 on a writing surface to a new location and registers as a cursor movement on-screen. The amount of pressure that must be applied to the pressure sensor 2906 to allow cursor movement may be configured by a user, as described above. When the user wishes to resume writing/drawing (leaving a mark) he can exert more force onto the writing surface via the pen. To register a left or the right mouse button click, one embodiment of the present invention includes tapping harder on the writing surface with the pen after lightly dragging the pen to its location. Additionally, this new method of lightly dragging the mouse end 2205 across the writing surface, allows for more support of the users arm yielding greater accuracy. The wrist has a support of the table instead of hovering in the air.

When a user lightly drags the pen 2202, a cursor is being manipulated on-screen. Existing operating system protocols (e.g., Windows Vista, MAC OS X) can receive pressure signals and can interpret any pressure signal that is above 15% of its total range as a tap or a click. The on-screen coordinates, which are relative coordinates when the mouse end 2205 is used and absolute coordinates when stylus end 2203 is used, are being recorded in a computing memory. If a tapping motion is performed by the user within a given time and spatial location of a previous cursor coordinate, a computing command, such as a left or right mouse click can be executed. The tap of the mouse end 2205 or the stylus end 2203 can touch down on the writing surface within a few (e.g., tens or hundreds) pixels and can yield an accurate tap, even if the user suffers from shaky hands. The number of pixels can be predetermined and set by the user. Users can also write keyboard equivalents (e.g., a combination of keystrokes that represent certain features, such as “ctrl-s” or “open apple-s” for a saving feature) with the stylus that enable them to open and close windows, and otherwise control an application without lifting the stylus from the tablet.

The pressure-sensitive stylus end 2203 or the mouse end 2205 of pen 2202 can each control a mouse that is used with a computer. For example, when the pen 2202 is used in conjunction with a program (e.g., Adobe Illustrator, Adobe Photoshop, Microsoft Word), a user can access tabs and fields around the screen and can use pen 2202 as a mouse, in which pressure signals are interpreted for clicking. When the pen 2202 is used in an area intended for writing or drawing, the pressure signal are interpreted for writing, and in applications that interpret pressure can show line thickness or line color scale depending on the settings. The pen 2202 records and interprets pressure while writing with ink on a surface (e.g., a tabletop or a sheet of paper) and these features do not require the pen 2202 to be used on an electronic surface.

In some examples, the pressure information is not sensitive to very light strokes that would leave a mark on paper but do not leave a mark on computer screen. In some examples, fast strokes made with the pen 2202 can be missed due to a lower pressure exerted when the pen goes down to paper and comes off.

In some examples, the stylus end 2203 or mouse end 2205 can “hover”, or move while being held at a small distance (i.e., about 2 cm) perpendicular to the writing surface, and this “hovering” motion can be used to move the cursor or to write or to draw.

In some examples, IR light can be emitted from the pen tip continuously or in a pulsed mode, and the pen 2202 can be used as a stylus even when it is not writing on paper but also when it is hovering. In some examples, the IR signal can be pulsed and synchronized with the pen holder 2200 when the pen 2202 is seen by the cameras in the pen holder. The IR signals can be in sync with the IR receiver of the pen holder 2200 and can reduce the energy consumption of the pen battery. When the pen is in contact with a surface and is dragged with even a slight pressure on the tip, a corresponding trace will be registered by the computing device and shown on a display because the pressure on the tip exceeds the pressure in resting position. The presence or the absence of pressure determines whether the pen 2202 should be used for leaving an ink mark or a cursor movement.

In some examples, a communication between the pen 2202 and the pen holder 2200 or between the pen 2202 and a computing device or between a computing device and the pen holder 2200 can indicate in which mode (e.g., stylus mode or mouse mode) the pen 2202 should operate. In some examples, the pen 2202 will emit light when hovering above the surface on which it is operating if it is used as a stylus in “computer mode” and the pen will not emit light when hovering if it is used in “sketch mode.”

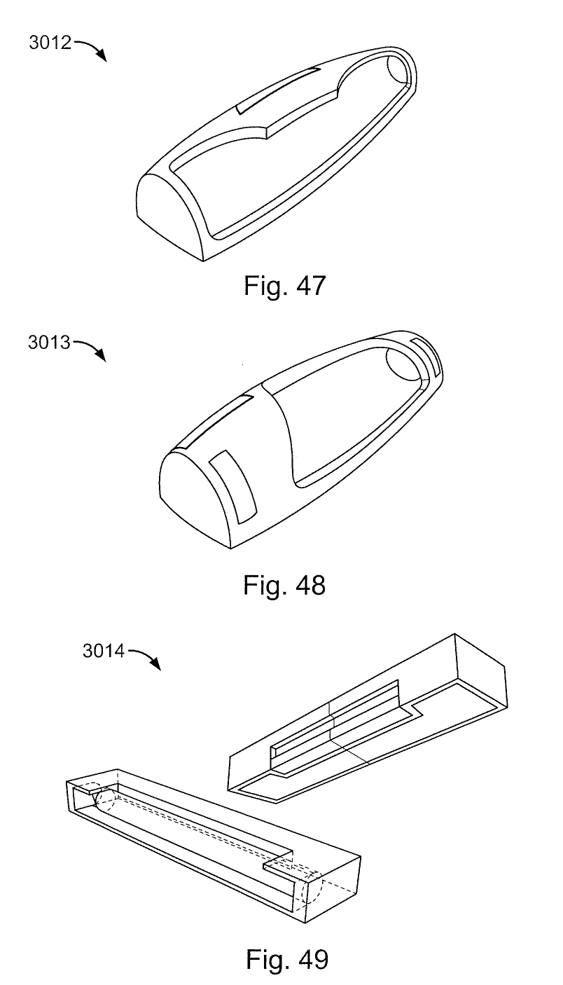

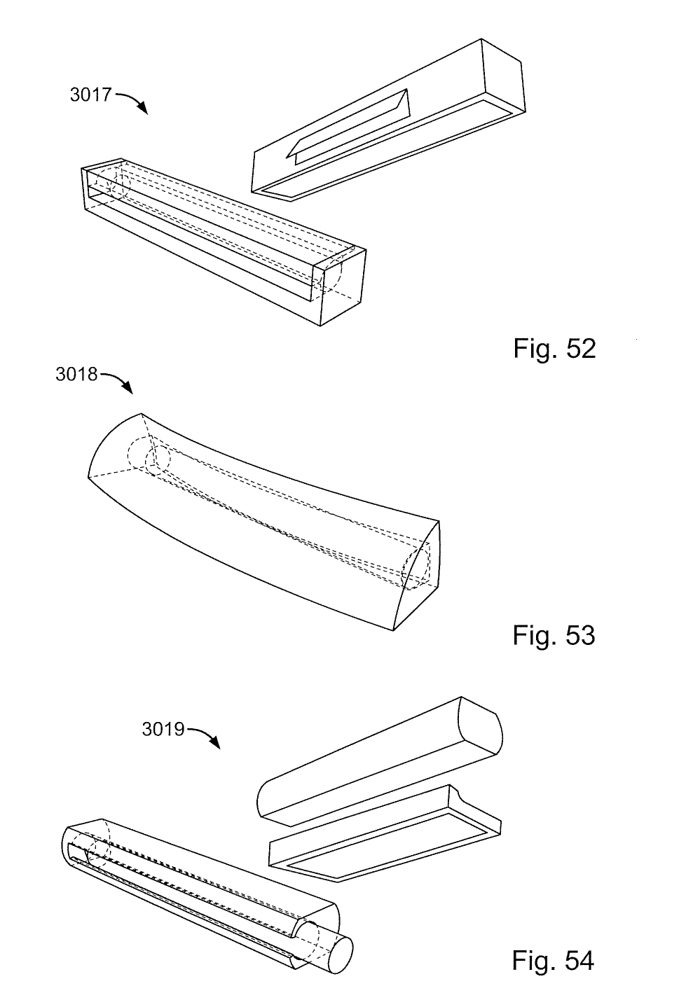

FIGS. 35 through 54 are non-limiting examples 3000-3019 of pen holders. In some examples, such as the example shown in FIG. 52, the pen is held in place by a lid, and the interface is disposed primarily under the lid. The pen could also be stored in and removed from a pen holder by sliding it in a hole in the side of the case, such as in the examples shown in FIGS. 48, 50, 51 and 54.

Displacements of the pen holder can be tracked using an optical or laser mouse such as a camera chip and then processed in software for correction of position of the handwriting in reference to the pen holder. The camera could be small and inexpensive, e.g., one with a resolution of only 32 pixels. An LED shines the light on paper, and the camera captures the paper scene, too. The pixels on the camera pickup a pattern from the paper. When the camera (which is in the pen holder) moves, the pattern moves. If a user picks up the pen holder or moves it accidentally, the processor could determine in what direction, rotation, and how far. The pen holder's position could be corrected to approximately where it was, and the sensor will help retrace its position versus the previous position. This sensor can work especially well in association with a simple clip to hold pen holder to paper, or even without a clip but a sticky rubber bottom.

In some examples, the pen may be used as a stylus when connected to a computer. This may be in conjunction with an application such as ADOBE PHOTOSHOP. A device establishes communication with the computer on which the application executes. A server or application associated with the device identifies data passed between the device and the computer. In some examples, the server or application provides instructions to turn on and keep on an IR emitter on the pen (via communication link between the pen and the device via IR bi-directional link) all the time. The IR emitter emits signals even when the pen is off the surface. The device therefore tracks the tip of the stylus even when it is moving within a certain space off the surface (within its field of vision in vertical and horizontal axes).

In some examples, the pen operates as a stylus by default when connected to a computer and moves the cursor even when hovering. In such cases, when the device is not connected to a computer (or any other computing device requiring a mouse or stylus), it switches to the pen mode where the IR emitter is turned on only when the stylus touches the surface. Such an implementation may result in energy savings.

In the stylus mode of operation, more power is consumed. However, the device may be plugged into a USB of a computer for charging while operating in the stylus mode.

### Pen Holder

In some examples, the pen can be held securely in tension between specially-designed contact faces within the pen holder. Referring to FIG. 59, the pen holder 2200 contains a spring 6202 on one end and a stop 6204 (which we sometimes call a holder) having a curved opening 6205 on the opposite end. The opening is slightly smaller than the diameter of the portion of the pen that is to be held by it so that pressing that portion of the pen against the holder snaps the pen into the holder. The spring 6202 is held in a spring housing 6206.

As shown in FIG. 60, the pen 2202 can be inserted into the pen holder 2200 by inserting the writing end 11 of the pen first and compressing a compliant contact (e.g., the spring 6202), then inserting (e.g., snapping) the mouse end 2205 second into the curved opening 6205 of the stop 6204. Referring to FIG. 61, the pen 2202 can be inserted into the pen holder 2200 such that the pen is in contact with the spring 6202, the stop 6204, and the electrical contacts 6207, 6209 used for charging the battery in the pen. The curved opening 6205 is formed to enable the mouse end 2205 of the pen 2202 to be snapped in by a gentle pressure on the mouse end and to be removed by a gentle pulling on the pen.

FIGS. 62, 63, and 64 are other views of the pen 2202 and pen holder 2200 that contains the spring 6202, the stop 6204, and the spring housing 6206.

FIGS. 65 and 66 are views of a portion of the spring housing 6206, which contains the spring 6202 and a metal contact 6208 that is positioned between the spring 6202 and the stored pen. The spring 6202 and the metal contact 6208 are held in the spring housing 6206. The large radius of the metal contact 6208 prevents it from contacting and possibly damaging the optical light pipes 2818 and 2805 on the pen 2202 when the pen is stored in the pen holder 2200.

As shown in FIG. 77A, the curvature of the metal contact 6208 allows for a reliable contact with the charging ring 2215a while preventing it to touch and damage the optical reflectors 2228b or 2228a.

FIG. 67 shows the stop 6204, which is part of the pen holder 2200 (not shown). The stop 6204 is attached to the body of the pen holder 2200 through mounting surface 6212. The outer surface 6203 of the stop 6204 that is in contact with the pen 2202 is made of a smooth material, such as a plastic, to prevent scratching any part of the pen (e.g., the light pipe 2205 or the light pipe 2218). Metal contacts 6210a and 6210b are embedded in the stop 6204. The outer portion 6210c for each metal contact is shaped to conform to the curved opening 6205 of the stop 6204 and to minimize damaging the surface of the pen 2202. The metal contacts 6210a and 6210b are electrically isolated from one another so that when the pen 2202 is inserted into the pen holder 2200, a circuit (not shown) will be electrically completed and the presence of the pen 2202 will be detected.

As shown in FIG. 68, in some examples, the metal contact 6208 (depicted in cross section) can be placed between the spring 6202 (depicted in cross section) and the front face 13 of the pen 2202. The stop 6204 can also have a slightly rounded end 6214 that helps prevent the pen 2202 from becoming dislodged. The stop 6204 and the rounded end 6214 can be made from a pliable material, such as plastic.

In some examples, a second curved holder is used instead of the spring 6202 and the spring holder 6206, as shown in FIGS. 69 and 70. The writing end 11 of the pen 2202 is inserted into a second curved holder 6214 in the pen holder 2200 to secure the pen in place. The second curved holder 6214 is similar to the stop 6204.

In some examples, as shown in FIGS. 71 and 72, the securing devices that hold the pen 2202 inside the pen holder 2200 can be springs 6218a and 6218b. The spring (e.g., spring 6218a) can have a rounded end (e.g., rounded end 6220) that loop back toward a part 6222 of the spring and are shaped in such a way to accommodate different diameters of different parts of the pen 2202. The springs with rounded ends facilitate the insertion of the pen 2202 into the pen holder 2200 regardless of which end of the pen is inserted first.

### Corrections to Measured Data

The sensors in the pen holder 2200 can assume that the pen tip is at the same location as the light coming in from the reflector at the tip of the pen 2202. When a user writes or draws with the pen 2202, an angle 7080 can be formed between the pen 2202 and the writing surface 7000, as shown in FIG. 73.

In some examples, two linear CMOS sensors are located in approximately the same plane as the writing pen tip. In some examples, these sensors can be in the plane (or close to the plane) of the lowest light reflector on the pen 2202. A projection of the light source on the horizontal plane can serve as a first approximation to the location of the pen tip. Such pens also work but exhibit some tilt errors that in some applications can be damaging.

In some examples, two light sources can be used for angle or tilt detection. The use of cylindrical lenses ensures a light projection on the pixel elements of the sensor, because linear sensors are used and because of the close proximity in the vertical plane of the sensor and light sources. In other words, the light spot projected onto a sensor would not roll off due to a tilting of the pen 2202 or due to another variation in the direction of emitted light. This could not be ensured if spherical lenses were used.

When using a single two-dimensional (2D) camera, vertical movements of the light projection onto a 2D sensor from different light sources on the pen 2202 are of particular interest. Such movements provide information on how the pen 2202 (or any other object) is positioned in a three-dimensional space, which will permit calculation of the angle between the pen 2202 and the surface 7000, leading to a precise determination of a position of the tip of the pen. For a more detailed discussion, refer to U.S. Ser. No. 09/991,539, entitled “Capturing Handwriting.” FIGS. 73-75 illustrate a single camera approach to determining a spatial position of an object.

### Data Transfer Between Pen and Pen Holder

When either the stylus end 2203 or the mouse end 2205 of pen 2202 is used, the pen 2202 transmits data (e.g., a value of pressure, a spatial location, an angle between the pen 2202 and the writing surface 7000, a signal specifying whether the stylus end 2203 or the mouse end 2205 is being used, a time stamp) to the pen holder 2200. In some examples, a large number of pressure levels (e.g., 300, 256, 200, 128, 100, 64) can be transmitted (e.g., in 8 bits of data) from the stylus end 2203 and data (e.g., 4 bits) can be transmitted from the mouse end 2205 of the pen 2202.

The data can be encoded into the same signal transmitted by the IR LEDs used by the two CMOS linear arrays to indicate the position of the writing tip 12 of the pen 2202.

This transmitted signal can be captured by an IR Receiver and then a modulated signal can be extracted to capture the encoded data. For example, an off-the-shelf IR Receiver (e.g., an IR Receiver used in a TV remote control) can be used to lock on a carrier frequency (e.g., 36 kHz) to synchronize the pen 2202 and the pen holder 2200 using the same IR receiver (so the same IR receiver is used to sync the pen 2202 to acquisition on the pen holder 2200 and to send data to the pen holder 2200). Referring to FIG. 78, a timing diagram that illustrates an example of sending data. In this example, the frequency of the modulated IR light transmitted by the pen 2202 can be changed (e.g. from 36 to 72 kHz) so that the IR receiver on the pen holder 2200 (also called the “dock”) toggles its output to produce bits for the data. A zero bit is produced by the IR receiver by a 36 kHz modulation; a high level is produced by a 72 kHz modulation.

In some examples, the pen holder 2200 can send a signal (e.g., an IR signal) back to the pen 2202. For example, the pen 2202 can send data to the pen holder 2200, the pen holder 2200 can analyze the signal, and then, the pen holder can send back data to the pen during the “Reserved for Feedback” slot in FIG. 78. For example, if the signal transmitted from the pen 2202 to the pen holder 2200 is very strong, the feedback data from the pen holder to the pen could be an instruction to decrease the signal level of the IR LEDs, saving the battery in the pen. For example, if the signal transmitted from the pen 2202 to the pen holder 2200 is very weak, the feedback data from the pen holder to the pen could be an instruction to increase the signal level of the IR LEDs.

Should the pen 2202 no longer receive a feedback signal from the pen holder 2200, this could indicate that the pen has strayed out of bounds, a transmitted signal between the pen and the pen holder has become blocked, the battery in the pen is dead, etc. An absence of a feedback signal can result in a turning on of a red LED in the pen 2202. This red light can be emitted through the outside of the light pipe within the pen.

In some examples, a separate communication link could be used to transfer data between the pen 2202 and the pen holder 2200.

### Methods of Use

The pen 2202 can operate in different modes, depending on whether or not the pen holder 2200 is in communication with another device and, if the pen holder is in communication with another device, what type of device (e.g., a cell phone, a computer) it is. For example, a user can write or draw with the pen 2202 in a “sketch mode,” in which the data representative of the sketch or writing is saved in the memory of the pen holder 2200. At a later time, the data can be transferred from the pen holder 2200 to another device (e.g., a cell phone or a computer) by using a hardware connection (e.g., a USB cable) or a wireless connection (e.g., BlueTooth® module 2304).

As shown in FIGS. 79, 80, and 83 a user can operate the pen 2202 in “mobile mode,” in which a connection (e.g., a BlueTooth® connection, a hardware connection) is enabled between the pen holder 2200 and a cell phone 7002. In the “mobile mode,” data (e.g., a sketch or a writing such as text 7004a) that is produced by the pen 2202 on a surface (e.g., a paper 7000) is streamed directly from the pen holder 2200 to the user's cell phone 7002. This data transmission can be encrypted. The cell phone can store or display the transferred data, for example, cell phone 7002 displays a text 7004b on its screen after receiving the data transmitted by pen holder 2200 in response to the pen 2202 writing text 7004a. A software package (e.g., PenScribe, which is described below) can be used to store data in the cell phone 7002 and to display on the cell phone the data generated by the pen 2202.

As shown in FIGS. 81 and 82, a user can operate the pen 2202 in “computer mode,” in which a connection (e.g., a BlueTooth® connection, a hardware connection) is enabled between the pen holder 2200 and a computer 7006. When the pen 2202 functions in “computer mode,” data is streamed directly from the pen holder 2200 to the computer, on which the data may be stored or displayed. This data transmission can be encrypted. A software package (e.g., PenServer, which is described below) can be used to store data in the computer 7006, and to display on the computer display 7008 the data generated by the pen 2202. The stylus end 2203 or the mouse end 2205 of the pen 2202 may be used in “computer mode.”

Referring to FIG. 134A, when the pen 2202 is used in computer mode with a laptop, IR sensors can be positioned on both sides of the laptop to allow a left-handed or right-handed user to use the pen 2202 or both the keyboard and the pen 2202 simultaneously.

Referring to FIG. 134B, positioning the IR sensors on the display, above the keyboard allows the user to place a writing surface or a document on top of the keyboard, saving desktop space.

In some examples, the IR sensors could be located on both sides of the laptop in addition to on the display. These sensors could be integrated to create an area in which the pen 2202 could be used and could be in communication with the pen holder 2200 or with another device. The functional area for the pen 2202 could include a keyboard and the space surrounding a laptop. This functional area could be an accessory device.

The IR sensors can detect the pen 2202 “hovering” (i.e., moving or resting at a distance of about 2 cm) above a surface or a sheet of paper. This detection can be referred to as a “tethered mode.” Tapping the pen 2202 on a surface or a sheet of paper can function as a “left mouse click” while in “tethered mode.”

In some examples, a button could be placed on the body of the pen 2202. Depression of this button, for example, by a user's thumb, could be interpreted as a “right mouse click.”

For example, if a user who is using the pen 2202 in a Microsoft Word or other editing program would like to select a different color in which to write, he could hover over the paper to a position on the screen corresponding to where a palate button is located in the editing program, and then would proceed to tap the pen 2202 on a surface (e.g., a table top or a sheet of paper). The computer would interpret this tapping motion as a “left mouse click”.

For example, if a user wanted to use a “select” feature within a program to grab a group of objects, a drag function could be accomplished by holding down the “right mouse click” button while hovering over the objects for selection. This action is unlike a regular mouse in which the left button is used for the “select” feature.

In some examples, the dimensions of the pen 2202 can be reduced so that the pen can be stored more easily alone or with other devices (e.g., a cell phone, a laptop computer, a tablet computer).

### User Interface and Operating System

The PenServer program is installed on the computer 7006 and packages the data transferred from the pen holder 2200 so that it can be parsed by the PenServer and passed on to the operating system of the computer. The data transferred from the pen holder 2200 can include a value of pressure, a spatial location, an angle between the pen 2202 and the writing surface 7000, a “pen up” or “pen down” signal, a signal specifying whether the stylus end 2203 or the mouse end 2205 is being used, and a time stamp.

The PenServer program runs on a computer (e.g., computer 7006) and relays the data transferred from the pen holder 2200 to an application programming interface (API), such as Ink in the Macintosh (MAC) environment or InkCanvas in the Microsoft Windows environment or Tablet and Touch Technology for a TabletPC. The PenServer program allows the data (also called “ink” or “digital ink”) to be interpreted by the computer 7006 as text or as drawing, with an absolute spatial reference frame, when the stylus end 2203 of the pen 2202 is used or as mouse movements, with a relative spatial reference frame, when the mouse end 2205 of the pen 2202 is used. In some examples, the pen 2202 can alternate between the mouse and stylus application depending on, for example, the position of the cursor in a window or the amount of pressure applied to the pen 2202 by the user.

For example, when a user prints text using a stylus (e.g., pen 2202), the API processes the text and can recognize text, if the recognition option is selected, and pass the text to the current insertion point, just as if the user had typed the text on a keyboard. Users can also write keyboard equivalents with the stylus that enable them to open and close windows, and otherwise control an application without lifting the stylus from the tablet. Users can turn handwriting recognition on or off, control where “inking” is permitted, and enable or disable recognition of predefined editing gestures.

APIs can provide automatic support for “ink” input into applications. As long as “ink” features are available in the system preferences, an application receives “ink” input as text without requiring any modifications. For example, the API can pass the data to a program for text editing (e.g., TextEdit, Microsoft Word, Microsoft PowerPoint, Internet Explorer), in which the text written with the pen 2202 is automatically recognized and entered as a stream of key down events into a document or text field. The API can also pass the data to a program for drawing (e.g., Adobe Photoshop, Adobe Illustrator, AutoCAD).

“Ink” data can also be used with additional applications created, for example, in Carbon and Cocoa (on the MAC) or Tablet PC SDK and Windows Presentation Foundation (in Windows). Some of these additional applications can provide features such as handwriting recognition (on a word-by-word or character-by-character basis), alternate interpretations for “ink” input, deferred recognition and recognition on demand, direct manipulation of text using gestures, access to Ink data at multiple levels (points and recognized text). Ink applications can recognize English, French, and German language input. The language that is recognized depends on the user's language setting in system preferences.

### Data Management

Pen File Manager (PFM) is an application programming interface (API) that is executed by an operating system (e.g., Windows Vista, Mac OS X). As shown in FIGS. 90-130, the pen file manager 8000 provides users of the pen 2202 with functions to manage data. For example, users can import files from the pen holder 2200 to a computer-readable medium, and then store, view, or organize those files. The computer-readable medium can be a machine-readable storage device, a machine-readable storage substrate, a memory device, a composition of matter effecting a machine-readable propagated signal, or a combination of one or more of them.

Data files created by the pen holder 2200 have a file format identified by an extension “cdn” (for CandleDragon Note). Each pen file represents one page of handwriting captured using the CandleDragon pen. The following data is stored inside a pen file: a size of a page created by pen 2202; a date and a time when the file was created by pen 2202; and a set of data points representing a trajectory of pen 2202. Each data point in the trajectory is described by three numbers: two spatial coordinates (e.g., X and Y) and a value of pressure applied to the pen 2202 when the data point was captured. In some embodiments, a third spatial coordinate could also be recorded.

The pen 2202 can store pixel data from both reflectors (on the stylus end 2203) and from one reflector (on the mouse end 2205). The pen server can present this data as coordinates and angles/tilts.

In the PFM, the main grouping unit for files is the file creation date. When files are imported from the pen they are grouped by date. Users can also create a notebook, which is a container storing references to actual files. The purpose of notebooks is to let users keep sets of related pages in one place. In the PFM, there is a command in the main application window (described below) to create a new notebook, which has only one attribute, its name.

In the PFM, the main application window includes a “navigation” pane and a “content” pane. The navigation pane displays a list of dates for which there are pen files and a list of notebooks that have been created. The content pane shows page thumbnails. The set of pages shown in the content pane depends on what item is selected in the navigation pane. If a date is selected, the content pane shows all pages created on that date. If a notebook is selected, only the pages from the selected notebook are shown. Pages can be copied or moved between notebooks by selecting page thumbnails and then dragging and dropping them on the target notebook in the navigation pane.

Table 1, below, lists operations that can be performed on a file or a set of files. The table also specifies whether an operation is applicable to a single file or to a set of files. A description for each operation follows Table 1.

TABLE 1
Operations Performed in Pen File Manager

| Operation | Single File | Multiple Files |
|---|---|---|
| Rotate | x | x |
| Set Page Size | x | x |
| Delete | x | x |
| Export | x | x |
| Split | x | |
| Merge | | x |
| Import | x | x |

The “Rotate” command rotates file data by 90, 180, 270 degrees in a clockwise or a counter-clockwise direction. The “Set Page Size” command permits the designation of page size (e.g., 11×17 inches, 8.5×11 inches). It is also possible to select one of the widely-used page sizes (e.g., Letter, A4). The “Delete” command prompts a user to choose whether a file is deleted or the reference to the file is deleted from a notebook. Deleting a file from a date deletes the actual file and also all references to it in all notebooks.

The “Export” command permits data to be transferred in a graphical formats, for example, JPEG, GIF, PNG, PDF, or SVG. For each type of export, the pen file manager keeps a set of default parameters. When exporting to raster image formats it is possible to specify resolution of the target image. Each format has its own specific export parameters (e.g., JPEG compression, resolution of target image). As indicated in table 1, it is possible to perform an export operation on a set of files. When a multi-file export is performed using a format that supports multiple pages (e.g., PDF) or layers (or other similar concepts) in one file, there is an option to export the selected pen files to either separate files (one for each pen file) or to a single target file in which each pen file is converted to a page or layer.

The “Split” command permits a user to retroactively paginate text or sketches. For example, if the user of the pen 2202 does not indicate (e.g., by depressing icon 2226d, by using switch 114) that a new page is desired or if a user's indication is not received by an additional sensor (e.g., a sensor on clipboard 202), multiple pages of actual text created by the user will overlap one another, that is, they will be part of the same data file. Additional page breaks may be added and separate files created at a later time by grouping the data based on a timestamp that is applied to the data when it is transferred from the pen holder 2200.

The timestamps on the pieces of handwriting data in a file can be used to retroactively separate pages by graphically unwinding the handwriting from the end of the file (timewise) toward the beginning of the file (while watching the unwinding presented in a “video” form) until the beginning of the final page is reached and so on for each page back to the first. The “Split” tool is implemented in a fashion similar to video editors and consists of a “timeline” pane and a “preview” pane. The timeline represents the time during which the contents of the file were captured. The timeline has a current position pointer that the user is able to shift and to set split marks between pages of data. Pressing the “Split” button separates the file at split marks into multiple new files. The creation date of the new file is set to the creation date of the original file. The user is prompted to save or to delete the original, non-separated file.

The preview pane displays contents of the file beginning from the left split mark closest to the current position pointer up to the current position. If there are no split marks to the right of the current position, then the beginning of the file is used as the starting point for preview.

The “Merge” command combines the contents of several pen files into one file. The user is prompted to save or to delete the original, unmerged files. The creation date of the new file is set to the creation date of the oldest merged file. The files can be merged with all data maintaining the same coordinates on paper, permitting, for example, designers to create several levels of layers.

The “Import” command permits a user to download all files to the computer 7006 from the pen holder 2200. When the pen holder 2200 is connected to the computer 7006 through, for example, a USB or a BlueTooth® link, the user is prompted whether or not to start the Import utility. In addition, a user can start the import utility at any time the pen holder 2200 is connected to the computer 7006 by selecting the Import option from the application menu.

After the pen holder 2200 downloads data from the pen 2202, the user is able to select files to be imported. Each file in the pen holder 2200 has an attribute that specifies whether or not that file has been imported previously. The Import command has an option to select all files that have not been imported.

After the Import command is successfully executed, all imported files are placed into the Last Import notebook and can be displayed as thumbnails. There is an option that specifies whether the files selected for import should be deleted from the pen holder 2200 after a successful import.

In some examples, specific buttons for file conversion are available. Fore example, a user can click on a file and then on an Adobe Illustrator button, resulting in the application automatically opening Illustrator with the converted file.

### Collaboration

The pen 2202 can be used as a natural and seamless input device to a number of on-demand collaboration, online meeting, web conferencing, or video conferencing systems (e.g., WebTrain Communicator™, Genesys Meeting Center®, Adobe Acrobat Connect™, Lotus Sametime® Connect™, Microsoft® LiveMeeting, Microsoft® Net Meeting, WebEx™).

For example, during a meeting, a participant could use the pen 2202 to sketch charts, to note questions, or to make notes on a virtual whiteboard for other participants to see. The pen 2202 could provide the presenter and/or attendees the ability to highlight or to mark items on a slide presentation or to make notes on a blank whiteboard. The participant could use the pen 2202 to explain information (e.g., a chart, a spreadsheet) as it is displayed on a screen. The participant could speak over a standard telephone line or a voice over internet protocol (VoIP) while explaining. As shown in FIG. 134C, one or more participants could each use a pen (e.g., pen 2202), simultaneously or sequentially, and contribute to a group drawing 8010 in a common area or to an individual drawing 8020a and 8020b in its own area.

Different pen operations can be processed by different or by the same pen holder. If multiple pens were used on the same surface, they could be processed by the same pen holder. Thus, the IR emitted by the pen 2202 has to be synchronized with the pen holder 2200 to keep track of which pen is writing presently. This can be achieved by time multiplexing or by users writing sequentially, in turn, after each has finished his own writing. When pens are used on different surfaces and could be at different locations, each pen holders has a unique ID number.

A participant could use the pen 2202 as part of a text-based chat feature for live question and answer sessions or for a poll or a survey to convey questions from a presenter to a participant.

In some examples, the pen 2202 can be in communication (e.g., via a wireless connection) with a projector in a room. One or more participants could each use a pen (e.g., pen 2202), simultaneously or sequentially, and contribute to a group drawing in a common area or to an individual drawing in its own area.

In some examples, the pen 2202 can be in communication (e.g., via a wireless connection) with a projector in a room. One or more participants could each use a pen (e.g., pen 2202), simultaneously or sequentially, and contribute to a group drawing in a common area or to an individual drawing in its own area.

In some examples, the pen 2202 could be used to generate lecture notes from a lecturer who is giving a presentation. The pen 2202 could be used on a whiteboard or a chalkboard by a lecturer and sensors could be located around the whiteboard or the chalkboard.

In some examples, the pen 2202 could be used to digitize medical records or patient charts. As a health care practitioner is filling out a traditional paper form (e.g., form 234) with the pen 2202, the same information could be stored in a digital format and transferred to a computer 7006 simultaneously or at a later time.

### Electronic Signature

In some examples, the pen 2202 could facilitate electronically signing documents.

For example, a lawyer could send his client an email containing a PDF file, which is a document that the client and three of his partners, who each live in a different city, must sign. Typically, the recipients would have to print out the document, find the spot to sign, date, initial and arrange for the document to be delivered back to the lawyer the following day. These transactions would be unnecessary if the pen 2202 were used by the client and his partners to sign the document. For example, the lawyer could use a program to digitally mark a signature line or use a different color to indicate where the client and each partner should sign the document. This document could be emailed to the client and to each partner and each party could access the document on an electronic device (e.g., the computer 7006, the cell phone 7002) or print out the document. If the recipient accesses the document electronically, he could use a handheld digital device (e.g., the pen 2282) to sign and to initial the document in the indicated location(s) and would not be required to print out the document. If the recipient chooses to print out the document, he could align the coordinates of the printed document with an electronic document and sign both documents. Alternatively, a stored signature, produced by a user with the pen 2202, or a signature written contemporaneously with the pen 2202 could be moved to appropriate places within the document. The user could sign anywhere, for example, on a plain table surface, and could place the signature in the correct location using an interface on the computer or hand-held device.

A handwritten signature, produced by the pen 2202, is embedded into the digital document that was to be signed.

As each recipient emails the signed document to the lawyer, it will be apparent who has signed and at what time (as the signature has a time stamp) and who needs to be reminded to sign.

In some examples, an authenticity of a user's signature can be verified by analyzing characteristics of the signature and comparing these characteristics with previously-determined signature characteristics. For example, these signature characteristics can include a measure of a pressure or a force (or, equivalently, an acceleration) applied to the pen 2202 when generating the signature, an angle at which the pen 2202 is held with respect to the writing surface 7000, a velocity at which the signature is written with the pen 2202. These and other characteristics can be communicated via a data link (e.g., the same infrared link used for other data transfer, a different infrared link, a radiofrequency or other link). These characteristics can be encoded into a file that is attached to a vector graphical file or an image of a signature that is to be verified. This verification can be performed by a security protocol by a party (e.g., a bank, a law firm, a government agency) who receives a signed document (e.g., a check, a legal document).

Encoding data signals into an IR signal for triangulation is inexpensive but has deficiencies (e.g., a low bandwidth). When using one end of the pen 2202, the other end can be used for the simultaneous transmission of data to the pen holder 2200 or to any other device that can receive data (e.g., a computer, a cell phone). In some examples, the pen holder 2200 can receive data from the pen 2202 and transmit the data to any other device that can receive data.

In some examples, while the stylus end 2203 of the pen 2202 writes on a surface 7000, the mouse end 2205 and its associated IR LED can transmit pressure or other signals using a standard IR LED protocol. Any data related to an operation of the pen 2202 can be transmitted, including transmission of data related to some additional sensors added to the pen.

In some examples, the pen 2202 can be used in graphology, or the study of handwriting in relation to human psychology. For example, characteristics (e.g., a slant of letters, an angle formed between the bottoms of successive words, a shape of strokes, a shape of individual letters, a pressure applied when writing) of a user's handwriting can be used to suggest aspects of the user's personality, behavior, or emotional state.

For example, the pen 2202 can be used to record various strokes, letters, slants, or angles, and the related psychological traits can be recorded in a database. Software could be used to analyze a user's handwriting by comparing the characteristics to the characteristics stored in the database and their associated traits.

The coordinates that represent handwriting, or traces of the pen 2202 the writing surface 7000, can be displayed on a monitor 7008. The tracked handwriting can be translated into ASCII in real time or at a later time. Either format, raw cursive or drawing motion, or handwriting that has already been converted to ASCII, can be stored in memory of the pen holder 2200 or transmitted to other devices. Other processing of data, such as language translation, may be done on the capturing device or later on using the computer 7006 or a server to which the data has been uploaded. Additional information about uploading and further processing is found in U.S. patent application Ser. No. 09/832,340, filed on Apr. 10, 2001, and incorporated by reference in its entirety.

In some examples, the chronological order of notes taken within a digital document could be analyzed. Correlations could be computed between the level of organization a user exhibits (e.g., as judged by a survey) and the temporal or geographical sequence of their writing. The correlations could be used in psychoanalysis.

Other examples are within the scope of the following claims.

What is claimed is:

1. An apparatus comprising:
electronics, including at least one sensor, to wirelessly track motion of a stylus;
a receptacle, coupled to the electronics, to hold the stylus when not in use;
one or more mating elements coupled to the receptacle to mate with one or more corresponding elements on an outer surface of the stylus when not in use; and
at least one retainer to push the stylus against the one or more mating elements.

2. The apparatus of claim 1 in which the one or more mating elements comprise:
one or more ribs that project in a direction normal to a longitudinal axis of the stylus when the stylus is held in the receptacle, the one or more ribs each have a receiving corner, the retainer configured to apply a force in the direction of the receiving corners to snap the stylus into the receptacle.

3. The apparatus of claim 1 in which the retainer comprises a conductive element connected to pass a charge to a conductor on the stylus to charge a battery in the stylus.

4. The apparatus of claim 1 in which the retainer is part of a circuit that determines whether the stylus is in the receptacle.

5. The apparatus of claim 1 in which the stylus comprises at least one of a pen, pencil, marker, or other writing instrument.

6. An apparatus comprising:
a stylus—motion of which is to be tracked wirelessly by electronics, including at least one sensor, coupled to a receptacle configured to hold the stylus when not in use, the stylus comprising:
a pen end;
a mouse or cursor control end;
an outer surface bearing one or more stylus elements to seat on one or more receptacle elements of the receptacle; and
conductive elements to make electrical contact with the receptacle to receive a charge to be stored in an energy storage device in the stylus.

7. The apparatus of claim 6 in which either one or both of the cursor control end and the pen end includes a pressure sensor configured to sense a pressure level wherein interpretation of tracked motion of at least one of the cursor control end and the stylus end is based on the sensed pressure level.

8. The apparatus of claim 7 in which a threshold of the sensed pressure level can be configured by a user.

9. The apparatus of claim 6 also including an user-operable switch wherein interpretation of tracked motion of the cursor control end is based on a state of the switch.

10. An apparatus comprising:
a wireless stylus—the motion of which is to be tracked wirelessly by electronics—an end of the stylus having flared gripping elements arranged around its circumference, the flared gripping elements having a substantially flat outwardly facing surface and arranged to include the largest circumference of the stylus.

11. The apparatus of claim 10 in which a tip of the stylus may comprise a writing element, a non-writing element, or both and is operable to select between the writing element and the non-writing element.

12. An apparatus comprising:
a stylus, motion of which is to be tracked wirelessly by electronics, the stylus comprising at least one light source and at least one light conductor to conduct the light along the stylus, the light source configured to provide to the electronics a position of the light source and an indication of a state of operation of the stylus.

13. The apparatus of claim 12 further comprising:
a second light source such that the two light sources in combination are configured to provide information related to an angle of the stylus to a writing surface.

14. The apparatus of claim 12 wherein the state of operation comprises at least one of a loss of wireless connection, a loss of power in the stylus, a blocking of a line of sight from the light source to a sensor and the sensor being out of range.

15. A method comprising:
detecting an angle at which an electronic stylus is oriented to a non-electronic writing surface, the electronic stylus comprising a writing element configured to leave a mark on the writing surface; and
using the detected angle in processing handwriting information derived from the stylus.

16. The method of claim 15 further comprising:
detecting a range of color and parameters of the mark that depend on the angle, and using the angle and information about trajectory of the writing element to capture the parameters.

17. The method of claim 15 further comprising:
using the detected angle to cancel an effect caused by the tilt angle of the stylus.

18. A method comprising:
receiving from an electronic stylus information representative of a force being applied by the stylus against a writing surface, the stylus having two functional ends, the force information being received with respect to a use of either end of the stylus; and
receiving from the stylus information indicating which of the ends is being used.

19. The method of claim 18 further comprising:
receiving, from the stylus, information to track motion of the stylus encoded in a signal that also includes information indicating which of the ends is being used, wherein signal modulation is used to separate one information from another.

20. A method comprising:
expressing a motion of an electronic stylus in a data file that represents a page of writing, the data file comprising:
a page size;
a date and time of creation; and
a set of data points representing a trajectory of the stylus, each data point comprising:
at least one pair of spatial coordinates,
a value of pressure, and
a signal representing which end of the stylus is being used: stylus or mouse.

21. A method comprising:
enabling a user to navigate temporally through a display of handwriting data that is stored in a data file derived from an electronic stylus; and
enabling the user to identify a beginning or an end of a segment of handwriting that is to be kept in the file.

22. The method of claim 21 further comprising:
enabling the user to identify more than one segments, wherein each segment is stored in a separate data file.

23. A method comprising:
enabling users to collaborate by accepting information entered by the users' handwriting with electronic styli on writing surfaces; and
displaying the handwriting of more than one of the users simultaneously in a manner that is visible to the users via at least one receiving device.

24. The method of claim 23 in which the handwriting is displayed through an online collaboration facility.

25. The method of claim 23 in which the handwriting is displayed on an electronic white board.

26. The method of claim 23 in which the handwriting is overlaid on a non-handwritten image.

27. A method comprising:
displaying to a user a document to be signed on a device;
capturing a signature of the user electronically while the user is signing his/her name on a surface using an electronic stylus;
displaying the signature on the document to be signed;
enabling the user to move the signature relative to the displayed document until the signature is in a proper location of the document; and
enabling the user to send the document with the properly located signature to a remote location.

28. The method of claim 27 further comprising:
storing with the document, as a profile of the signature, characteristics of the signature including at least one of a pressure applied to the stylus, an angle at which the electronic stylus is oriented to the surface, velocity and acceleration of the stylus and time stamps of each stroke samples.

29. The method of claim 28 in which the profile of the signature is compared with a previously stored profile or statistically averaged for variations to determine authenticity.

30. A method comprising:
electronically capturing a signature that a user has written using an electronic stylus;
electronically capturing metadata representing characteristics of the signature including pressures applied to the stylus during the writing of the signature; and
using the metadata to authenticate a signature that purports to be a signature of the user, based on metadata representing characteristics of the purported signature.

31. The method of claim 30 in which the metadata also includes angles of orientation of the stylus to a writing surface.

32. The method of claim 30 in which the metadata includes information about the pressures over time while the signature is written.

33. An apparatus comprising:
an electronic stylus that enables electronic capture of data representing a trajectory of the stylus as it is moved across a writing surface, the stylus including a device to detect a level of a force between the stylus and the writing surface as the stylus is moved across the writing surface.

34. The apparatus of claim 33 in which the device detects the level of force at successive locations of the stylus on the writing surface.
